(19) United States
(12) Patent Application Publication
(10) Pub. No.: US 2013/0279339 A1
(43) Pub. Date: Oct. 24, 2013

(54) COMMUNICATION DEVICE AND METHOD

(71) Applicant: FUJITSU LIMITED, Kawasaki-shi (JP)

(72) Inventor: Jun Ibuki, Sagamihara (JP)

(21) Appl. No.: 13/903,467

(22) Filed: May 28, 2013

Related U.S. Application Data
(63) Continuation of application No. PCT/JP2010/071299, filed on Nov. 29, 2010.

(51) Int. Cl. H04L 12/70

(52) U.S. Cl. CPC H04L 47/12
USPC 370/236

(57) ABSTRACT

A first device in a network includes: a memory configured to memorize a third device adjacent to the first device and selectable when data is transmitted toward a second device; a receiver configured to receive, from a fourth device, a notification of a first data volume being a volume of data addressed to the second device and transmitted by the fourth device through the first device; a processor configured to judge whether a criterion is exceeded by a second data volume which includes the first data volume and is a volume of data addressed to the second device and transmitted by the first device; and a transmitter configured to notify the third device of the second data volume, and notify a fifth device that the first device is a bottleneck, when the processor judges that the second data volume exceeds the criterion.

### CROSS-REFERENCE TO RELATED APPLICATION

This application is a continuation application of International Application PCT/JP2010/071299 filed on Nov. 29, 2010, and designated the U.S., the entire contents of which are incorporated herein by reference.

### FIELD

The embodiments discussed herein are related to a network communication technique.

### BACKGROUND

In a network including a plurality of communication devices, it is not preferable to concentrate a communication load. However, depending on the situation, a communication load may be concentrated in a communication device. Then, for example, based on the statuses of a node and a link in a communication network system, the following communication network system, which aims at providing the technology for the optimum use of network resources, is proposed.

That is, the communication network system includes a device for managing the situation of the network resources provided for a plurality of devices, and a device for judging whether or not adaptive control of network resources is requested. In addition, the communication network system includes a device for planning the arrangement of the function of a device and a process target, or the configuration of a path between devices when it is judged that the adaptive control of network resources is requested. Furthermore, the communication network system includes a device for re-arranging the function of a device and a process target, or re-configuring a path between devices depending on the plan.

In the field of a network communication technique, documents such as Japanese Laid-open Patent Publication No. 2004-241845 are known.

### SUMMARY

According to an aspect of the embodiments, first communication device in a network including a plurality of communication devices is provided. The first communication device includes a memory configured to memorize a third communication device which is adjacent to the first communication device, and selectable when data is transmitted toward a second communication device. The first communication device further includes a receiver configured to receive a notification of a first transmission data volume from a fourth communication device adjacent to the first communication device, the first transmission data volume being a volume of data that is addressed to the second communication device and transmitted by the fourth communication device through the first communication device in a certain period. The first communication device further includes a processor configured to judge whether a second transmission data volume exceeds a certain criterion, the second transmission volume including the first transmission data volume and being a volume of data that is addressed to the second communication device and transmitted by the first communication device in the certain period. The first communication device further includes a transmitter configured to notify the third communication device of the second transmission data volume, and notify a fifth communication device that the first communication device is a bottleneck in the network, when the processor judges that the second transmission data volume exceeds the certain criterion.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a configuration of the communication device according to the first embodiment;

FIG. 2 is a configuration of the first hardware of the communication device;

FIG. 3 is a configuration of the second hardware of the communication device;

FIG. 4 is a first example of a network;

FIG. 5 is a block diagram of a configuration of the communication device according to the second embodiment;

FIG. 6 is a timing chart relating to the transmission and reception of a data packet according to the third embodiment;

FIG. 7 is a block diagram of a configuration of the communication device according to the third embodiment;

FIG. 8 illustrates examples of link tables according to the third embodiment;

FIG. 9 is an example of a routing table according to the third embodiment;

FIG. 10 is an example of a packet used in the third embodiment;

FIG. 11 is a flowchart of a packet receiving process commonly used in some embodiments;

FIG. 12 is a flowchart of a data packet receiving process in the third embodiment;

FIG. 13 is a flowchart of a reception traffic setting process in the third embodiment;

FIG. 14 is a flowchart of a bottleneck detecting process in the third embodiment;

FIG. 15 is a flowchart of a data packet transmitting process in the third embodiment;

FIG. 16 is a timing chart relating to transmission and reception of a hello packet in the fourth embodiment;

FIG. 17 is a block diagram of a configuration of the communication device according to the fourth embodiment;

FIG. 18 is an example of link tables according to the fourth embodiment;

FIG. 19 is an example of a packet used in the fourth embodiment;

FIG. 20 is a flowchart of a hello packet receiving process in the fourth embodiment;

FIG. 21 is a flowchart of a hello packet transmitting process in the fourth embodiment;

FIG. 22 is a flowchart of a bottleneck detecting process in the fifth embodiment;

FIG. 23 is an example of a link table in the sixth embodiment;

FIG. 24 is a flowchart of a hello packet receiving process in the sixth embodiment;

FIG. 25 is a flowchart of a bottleneck detecting process in the sixth embodiment; and

FIG. 26 is a second example of a network.

### DESCRIPTION OF EMBODIMENTS

Depending on the configuration of a network, a large volume of data transmitted from a large number of communication devices may be transmitted through a particular communication device. Therefore, a communication load may be concentrated on the particular communication device. In addition, the communication load is naturally heavy in the communication device which transmits as an originator a large volume of data.

Then, the particular communication device in which a communication load is concentrated may be a bottleneck in an increasing transmission delay, an increasing data re-transmission due to a timeout, or many other problems. Therefore, to predict and prevent a bottleneck, or to detect a bottleneck so that a countermeasure against the bottleneck may be taken is useful in an operation of a network.

On the other hand, it is not preferable to impose an excessive load on a network in predicting or detecting a bottleneck.

For example, a centrally managed network system in which a particular management device collects, from each communication device in the network, information to be used by the particular management device in predicting or detecting a bottleneck may impose a heavy load on the network by the traffic for the collection of the information. Therefore, what is desirable to avoid an excessive load is a technique capable of autonomously predicting or detecting a bottleneck by an individual communication device in the network.

Accordingly, an aspect of the following embodiments aims at autonomously predicting or detecting a bottleneck by a communication device in a network.

A communication device according to an aspect of the embodiment is a first communication device in a network including a plurality of communication devices. The plurality of communication devices includes the first communication device as well as second to fourth communication devices described below.

The first communication device includes a path information storage unit which memorizes the third communication device. The third communication device is adjacent to the first communication device and is selectable when the first communication device transmits data toward the second communication device. The path information storage unit may be, for example, volatile or non-volatile memory included in the first communication device.

Furthermore, the first communication device includes a reception unit which receives a notification of a first transmission data volume from the fourth communication device. The fourth communication device is adjacent to the first communication device. The first transmission data volume is the volume of data that is addressed to the second communication device and transmitted by the fourth communication device through the first communication device in a certain period. The reception unit may be, for example, a receiver included in the first communication device.

In addition, the first communication device includes a transmission volume notification unit which notifies the third communication device of a second transmission data volume. The second transmission data volume is the volume of data that is addressed to the second communication device and transmitted by the first communication device in the certain period. Therefore, the second transmission data volume includes the first transmission data volume. The first communication device also includes a judgment unit which judges whether the second transmission data volume exceeds a certain criterion.

Furthermore, the first communication device also includes a transmission bottleneck notification unit. When the judgment unit judges that the second transmission data volume exceeds the certain criterion, the transmission bottleneck notification unit notifies the fifth communication device that the first communication device is the bottleneck in the network. The fifth communication device may be predetermined.

For example, a transmitter included in the first communication device may operate as the transmission volume notification unit and also as the transmission bottleneck notification unit. In addition, the judgment unit may be, for example, a processor included in the first communication device.

As described above, the path information storage unit of the first communication device memorizes the third communication device selectable when data is transmitted toward the second communication device. The transmission volume notification unit of the first communication device notifies the third communication device (i.e., nothing else but the communication device memorized as above) of the second transmission data volume. Therefore, if each communication device corresponding to each node in the network is configured as the first communication device above, a notification of a transmission data volume is successively transmitted along a data transmission path to the second communication device while the transmission data volume gets accumulated along the data transmission path. Then, based on the accumulated transmission data volume, the judgment unit of each communication device on the data transmission path to the second communication device makes a judgment as described above.

As it is clearly described about the first communication device above, each of the notifications of the first and second transmission data volumes is not limited to the notification of a predicted transmission data volume, or not limited to the notification of the actual current transmission data volume. Therefore, the first communication device above is capable of predicting and detecting a bottleneck.

Therefore, if each node in a network is configured as the first communication device above, each individual communication device is enabled to autonomously predict or detect whether or not the communication device itself is the bottleneck on the data transmission path to the second communication device.

Each embodiment is described below in detail with reference to the attached drawings. Each embodiment described below is preferable in predicting or detecting a bottleneck in an ad hoc network. First, a bottleneck in an ad hoc network is briefly described below, and then the first through eleventh embodiments and their variations are sequentially described.

One of the features of an ad hoc network is that it is almost unnecessary to design or set in advance a data transmission path etc. On the other hand, in a practical operation of an ad hoc network, a bottleneck may occur in a network due to various factors such as an arrangement of a node etc.

In a conventionally assumed or used small ad hoc network, an occurrence of a bottleneck is not a serious problem. However, with a recent increasing use of an ad hoc network, a large ad hoc network which has not conventionally been assumed has become adopted.

Furthermore, an ad hoc network has been adopted as a use which has not been conventionally assumed and in which there is relatively heavy traffic steadily. For example, one of new uses of an ad hoc network is a large sensor network including a large number of nodes which periodically transmit the output of a sensor.

Then, with an increasing uses of an ad hoc network as described above, the occurrence of a bottleneck has been revealed as a new problem. Each of the following embodiments is to provide a countermeasure against the new problem.

If there is a bottleneck in a network, for example, data may be lost by a buffer overflow in a node of the bottleneck. Otherwise, a timeout may frequently occur as a result of which a data retransmission and switching of a transmission path may also frequently occur, and a data transmission delay may increase in the network.

However, in consideration of the feature of the ad hoc network that it is almost unnecessary to perform designing and setting in advance, and that it is unnecessary to include a node for centrally managing the entire network, it is not preferable that a particular management device predicts or detects a bottleneck because the particular management device is to newly collect information from each node in the network for prediction or detection of a bottleneck. That is, the traffic for collection of information may impose an excessive load on the network.

Thus, it is preferable that a bottleneck may be predicted or detected while suppressing a load newly occurring in the network to predict or detect the bottleneck.

As a factor of a particular node being a bottleneck, there is heavy traffic entering a particular node, or there is heavy traffic outgoing the particular node. That is, the factor of a bottleneck is the heavy traffic passing along an actual data transmission path.

It is unnecessary for each node in the ad hoc network to recognize the entire paths about the route used when practically transmitting data, but each node recognizes at least the node in the next hop adjacent to the node. Accordingly, the Inventor has reached the following consideration. That is, each node may autonomously predict or detect a bottleneck without imposing an excessive load on the network by using the information about the next hop recognized by the node.

Described below is each embodiment in which each node may autonomously predict or detect a bottleneck. The network in each of the embodiments below may be an arbitrary network, but each of the following embodiments is preferably applied to an ad hoc network.

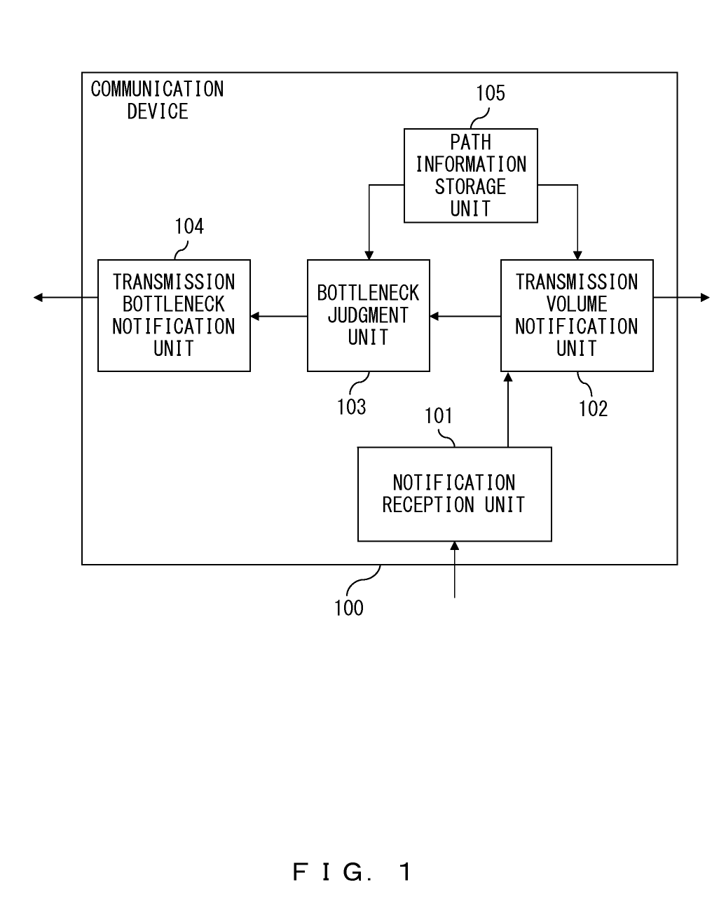

FIG. 1 is a block diagram of a configuration of the communication device according to the first embodiment. A communication device 100 in FIG. 1 is used in a network including a plurality of communication devices. The network is, for example, an ad hoc network.

In the descriptions with reference to FIGS. 1 through 4, the following communication devices in the network are respectively referred to as the “first communication device” through “sixth communication device” for convenience.

The communication device 100 is referred to as the “first communication device” for convenience.

In addition, a particular communication device as a final destination of data in the network is referred to as the “second communication device” for convenience. The second communication device may be, for example, a gateway between the network above and another network.

Furthermore, a communication device which is adjacent to the communication device 100 and which is selectable as a direct destination when the communication device 100 transmits data toward the second communication device is referred to as a “third communication device” for convenience.

The “communication device adjacent to the communication device 100” is a communication device having the hop count of 1 from the communication device 100. One or more communication devices may be adjacent to the communication device 100.

In the one or more communication devices adjacent to the communication device 100, only one communication device or more than one communication device may be selectable as a direct destination when the communication device 100 transmits data to the second communication device. The third communication device is one of the one or more selectable communication devices.

For example, the third communication device may be a communication device having the best evaluation value in one or more selectable communication devices. The evaluation value is dynamically changed according to a certain rule. In addition, when the second communication device is adjacent to the communication device 100, the third communication device may be the second communication device.

Whether or not a communication device adjacent to the communication device 100 is “selectable” depends on, for example, the routing algorithm adopted by the communication device 100. According to a routing algorithm, all communication devices adjacent to the communication device 100 are selectable as a direct destination when the communication device 100 transmits data toward the second communication device. According to another routing algorithm, only the communication device(s) whose evaluation value is included in the M-best evaluation values (1≦M), in the communication devices adjacent to the communication device 100, may be selectable as the direct destination when the communication device 100 transmits data toward the second communication device.

Additionally, the communication device which is adjacent to the communication device 100 and transmits data addressed to the second communication device through the communication device 100 is referred to as a “fourth communication device” for convenience. There may be only one or a plurality of fourth communication devices.

As described later, the communication device 100 may judge that the communication device 100 is a bottleneck in which the communication load is concentrated in the network. A communication device predetermined as a destination to which a notification of the judgment result is transmitted from the communication device 100 is referred to as a “fifth communication device” for convenience.

One particular communication device in the network may be determined in advance as the fifth communication device. For example, the fifth communication device may be the second communication device. Otherwise, a plurality of communication devices may be determined in advance as a plurality of fifth communication devices. For example, all communication devices other than the communication device 100 in the network may be determined in advance as a plurality of fifth communication devices.

The communication device (s) which are different from the third communication device, adjacent to the communication device 100, and selectable as a direct destination when the communication device 100 transmits data toward the second communication device, is/are referred to as a “sixth communication device(s)” for convenience. As described above with reference to the third communication device, there may be one or more selectable communication devices.

There may be the case in which the fourth communication device is the sixth communication device. The reason is as follows. Since the fourth communication device is adjacent to the first communication device, the fourth communication device is potentially selectable as the direct destination when the first communication device transmits data addressed to the second communication device.

The communication device 100 in FIG. 1 is the first communication device in the network including the first through sixth communication devices as described above. Then, as illustrated in FIG. 1, the communication device 100 includes a notification reception unit 101, a transmission volume notification unit 102, a bottleneck judgment unit 103, a transmission bottleneck notification unit 104, and a path information storage unit 105.

The notification reception unit 101 receives a notification of a first transmission data volume from the fourth communication device. The first transmission data volume is the volume of the data which is addressed to the second communication device and which is transmitted by the fourth communication device through the communication device 100 in a certain period. The transmission volume notification unit 102 notifies the third communication device of a second transmission data volume. The second transmission data volume includes the first transmission data volume. The second transmission data volume is the volume of the data which is addressed to the second communication device and which is transmitted by the communication device 100 in a certain period.

For example, assume that “certain period” is one hour, and that the number of the fourth communication devices is two. Also assume that one of the fourth communication devices transmits, toward the second communication device through the communication device 100, data of 3000 kilobytes (KB) per hour including data relayed (i.e., forwarded) by this fourth communication device and data generated by this fourth communication device itself. It is also assumed that the other fourth communication device transmits, toward the second communication device through the communication device 100, data of 2400 kilobytes per hour including data relayed by this fourth communication device and the data generated by this fourth communication device itself.

Then, the notification reception unit 101 of the communication device 100 receives a notification of “3000 KB per hour” and a notification of “2400 KB per hour” as the notification of the first transmission data volume from the respective fourth communication devices. In addition, assume that the communication device 100 itself generates and transmits data which is as much as 200 KB per hour and is addressed to the second communication device. Then, the second transmission data volume is 5600 (=3000+2400+200) KB.

The transmission volume notification unit 102 may calculate the second transmission data volume based on the notification of the first transmission data volume received by the notification reception unit 101 as described above. Then, the transmission volume notification unit 102 may output the calculated second transmission data volume to the bottleneck judgment unit 103.

The bottleneck judgment unit 103 judges whether or not the second transmission data volume exceeds a certain criterion. The certain criterion may depend on an embodiment. For example, the bottleneck judgment unit 103 may simply compare the second transmission data volume with a certain threshold. Then, if the second transmission data volume exceeds the certain threshold, the bottleneck judgment unit 103 may judge that the second transmission data volume exceeds the certain criterion. Other concrete examples of the certain criterion are described later.

If the bottleneck judgment unit 103 judges that the second transmission data volume exceeds the certain criterion, the transmission bottleneck notification unit 104 notifies the fifth communication device that the communication device 100 is a bottleneck in the network. That is, the notification to the fifth communication device is a warning that the communication load of the communication device 100 is excessive.

Therefore, it is preferable that a countermeasure is taken to reduce the excessive load according to the notification from the transmission bottleneck notification unit 104 to the fifth communication device.

For example, the fifth communication device may have a display, and the contents of the notification from the transmission bottleneck notification unit 104 may be displayed on the display. Then, for example, a network administrator may watch the display to take any countermeasure.

For example, the network administrator may attempt to reduce the concentration of the communication in the communication device 100 by deploying one or more new communication devices near the communication device 100 based on the notification that the communication device 100 is a bottleneck in the network. Otherwise, the network administrator may change the settings of all or part of the communication devices in the network so that the volume of the data that the communication devices generate in a certain period in order to transmit the data toward the second communication device may be reduced.

Obviously, upon receipt of the notification from the transmission bottleneck notification unit 104, the fifth communication device may automatically instruct all or part of communication devices in the network to change the settings. That is, the fifth communication device may automatically transmit an instruction to all or part of the communication devices, thereby instructing them to reduce the volume of data that they generate in a certain period in order to transmit the data toward the second communication device.

The above-mentioned transmission regulation may be executed according to the rule such as “transmission of the data of a particular type having a low priority (that is, low level of emergency, less importance, etc.) is restricted, but transmission of other types of data is not restricted”. Then, under the transmission regulation, data having a high priority is transmitted certainly.

Otherwise, all communication devices other than the communication device 100 in the network may be the fifth communication devices as described above. In this case, upon receipt of the notification from the transmission bottleneck notification unit 104, each fifth communication device may decrease the volume of the data that the fifth communication device itself generates in a certain period in order to transmit the data toward the second communication device.

The first transmission data volume, whose notification is received by the notification reception unit 101, and the second transmission data volume, whose notification is transmitted by the transmission volume notification unit 102, may indicate the volume of data to be transmitted in the subsequent operations, or the volume of data that has been actually transmitted.

When the first and second transmission data volumes indicate the predicted or planned volumes of data, the notification to the fifth communication device is a warning of a bottleneck predicted for the subsequent operations. On the other hand, if the first and second transmission data volumes indicate the volumes of actually transmitted data, the notification to the fifth communication device is a warning that a bottleneck has actually been detected.

The path information storage unit 105 memorizes the third communication device as a communication device selectable as a direct destination when the communication device 100 transmits data addressed to the second communication device. Therefore, the transmission volume notification unit 102 is capable of recognizing the third communication device, which is the destination of a notification of the second transmission data volume, with reference to the path information storage unit 105.

The path information storage unit 105 may also memorize a communication device which is selectable as a direct destination when the communication device 100 transmits the data addressed to the fifth communication device. When a particular communication device is specified as the fifth communication device in advance, the transmission bottleneck notification unit 104 is capable of determining a direct destination to be specified when the transmission bottleneck notification unit 104 transmits a warning finally to the fifth communication device, with reference to the path information storage unit 105.

Otherwise, when all communication devices other than the communication device 100 in the network are determined in advance as the fifth communication devices, it is sufficient for the transmission bottleneck notification unit 104 to simply broadcast a warning. Therefore, in this case, it is unnecessary for the transmission bottleneck notification unit 104 to refer to the path information storage unit 105.

The path information storage unit 105 concretely stores the information including the identification information for identification of the third communication device. There are various contents and formats of the information stored in the path information storage unit 105 depending on the embodiments. Then, in some embodiments, the bottleneck judgment unit 103 may refer to the information stored in the path information storage unit 105 when the bottleneck judgment unit 103 judges whether or not the second transmission data volume exceeds a certain criterion.

For example, the path information storage unit 105 may further store a first evaluation value of the communication quality between the third communication device and the communication device 100. In this case, the bottleneck judgment unit 103 performs a specified calculation using the second transmission data volume and the first evaluation value, and may compare a first value obtained as a calculation result with a first threshold. When the first value is larger than the first threshold, the bottleneck judgment unit 103 may judge that the second transmission data volume exceeds the certain criterion.

In the following description, for convenience of explanation, the first evaluation value indicating the communication quality is defined so that the smaller the first evaluation value is, the higher quality is indicated. However, obviously depending on the embodiments, the first evaluation value may be defined so that the larger the first evaluation value is, the higher quality is indicated.

The first value is defined so that the larger the second transmission data volume is, the larger the first value becomes, and so that the higher quality the first evaluation value indicates (that is, the smaller the first evaluation value is), the smaller the first value becomes. For example, the first value may be a product of the second transmission data volume and the first evaluation value.

To be more concrete, the first evaluation value may be a value defined based on one or more indexes exemplified below. For example, first evaluation value may be a value based on the reception power or the number of retries in a wireless network. In addition, regardless of a wireless network or a cable network (i.e., wired network), the first evaluation value may be a value based on the packet error rate, the packet loss rate, the throughput, or the fluctuation (that is, jitter) of the reception interval of a control packet that is to be periodically transmitted from each communication device in the network.

For example, the first evaluation value may be defined so that the larger the reception power (that is, the field intensity) is, the smaller the first evaluation value becomes (the higher quality the first evaluation value indicates). On the other hand, the first evaluation value may be defined so that the larger the number of retries caused by the occurrences of collisions, the larger the first evaluation value becomes (the lower quality the first evaluation value indicates).

Furthermore, when packets received by the communication device 100 includes their error detection code such as a checksum, a cyclic redundancy check (CRC), etc., the communication device 100 is capable of recognizing the rate at which an error is included in the received packet. The first evaluation value may be defined so that the higher the packet error rate is, the larger the first evaluation value becomes (that is, the lower quality the first evaluation value indicates).

In the present specification, a PDU (protocol data unit) transmitted and received between communication devices according to a particular protocol is referred to as a “packet”. The term “packet” is not intended to limit the above “particular protocol”. The term “packet” is not intended to limit the above “particular protocol” to the protocol of a specified layer.

In addition, the communication device 100 may assume that a packet has been lost unless it receives an ACK (acknowledgment) signal from the third communication device within a specified time period after transmitting the packet to the third communication device.

Otherwise, the communication device 100 may retry a transmission of a packet unless it receives an ACK signal within a specified time period after transmitting the packet to the third communication device. Then, the communication device 100 may retry the transmission up to a specified number of times as appropriate, and may assume that the packet has been lost if it does not receive an ACK signal even after the specified number of retries.

Anyway, the communication device 100 is capable of recognizing a packet loss rate. Thus, the first evaluation value may be defined so that the higher the packet loss rate is, the larger the first evaluation value becomes (the lower quality the first evaluation value indicates.)

The communication device 100 may measure the throughput with the third communication device. The first evaluation value may be defined so that the larger the throughput is, the smaller the first evaluation value becomes (the higher quality the first evaluation value indicates). It is not necessarily easy to measure correct throughput. However, for example, the communication device 100 may obtain an approximate value of the throughput using test packets.

Furthermore, in the embodiment in which each communication device in the network is configured to periodically transmit a certain type of control packet, the first evaluation value may be defined so that the larger the fluctuation of the reception interval of a control packet is, the larger the first evaluation value becomes (the lower quality the first evaluation value indicates). For example, in an ad hoc network, each communication device may periodically transmit a control packet called a “hello packet” etc. to notify its adjacent communication device(s) of the existence of the communication device itself.

In this case, if the communication quality of the link between the communication device 100 and the third communication device is very high, all of hello packets periodically transmitted from the third communication device are normally and successfully received by the communication device 100. Therefore, the fluctuation of the reception interval of the hello packets is almost zero.

On the other hand, if the communication quality of the link between the communication device 100 and the third communication device is inferior, some of the hello packets periodically transmitted from the third communication device are not received by the communication device 100. As a result, the reception interval of the hello packets in the communication device 100 is not constant, namely, the jitter in the reception interval increases.

Therefore, the first evaluation value may be defined so that the larger the fluctuation of the reception interval of a hello packet is, the larger the first evaluation value becomes (the lower quality the first evaluation value indicates). The fluctuation of the reception interval may be expressed by, for example, the variance of the reception interval or the standard deviation of the reception interval.

As described above, the concrete definition of the first evaluation value depends on the embodiments. However, regardless of the concrete definition of the first evaluation value, if the path information storage unit 105 further stores the first evaluation value, the bottleneck judgment unit 103 is enabled to compare the first value, which is calculated based on the second transmission data volume and the first evaluation value, with the first threshold.

If the first value is larger than the first threshold, the bottleneck judgment unit 103 may judge that the second transmission data volume exceeds the certain criterion. Even if the second transmission data volume may be constant, whether the communication device 100 is overloaded or not may still vary depending on the first evaluation value. Therefore, it is more preferable to consider the first evaluation value as described above than the judgment based only on the second transmission data volume.

Furthermore, the path information storage unit 105 may further store the second evaluation value of the communication quality between each of one or more sixth communication devices and the communication device 100, in addition to the first evaluation value of the communication quality between the third communication device and the communication device 100.

In this case, the bottleneck judgment unit 103 may perform a specified calculation using the second transmission data volume, the first evaluation value, and the second evaluation value, and compare a second value obtained as the calculation result with a second threshold. Then, the bottleneck judgment unit 103 may judge that the second transmission data volume exceeds the certain criterion, when the second value is larger than the second threshold.

The second evaluation value is also defined based on one or more indexes similar to those used for defining the first evaluation value. That is, the first and second evaluation values are defined respectively for the third and sixth communication devices based on one or more same indexes.

The second value is defined so that the larger the second transmission data volume is, the larger the second value becomes. In addition, the second value is also defined so that the higher the quality indicated by the first evaluation value is (that is, the smaller the first evaluation value is), the smaller the second value becomes, and so that the higher the quality indicated by the second evaluation value is (that is, the smaller the second evaluation value is), the smaller the second value becomes.

One of the typical example of the specified calculation above to obtain the second value is to divide the second transmission data volume by a sum of the inverse of the first evaluation value and the inverse of each second evaluation value corresponding to each of one or more sixth communication devices.

That is, the second value is the value obtained by dividing the second transmission data volume by a result obtained by counting the weighted number of communication devices selectable as a direct destination when the communication device 100 transmits data addressed to the second communication device. As a weight, an inverse of an evaluation value is available as in the example above.

The number of communication devices selectable as a direct destination when the communication device 100 transmits data addressed to the second communication device is, in other words, the number of transmission paths potentially selectable by the communication device 100. Therefore, the result obtained by counting the weighted number of communication devices as described above is also referred to as a “weighted number of transmission paths” in the following descriptions.

With the higher quality link a communication device is connected to the communication device 100, the smaller the evaluation value corresponding to the link becomes. Therefore, the weight value (for example, the inverse of the evaluation value) is large. Accordingly, the larger the number of communication devices connected to the communication device 100 with a high quality link is, the larger the weighted number of transmission paths becomes. On the other hand, the larger the number of communication devices connected to the communication device 100 with a low quality link is, the smaller the weighted number of transmission paths becomes. If the number of the communication devices connected to the communication device 100 is small, the weighted number of transmission paths is naturally small.

In the example above, the second value is obtained by dividing the second transmission data volume by the weighted number of transmission paths. Therefore, the larger the weighted number of transmission paths is, the smaller the second value becomes. That is, the larger the number of communication devices connected to the communication device 100 with a higher quality link is, the smaller the second value becomes.

That is, when the second value exceeds the second threshold, the number of communication devices connected to the communication device 100 with a high quality link is insufficient, thereby possibly making the communication device 100 a bottleneck. Therefore, the bottleneck judgment unit 103 may judge that “the second transmission data volume has exceeded the certain criterion” as described above, when the second value is larger than the second threshold.

The merit of additionally using the second evaluation value as described above is that estimation of the possibility that the communication device 100 may be overloaded is still feasible also when the communication device 100 switches, depending on the dynamic change in the state of the network, the adjacent communication device through which the communication device 100 transmits the data addressed to the second communication device.

That is, depending on the change in the state of the network, the communication device 100 may switch its operation so that the communication device 100 may transmit the data addressed to the second communication device through one of the sixth communication devices, not through the third communication device. If each of one or more sixth communication devices has inferior communication quality of the link to the communication device 100, then the communication device 100 has a strong possibility of an excessive load when the operation is switched. That is, the communication device 100 has, in this case, low robustness against a dynamic change in the state of the network.

On the other hand, if it is possible to detect in advance the poor robustness before the state of the network actually changes, any countermeasure may be taken by, for example, adding a new communication device near the communication device 100, moving the position of the communication device 100, etc. As a result, the communication device 100 may be prevented from entering an overload state even when the state of the network actually changes.

The bottleneck judgment unit 103 may reach the final judgment by, for example, combining a comparison result of the second transmission data volume and a specified threshold, a comparison result of the first value and the first threshold, and a comparison result of the second value and the second threshold.

In addition, the notification of the first transmission data volume received by the notification reception unit 101 from the fourth communication device may be transmitted as an independent packet. However, from the viewpoint of reduction in the load on the network, it is preferable that the notification of the first transmission data volume is included in first data which is addressed to the second communication device and transmitted by the fourth communication device through the first communication device. The first data is a target of the calculation of the first transmission data volume. In other words, the first data is to be measured in measuring the first transmission data volume.

The first data may be concretely a data packet. When the first data includes a notification of the first transmission data volume, the transmission volume notification unit 102 notifies the third communication device of the second transmission data volume by including the notification of the second transmission data volume in the first data when the first data is forwarded to the third communication device.

Otherwise, from the viewpoint of reduction in the load on the network, it is also preferable that second data that is broadcast by the fourth communication device includes a notification of the first transmission data volume together with the information for identifying the communication device 100. When the second data includes a notification of the first transmission data volume, the transmission volume notification unit 102 notifies the third communication device of the second transmission data volume as follows.

That is, the transmission volume notification unit 102 notifies the third communication device of the second transmission data volume by including the notification of the second transmission data volume in third data together with the information for identifying the third communication device when the third data is broadcast by the communication device 100 (more specifically, by the transmission volume notification unit 102). The second and third data may be hello packets concretely.

When a notification of a transmission data volume is included in a data packet or in a hello packet as described above, the load newly added to the network for prediction or detection of a bottleneck is very low. That is, without transmitting another new packet, the payload length of a data packet or a hello packet is prolonged only by the volume used for the notification of the transmission data volume.

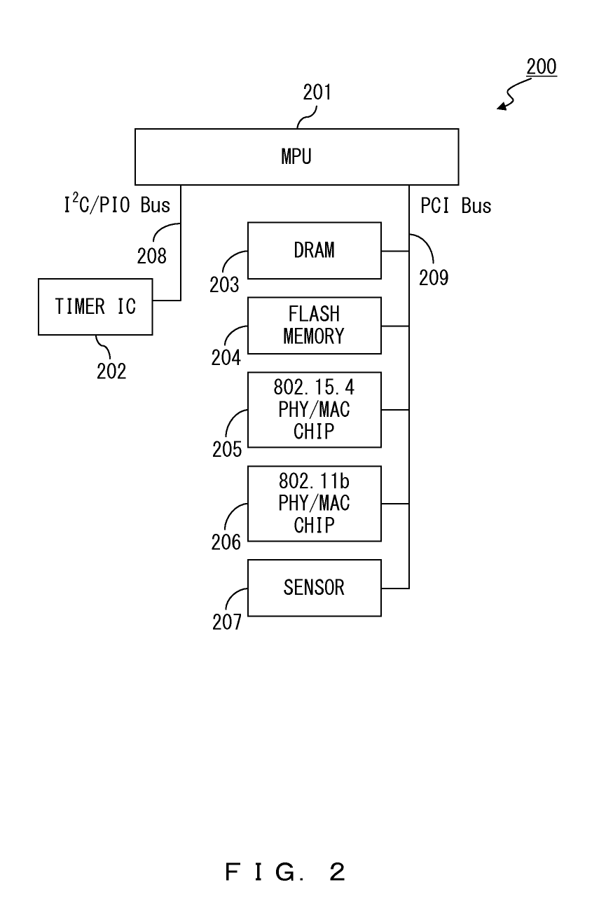

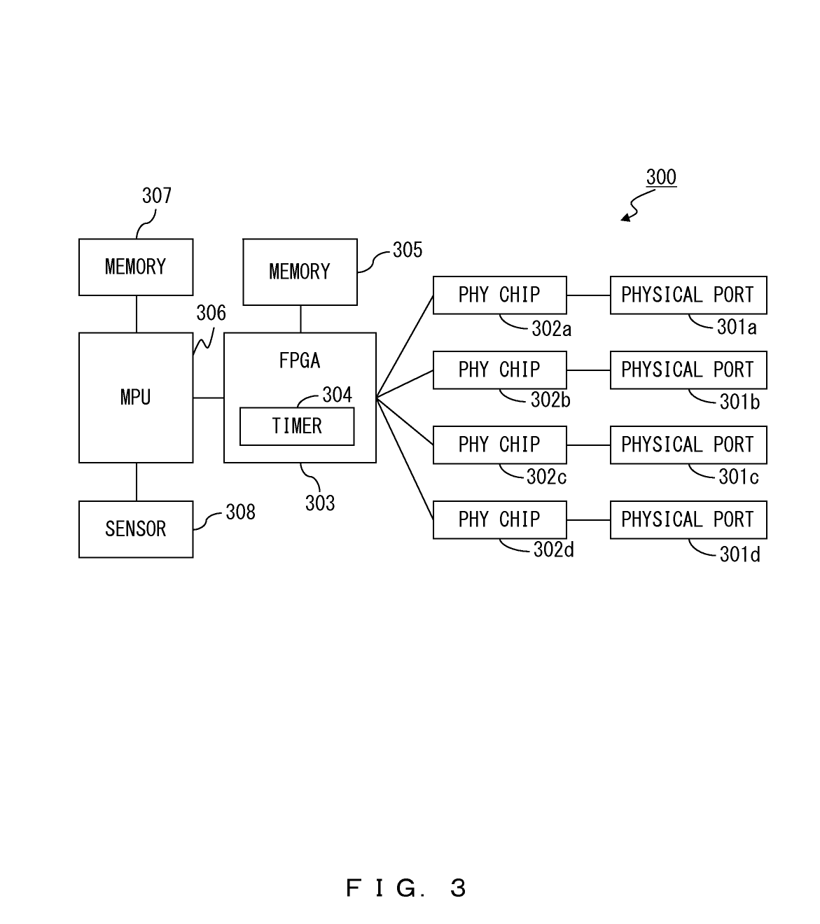

The communication device 100 illustrated in FIG. 1 may be realized by, for example, the hardware illustrated in FIG. 2 or 3. For example, when the network including the communication device 100 is a wireless network, the communication device 100 illustrated in FIG. 1 may be realized by a communication device 200 in FIG. 2 concretely. If the network including the communication device 100 is a cable network, the communication device 100 in FIG. 1 may be realized by a communication device 300 in FIG. 3 concretely.

The communication device 200 in FIG. 2 includes an MPU (micro processing unit) 201, a timer IC (integrated circuit) 202, DRAM (dynamic random access memory) 203, and flash memory 204. The communication device 200 may include another non-volatile memory instead of the flash memory 204.

The MPU 201 is an example of a processor. The MPU 201 loads a program stored in the flash memory 204 into the DRAM 203, and executes the program while using the DRAM 203 as a work area. The timer IC 202 outputs an interrupt signal with appropriate timing to allow the MPU 201 to periodically perform a particular process.

The memory such as the DRAM 203, the flash memory 204, etc. is also an example of a computer-readable and tangible storage medium. The memory such as the DRAM 203, the flash memory 204, etc. is not a transitory medium such as a signal carrier wave etc.

The communication device 200 further includes a wireless communication module. A wireless communication module may be, for example, an 802.15.4 PHY/MAC chip 205 an 802.11b PHY/MAC chip 206 as exemplified in FIG. 2. In the present specification, a “PHY/MAC chip” refers to a hardware circuit which performs a process of a physical layer and a MAC (media access control) sub-layer.

The 802.15.4 PHY/MAC chip 205 provides a wireless communication function according to an IEEE (Institute of Electrical and Electronics Engineers) 802.15.4 standard. The 802.11b PHY/MAC chip 206 provides a wireless communication function according to an IEEE 802.11b standard. The communication device 200 may be provided with one or both of the 802.15.4 PHY/MAC chip 205 and 802.11b PHY/MAC chip 206. Otherwise, the communication device 200 may be provided with another PHY/MAC chip according to another wireless communication standard.

Furthermore, the communication device 200 may include a sensor 207. The sensor 207 may be any sensor such as an image sensor, a temperature sensor, a humidity sensor, a pressure sensor, etc.

The timer IC 202 is connected to the MPU 201 through an I²C/PIO (inter-integrated circuit or parallel input/output) bus 208. The DRAM 203, the flash memory 204, the 802.15.4 PHY/MAC chip 205, the 802.11b PHY/MAC chip 206, and the sensor 207 are connected to the MPU 201 through a PCI (peripheral component interconnect) bus 209.

For example, the communication device 200 may perform normal communications according to the IEEE 802.15.4 standard, and notify the fifth communication device from the transmission bottleneck notification unit 104 according to the IEEE 802.11b standard described above with reference to FIG. 1. That is, the communication device 200 may normally perform communications according to the IEEE 802.15.4 standard featured by low energy consumption. Then, the communication device 200 may perform communications according to the IEEE 802.11b standard which is longer in communication distance in 1 hop than the IEEE 802.15.4 standard in order to notify an emergency warning.

The example of the above-mentioned “normal communication” is a transmission and reception of a data packet including data output by the sensor 207 in the payload. Another example of the above-mentioned “normal communication” is a transmission and reception of a control packet such as a hello packet, an ACK packet, etc.

As described above, a notification of the first transmission data volume received by the notification reception unit 101 from the fourth communication device illustrated in FIG. 1 may be realized by a dedicated control packet. However, it is preferable that the notification is added to the packet used in a normal communication because when a notification of the first transmission data volume is added to the packet used in a normal communication, no various overheads which accompany the transmission of a new dedicated control packet occur, thereby suppressing the increase of traffic caused by the notification of the first transmission data volume to the least possible level.

Similarly, it is preferable that a notification of the second transmission data volume transmitted by the transmission volume notification unit 102 in FIG. 1 to the third communication device is also added to the packet used in a normal communication. Accordingly, described below is the case in which the notification of the first and second transmission data volume is added to the packet used in the normal communication.

In this case, the notification reception unit 101 in FIG. 1 is realized by the 802.15.4 PHY/MAC chip 205 in FIG. 2. The 802.15.4 PHY/MAC chip 205 outputs the received packet to the DRAM 203, and notifies the MPU 201 of the reception of the packet.

When the packet including the notification of the first transmission data volume is transmitted by the fourth communication device, the MPU 201 which operates as a part of the transmission volume notification unit 102 extracts a notification of the first transmission data volume from the received packet. In addition, the MPU 201 associates the first transmission data volume with the fourth communication device, and stores the resultant data in the DRAM 203.

Then, the MPU 201 refers to the DRAM 203, and adds the first transmission data volume notified from one or more fourth communication devices to the data volume generated by the communication device 200 itself in a specified period and transmitted to the second communication device. As described above, the MPU 201 obtains the second transmission data volume by the addition. A concrete example of the data generated by the communication device 200 itself and transmitted to the second communication device is, for example, a data packet including the data output by the sensor 207 in the payload.

Then, the MPU 201 adds the notification of the second transmission data volume to the packet when it transmits (or broadcasts) the packet used in a normal communication such as a data packet, a hello packet, etc. to the third communication device. Then, the packet including the notification of the second transmission data volume is transmitted to the third communication device through the 802.15.4 PHY/MAC chip 205 as a part of the transmission volume notification unit 102.

Furthermore, the MPU 201 also operates as the bottleneck judgment unit 103 in FIG. 1. That is, the MPU 201 judges whether or not the second transmission data volume calculated as described above exceeds a specified criterion. A concrete example of the specified criterion is described above with reference to FIG. 1.

The MPU 201 also operates as a part of the transmission bottleneck notification unit 104. That is, when the second transmission data volume exceeds the specified criterion, the MPU 201 judges that “the communication device 200 is a bottleneck in the network”. Then, the MPU 201 generates a packet for notification of the judgment result to the fifth communication device. The 802.11b PHY/MAC chip 206 as a part of the transmission bottleneck notification unit 104 transmits the packet generated by the MPU 201.

Obviously, depending on the embodiments, a notification from the transmission bottleneck notification unit 104 to the fifth communication device may also be transmitted according to the same communication standard as the normal communication. For example, the 802.15.4 PHY/MAC chip 205 may operate as a part of the notification reception unit 101, operate as a part of the transmission volume notification unit 102, and operate as a part of the transmission bottleneck notification unit 104 in an embodiment.

The path information storage unit 105 in FIG. 1 is realized by the DRAM 203 or the flash memory 204. As described above, when the network including the communication device 100 is a wireless network, the communication device 100 in FIG. 1 may be concretely realized by the communication device 200 in FIG. 2.

On the other hand, when the network including the communication device 100 is a cable network, the communication device 100 in FIG. 1 may be concretely realized by the communication device 300 in FIG. 3.

The communication device 300 in FIG. 3 includes four physical ports 301a through 301d, and four PHY chips 302a through 302d connected to the corresponding physical ports 301a through 301d. Obviously, the number of physical ports 301a through 301d may be any number other than 4 exemplified in FIG. 3.

The communication device 300 further includes an FPGA (field programmable gate array) 303 connected to the four PHY chips 302a through 302d through the MII (media independent interface). The FPGA 303 includes a timer 304. The timer 304 outputs an interrupt signal for realization of the execution of a periodical process.

Furthermore, the communication device 300 has memory 305 which is connected to the FPGA 303, and may be referred to from the FPGA 303. The memory 305 may include, for example, a CAM (content addressable memory), SRAM (static random access memory), and SDRAM (synchronous dynamic random access memory).

For example, the SRAM may store a LUT (look-up table) for defining the operation of the FPGA 303. In addition, the memory 305 may be configured so that the address of the SRAM may be obtained as a result of searching the CAM.

Then, the communication device 300 includes MPU 306 connected to the FPGA 303, and memory 307 which is connected to the MPU 306, and may be referred to from the MPU 306. The memory 307 may include, for example, DRAM for a work area and non-volatile memory (for example, flash memory) for storage of a program.

Furthermore, the communication device 300 may further include a sensor 308 connected to the MPU 306. The sensor 308 may be any sensor as with the sensor 207 in FIG. 2.

In a cable network, adjacent communication devices are connected directly through a cable. For example, when the communication device 100 as the first communication device described above with reference to FIG. 1 is realized by the communication device 300 in FIG. 3, the communication device 300 includes the four physical ports 301a through 301d. Therefore, there are up to the maximum number of four communication devices adjacent to the communication device 300.

For convenience of explanation in the descriptions below, it is assumed that the third communication device is connected to the physical port 301a, and the fourth communication device is connected to the physical port 301b. In addition, it is assumed that the sixth communication device is connected to the physical port 301c, and another sixth communication device is connected to the physical port 301d.

Then, the notification reception unit 101 in FIG. 1 which receives the notification of the first transmission data volume from the fourth communication device is concretely realized by the physical port 301b and the PHY chip 302b. The PHY chip 302b outputs the packet received from the fourth communication device to the FPGA 303.

In various processes performed by the communication device 300, the process to be performed by the FPGA 303 and the process to be performed by the MPU 306 are arbitrarily determined depending on the embodiment. For example, the FPGA 303 may perform the routing of a data packet according to the LUT, and the processes other than the routing may be performed by the MPU 306.

For example, a cable network (i.e., wired network) is featured by that “the upper limit of the number of the adjacent communication devices depends on the number of physical ports”. In the cable link, the fluctuation of the quality detected in a wireless link may be ignored. That is, although it is preferable that the state of a wireless link is expressed by a continuous value, there is no problem with the state of a cable link when it is expressed by a binary value as to “connected or disconnected”.

Therefore, the routing in a cable network (to be more concrete, a cable ad hoc network) is applicable in realization by a combinational logic circuit such as the FPGA 303 etc. Therefore, the routing may be performed by the FPGA 303, and a more complicated process depending on the contents of a packet may be performed by the MPU 306.

For convenience of explanation in the following descriptions, it is assumed that the FPGA 303 may perform the routing, and other processes may be performed by the MPU 306. In addition, the packet received by the communication device 300 is temporarily buffered in the memory 305 or 307.

Therefore, when a packet including the notification of the first transmission data volume from the fourth communication device is received by the physical port 301b, the MPU 306 operating as apart of the transmission volume notification unit 102 extracts the notification of the first transmission data volume from the packet. The MPU 306 also associates the first transmission data volume with the fourth communication device, and stores the resultant data in the memory 307.

Then, the MPU 306 refers to the memory 307, and adds the first transmission data volume notified from one or more fourth communication devices to the volume of the data generated by the communication device 300 itself in a specified period and transmitted to the second communication device. As described above, the MPU 306 obtains the second transmission data volume by the addition.

In the assumption above, the fourth communication device is only one communication device connected to the physical port 301b. A concrete example of the data generated by the communication device 300 and transmitted to the second communication device is, for example, a data packet including the data output by the sensor 308 in the payload.

The MPU 306 adds the notification of the second transmission data volume to the packet when transmitting the packet used in a normal communication to the third communication device. Then, the packet including the notification of the second transmission data volume is transmitted to the third communication device through the PHY chip 302a and the physical port 301a as a part of the transmission volume notification unit 102.

Furthermore, the MPU 306 also operates as the bottleneck judgment unit 103 in FIG. 1. That is, the MPU 306 judges whether or not the second transmission data volume calculated as described above has exceeded a specified criterion. A concrete example of the specified criterion is described with reference to FIG. 1.

Then, the MPU 306 also operates as a part of the transmission bottleneck notification unit 104. That is, when the second transmission data volume exceeds the specified criterion, the MPU 306 judges that “the communication device 300 is a bottleneck in the network”. Then, the MPU 306 generates a packet for notification of the judgment result to the fifth communication device.

The generated packet is transmitted from all or a part of the physical ports 301a through 301d. As explained about FIG. 1, there may be one or more fifth communication devices to which the transmission bottleneck notification unit 104 notifies the judgment result.

For example, the transmission bottleneck notification unit 104 may notify a plurality of fifth communication devices of the judgment result by broadcast. In this case, the transmission bottleneck notification unit 104 is realized by the physical ports 301a through 301d, the PHY chips 302a through 302d, the FPGA 303, and the MPU 306.

Otherwise, the transmission bottleneck notification unit 104 may notify a particular fifth communication device of the judgment result. In this case, the transmission bottleneck notification unit 104 includes not only the MPU 306, but also the FPGA 303 for determining the routing destination of a packet addressed to the fifth communication device. In addition, the transmission bottleneck notification unit 104 further includes any one physical port connected to the direct destination determined by the FPGA 303, and a PHY chip connected to the physical port.

As described above, when the FPGA 303 performs the routing of a packet (that is, a direct destination is determined from the final destination of the packet), the path information storage unit 105 in FIG. 1 may be realized by the memory 305 referred to by the FPGA 303.

In the description given with reference to FIGS. 1 through 3, the network including the first through sixth communication devices was referred to. In the following description, more detailed explanation is given with reference to a concrete example of the network to support understanding the relationships among the first through sixth communication devices.

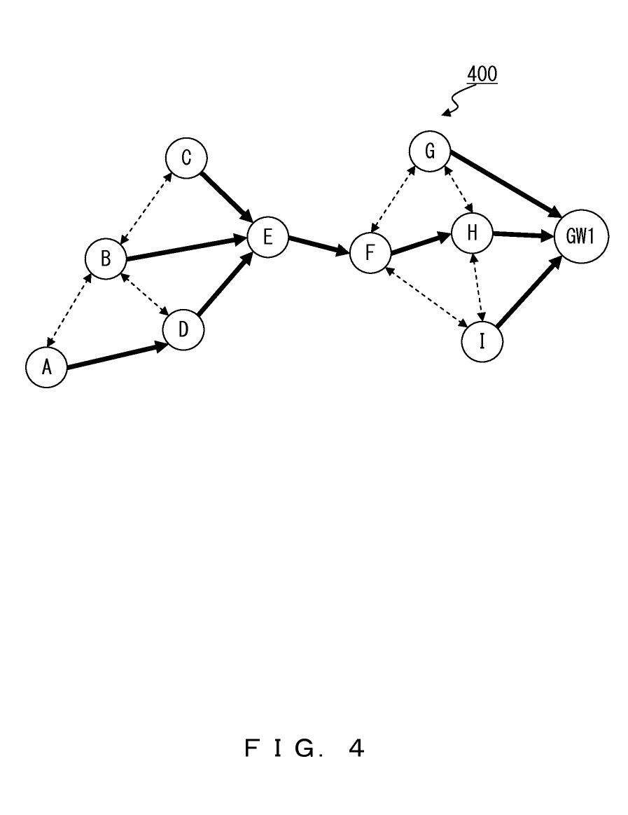

FIG. 4 is a first example of a network. A network 400 in FIG. 4 includes nodes A through I and a gateway GW1. The network 400 may be a wireless ad hoc network and a cable ad hoc network.

The second communication device as the final destination of data in the network 400 is a gateway GW1 in the example in FIG. 4. In the example in FIG. 4, it is also assumed that the fifth communication device to which the transmission bottleneck notification unit 104 transmits a notification of a judgment result is also the gateway GW1. In the first embodiment, the nodes A through H other than the gateway GW1 are communication devices similarly configured as with the communication device 100 in FIG. 1.

The nodes connected by a two-way arrow in broken line or a one-way arrow in solid line in FIG. 4 are adjacent to each other and may communicate with each other in 1 hop. A one-way arrow in solid line indicates a path practically selected in transmitting a packet with the gateway GW1 set as a destination.

For example, the meaning of an arrow is described below with reference to the node D as an example.

The arrow in solid line from the node A to the node D indicates that “the node A selects the node D as a direct destination when a packet addressed to the gateway GW1 is transmitted”. That is, when the node A is considered as the first communication device, the node D is the third communication device. On the other hand, when the node D is considered as the first communication device, the node A is the fourth communication device, and is the sixth communication device depending on the routing algorithm.

In addition, the arrow in solid line from the node D to the node E indicates that “the node D selects the node E as a direct destination when a packet addressed to the gateway GW1 is transmitted”. That is, when the node D is considered as the first communication device, the node E is the third communication device. On the other hand, the node E is considered as the first communication device, the node D is the fourth communication device, and the sixth communication device depending on the routing algorithm.

The arrow in broken line which connects the node B to the node D indicates the following three facts. That is, first, the nodes B and D may transmit and receive a packet physically in 1 hop. Second, when the node B transmits a packet addressed to the gateway GW1, the node which is selected by the node B as a direct destination is not the node D. Third, when the node D transmits a packet addressed to the gateway GW1, the node D which is selected by the node D as a direct destination is not the node B.

That is, when the node B is considered as the first communication device, the node D may be the sixth communication device, but is not the third communication device or the fourth communication device. On the other hand, when the node D is considered as the first communication device, the node B may be the sixth communication device, but is not the third communication device or the fourth communication device.

According to the meaning of the arrow as described above, the network 400 in FIG. 4 is configured as follows.

The node A is adjacent to the nodes B and D, but when a packet addressed to the gateway GW1 is transmitted, the node D is selected as a destination. The node B is adjacent to the nodes A, C, D, and E, but when a packet addressed to the gateway GW1 is transmitted, the node E is selected as a destination. The node C is adjacent to the nodes B and E, but when a packet addressed to the gateway GW1 is transmitted, the node E is selected as a destination.

The node D is adjacent to the nodes A, B, and E, but when a packet addressed to the gateway GW1 is transmitted, the node E is selected as a destination. The node E is adjacent to the nodes B, C, D, and F, but a packet addressed to the gateway GW1 is transmitted, the node F is selected as a destination. The node F is adjacent to the nodes E, G, H, and I, but when a packet addressed to the gateway GW1 is transmitted, the node H is selected as a destination.

Then, the node G is adjacent to the nodes F and H, and the gateway GW1. The node H is adjacent to the nodes F, G, and I, and the gateway GW1. Furthermore, the node I is adjacent to the nodes F and H and the gateway GW1. These nodes G, H, and I select the gateway GW1 itself as a destination when a packet addressed to the gateway GW1 is transmitted.

As clearly explained above, when the node A, B, C, G, or I is considered as the first communication device, the fourth communication device does not exist because there is no arrow in solid line toward the node A, B, C, G, or I.

Thus, when there is no fourth communication device, the notification reception unit 101 does not receive a notification of the first transmission data volume in the communication device 100 in FIG. 1 as the first communication device. In this case, the transmission volume notification unit 102 assumes the first transmission data volume as zero. Therefore, the transmission volume notification unit 102 notifies the third communication device of the volume of the data generated by the communication device 100 itself in a specified period and addressed to the second communication device as the second transmission data volume.

Since there are three arrows in solid line toward the node E, there are three fourth communication devices (that is, the three nodes B, C, and D are the fourth communication devices) when the node E is considered as the first communication device. On the other hand, when the node D is considered as the first communication device, the node corresponding to the fourth communication device is only one node A as described above. Thus, the number of the fourth communication devices is 0, 1, or more.

When the node G as a starting point of the arrow in solid line toward the gateway GW1 is considered as the first communication device, the gateway GW1 is also the second communication device and the third communication device. Thus, the second communication device may be the third communication device.

In the above-mentioned network 400, it is assumed that the nodes A through I is considered as the communication device 100 in FIG. 1. In this case, the concrete prediction and the detection of a bottleneck are explained below with reference to numerical examples.

For simple explanation, the volume of data generated by the nodes A through I in a specified period and addressed to the gateway GW1 is set to “1”. In addition, for convenience of explanation, it is assumed that the bottleneck judgment unit 103 judges that “the second transmission data volume has exceeded a specified criterion” when the second transmission data volume output from the transmission volume notification unit 102 exceeds a specified threshold of “5”.

The length of the specified period and the unit of the transmission data volume are arbitrary depending on the embodiments. For example, when the unit volume is 100 KB and the specified period is 5 minutes, the value of “1” indicates “100 KB/5 minutes”, and the value of “5” indicates “500 KB/5 minutes”.

The transmission data volume may be measured based on the payload length of a data packet. Otherwise, when the data packet has a fixed length, the transmission data volume may be measured based on the number of data packet (that is, the transmission frequency). For example, when the specified period is 30 minutes, the value of “1” may indicate “once for 30 minutes”.

As described above, when the node A is considered as the first communication device, the fourth communication device does not exist. Therefore, the transmission volume notification unit 102 of the node A notifies the node D of the transmission data volume of “1”.

Similarly, the transmission volume notification unit 102 of the node B notifies the node E of the transmission data volume of “1”. The transmission volume notification unit 102 of the node C also notifies the node E of the transmission data volume of “1”. Since the expression 1≦5 holds true, the bottleneck judgment unit 103 judges that “the second transmission data volume has not exceeded the specified criterion” in any of the nodes A, B, and C.

The notification reception unit 101 of the node D receives a notification of the transmission data volume of “1” from the node A. Then, the transmission volume notification unit 102 of the node D adds “1” as the volume of the data which is generated by the node D itself and addressed to the gateway GW1 to “1” as the notified transmission data volume, and notifies the node e of the transmission data volume of “2” obtained as a sum. Since the expression 2≦5 holds true, the bottleneck judgment unit 103 of the node D also judges that “the second transmission data volume has not exceeded the specified criterion”.

The notification reception unit 101 of the node E receives the notification of the transmission data volume of “1” from the node B, the notification of the transmission data volume of “1” from the node C, and the notification of the transmission data volume of “2” from the node D. Then, the transmission volume notification unit 102 of the node E adds “1” as the volume of the data which is generated by the node E itself and addressed to the gateway GW1 to the notified transmission data volumes of “1”, “1” and “2”. Then, the transmission volume notification unit 102 of the node E notifies the node F of the transmission data volume of “5” which is obtained as a sum. Since the expression 5≦5 holds true, the bottleneck judgment unit 103 of the node E also judges that “the second transmission data volume has not exceeded the specified criterion”.

The notification reception unit 101 of the node F receives a notification of the transmission data volume of “5” from the node E. Then, the transmission volume notification unit 102 of the node F adds “1” as the volume of the data which is generated by the node F itself and addressed to the gateway GW1 to “5” as the notified transmission data volume, and notifies the node H of “6” as the transmission data volume obtained as a sum.

Since the expression 6>5 holds true, the bottleneck judgment unit 103 of the node F judges that “the second transmission data volume has exceeded the specified criterion”. Therefore, the transmission bottleneck notification unit 104 of the node F judges that “the node F is a bottleneck in the network 400”, and notifies the gateway GW1 of the judgment result.

Furthermore, as described above, when the node G is considered as the first communication device, the fourth communication device does not exist. Therefore, the transmission volume notification unit 102 of the node G notifies the gateway GW1 of “1” as the transmission data volume.

The notification reception unit 101 of the node H receives “6” as the notification of the transmission data volume from the node F. Then, the transmission volume notification unit 102 of the node H adds “1” as the volume of the data which is generated by the node H itself and addressed to the gateway GW1 to “6” as the notified transmission data volume, and notifies the gateway GW1 of “7” as the transmission data volume obtained as a sum.

Since the expression 7>5 holds true, the bottleneck judgment unit 103 of the node H judges that “the second transmission data volume has exceeded the specified criterion”. Therefore, the transmission bottleneck notification unit 104 of the node H judges that “the node H is a bottleneck in the network 400”, and notifies the gateway GW1 of the judgment result.

As described above, when the node I is considered as the first communication device, the fourth communication device does not exist. Therefore, the transmission volume notification unit 102 of the node I notifies the gateway GW1 of “1” as the transmission data volume.

The gateway GW1 receives “1”, “7”, and “1” as the notifications of the transmission data volumes respectively from the nodes G, H, and I as described above. The gateway GW1 receives the notifications that “the node F is a bottleneck”, and that “the node H is a bottleneck” respectively from the nodes F and H.

The notification of the bottleneck from the nodes F and H to the gateway GW1 may be transmitted to the gateway GW1 by, for example, the routing along the arrow in solid line in the network 400 as with the normal data packet.

In addition, upon receipt of a notification of a bottleneck, the gateway GW1 may display the notified contents on a display. Otherwise, the gateway GW1 may, for example, transmit a notification of a bottleneck by electronic mail addressed to a network administrator. Then, at the information on the display or upon receipt of the electronic mail, the network administrator may, for example, take an appropriate measure such as setting a new node etc.

According to the first embodiment described above with reference to FIGS. 1 through 4, since a bottleneck may be predicted or detected in a network, it is very useful. Furthermore, by including the notifications of the first and second transmission data volumes in a packet used in a normal communication, each node in the network 400 may autonomously predict or detect a bottleneck without excessively increasing traffic.

In the first embodiment above, the bottleneck judgment unit 103 makes a judgment based on the second transmission data volume as a sum of the first transmission data volume indicating the volume of the data received by the communication device 100 and the volume of the data which is generated by the communication device 100 itself and addressed to the second communication device. However, depending on the embodiments, there may be a communication device which does not generate itself the data addressed to the second communication device (that is, a communication device exclusive to a relay). Furthermore, if a communication device enters an overload state only by receiving data from another adjacent communication device and by generating and transmitting data addressed to the second communication device, then it is clear that the overload state becomes worse.

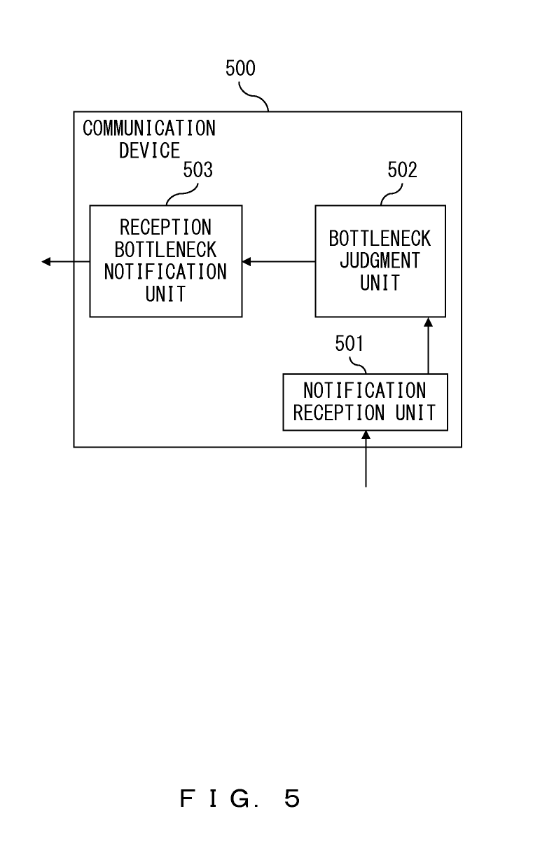

In the second embodiment illustrated in FIG. 5, the communication device judges whether or not the communication device itself is a bottleneck in the network based on the volume of the data received from other adjacent communication devices regardless of the volume of the data generated by the device itself.

FIG. 5 is a block diagram of a configuration of the communication device according to the second embodiment. A communication device 500 in FIG. 5 is used in the network including a plurality of communication devices. The network is, for example, a cable or wireless ad hoc network. To be more concrete, the network 400 in FIG. 4 is applicable. For convenience in the explanation below relating to FIG. 5, the communication devices in the network are referred to as “the first communication device” through “the fourth communication device”. The first through fourth communication devices in the explanation relating to FIG. 5 call for caution that they are different from the first through fourth communication devices in the explanation relating to FIGS. 1 through 4.

For convenience, the communication device 500 itself is hereafter referred to as a “first communication device”.

Furthermore, for convenience, each of one or more communication devices adjacent to the communication device 500 is hereafter referred to as “second communication devices”.

Then, for convenience, a particular communication device as the final destination of the data in the network is referred to as a “third communication device”. The third communication device may be, for example, the gateway GW1.

In addition, when the communication device 500 itself judges that “the communication device 500 is a bottleneck which refers to the concentration of a communication load in the network”, a communication device for which a destination of a notification of the judgment result of the communication device 500 is determined in advance is referred to as a “fourth communication device” for convenience.

A particular communication device in the network may be determined in advance as the fourth communication device. For example, the fourth communication device may be equal to the third communication device. Otherwise, a plurality of communication devices may be determined in advance as a plurality of fourth communication devices. For example, all communication devices other than the communication device 500 in the network may be determined in advance as a plurality of fourth communication devices.

The communication device 500 in FIG. 5 is the first communication device in the network including the above-mentioned first through fourth communication devices. Then, as illustrated in FIG. 5, the communication device 500 includes a notification reception unit 501, a bottleneck judgment unit 502, and a reception bottleneck notification unit 503.

The notification reception unit 501 receives from each of one or more second communication devices adjacent to the communication device 500 a notification of the first transmission data volume as the volume of the data addressed to the third communication device and transmitted by each second communication device in a specified period.

The operation of the notification reception unit 501 is similar to the operation of the notification reception unit 101 in FIG. 1, and the length of the specified period may be arbitrary. As in the first embodiment, it is more preferable from the viewpoint of suppressing the traffic that the notification of the first transmission data volume is transmitted by adding the notification to a packet used in a normal communication than by transmitting the notification using a dedicated control packet.

The bottleneck judgment unit 502 calculates the second transmission data volume obtained by aggregating the first transmission data volume notified from each of one or more second communication devices. Furthermore, the bottleneck judgment unit 502 judges whether or not the calculated second transmission data volume has exceeded a specified criterion.

The aggregation performed by the bottleneck judgment unit 502 may be, for example, a simple addition. Furthermore, the bottleneck judgment unit 502 compares the calculated second transmission data volume with a specified threshold, and if the second transmission data volume has exceeded the specified threshold, it may judge that “the second transmission data volume has exceeded the specified criterion”.

When the bottleneck judgment unit 502 judges that “the second transmission data volume has exceeded the specified criterion”, the reception bottleneck notification unit 503 notifies the fourth communication device that “the communication device 500 is a bottleneck in the network”. The notification to the fourth communication device is, in other words, a warning that “the volume of the data received by the communication device 500 is excessive, and the communication device 500 enters an overload state only by receiving data”.

Therefore, according to the notification from the reception bottleneck notification unit 503 to the fourth communication device, it is preferable to take measures for reducing the excessive load. Since an example of measures is described above with reference to the first embodiment, the description is omitted here.

Furthermore, the communication device 500 described above may be realized by the hardware illustrated in, for example, FIG. 2 or 3.

For example, when the network including the communication device 500 is a wireless network, the communication device 500 may be realized by the communication device 200 in FIG. 2. That is, the notification reception unit 501 may be realized by the 802.15.4 PHY/MAC chip 205, and the bottleneck judgment unit 502 may be realized by the MPU 201 and the DRAM 203.

Then, the reception bottleneck notification unit 503 may be realized by the MPU 201 and the 802.11b PHY/MAC chip 206, or by the MPU 201 and the 802.15.4 PHY/MAC chip 205. In addition, when the communication device 500 is dedicated to a relay operation, the sensor 207 may be omitted.

Otherwise, when the network including the communication device 500 is a cable network, the communication device 500 may be realized by the communication device 300 in FIG. 3. For convenience of explanation, it is assumed, for example, that there are two second communication devices, and two second communication devices are respectively connected to the physical ports 301a and 301b. Then, the notification reception unit 501 is concretely realized by the physical ports 301a and 301b and the PHY chips 302a and 302b.

Furthermore, as with the explanation above relating to FIG. 3, it is assumed that the FPGA 303 performs the routing, and other processes are performed by the MPU 306. Then, the bottleneck judgment unit 502 is realized by the MPU 306 and the memory 307.

The MPU 306 may also operate as a part of the reception bottleneck notification unit 503. That is, when the second transmission data volume exceeds a specified criterion, the MPU 306 judges that “the communication device 300 is a bottleneck in the network”. Then, the MPU 306 generates a packet for notification of the judgment result to the fourth communication device.

The generated packet is transmitted from all or a part of the physical ports 301a through 301d. As described above, there may be one or more fourth communication devices in the second embodiment.

For example, the reception bottleneck notification unit 503 may notify a plurality of fourth communication devices of a judgment result by broadcast. In this case, the reception bottleneck notification unit 503 is realized by the physical ports 301a through 301d, the PHY chips 302a through 302d, the FPGA 303, and the MPU 306.

Otherwise, the reception bottleneck notification unit 503 may notify a particular fourth communication device of the judgment result. In this case, the reception bottleneck notification unit 503 includes, not only the MPU 306, but also the FPGA 303 for determining the routing destination of a packet addressed the fourth communication device. Furthermore, the reception bottleneck notification unit 503 further includes a physical port connected to a direct destination determined by the FPGA 303, and a PHY chip connected to the physical port.

For example, in the network 400 in FIG. 4, unlike the first embodiment, it is assumed that the node H is a communication device dedicated to a relay operation. It is also assumed that the nodes A through G and I are the communication devices 100 in the first embodiment, and the node H is the communication device 500 in the second embodiment. Also assume that the bottleneck judgment unit 502 judges that “the second transmission data volume has exceeded a specified criterion” when the second transmission data volume obtained by the aggregation exceeds a specified threshold of “5”.

As explained above relating to the first embodiment, the transmission volume notification unit 102 of the node F notifies the node H of the transmission data volume of “6”. Therefore, the notification reception unit 501 of the node H receives a notification of the transmission data volume of “6” from the node F.

In the network 400 in FIG. 4, when the node H is considered as the first communication device in the second embodiment, the node corresponding to the second communication device is only the node F. Therefore, the bottleneck judgment unit 502 of the node H simply recognizes the transmission data volume of “6” notified from the node F as the aggregated second transmission data volume. Since the expression 6>5 holds true, the bottleneck judgment unit 502 of the node H judges that “the second transmission data volume has exceeded a specified criterion”, and notifies the gateway GW1 as the fourth communication device of the judgment result.

The communication device 500 according to the second embodiment described above may be transformed as follows. That is, the communication device 500 may further include a transmission volume notification unit not illustrated in the attached drawings. Then, the transmission volume notification unit not illustrated in the attached drawings may notify the communication device adjacent to the communication device 500 which may be selectable as a direct destination when the communication device 500 transmits data addressed to the third communication device of the second transmission data volume aggregated by the bottleneck judgment unit 502. The communication device 500, which is transformed so that it includes the transmission volume notification unit not illustrated in the attached drawings is applicable to, for example, the communication device dedicated to a relay operation.

The above-mentioned transmission volume notification unit not illustrated in the attached drawings may also be realized by, for example, the 802.15.4 PHY/MAC chip 205 in FIG. 2. Otherwise, the above-mentioned transmission volume notification unit not illustrated in the attached drawings may also be realized by all or a part of the physical ports 301a through 301d and the PHY chips 302a through 302d illustrated in FIG. 3.

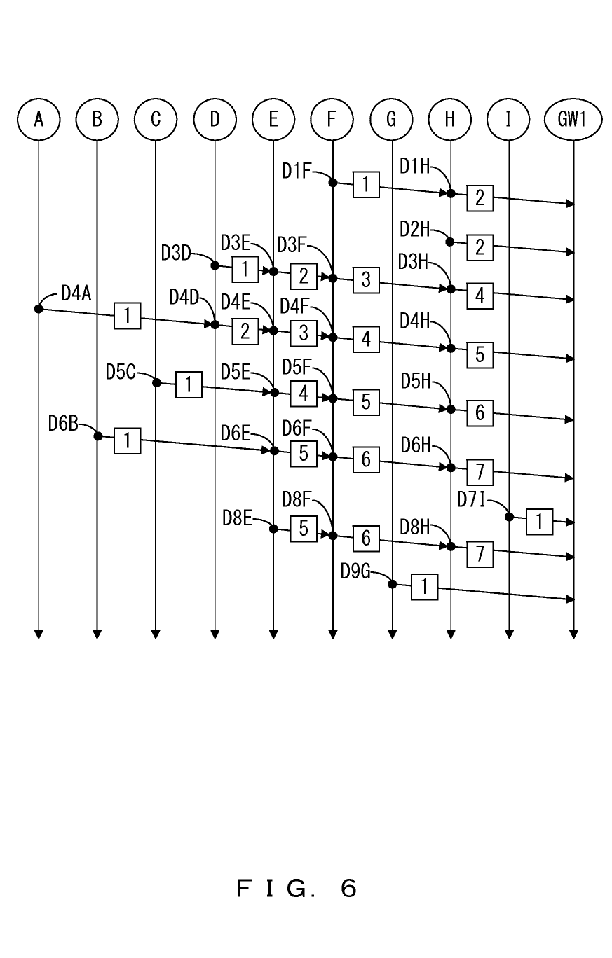

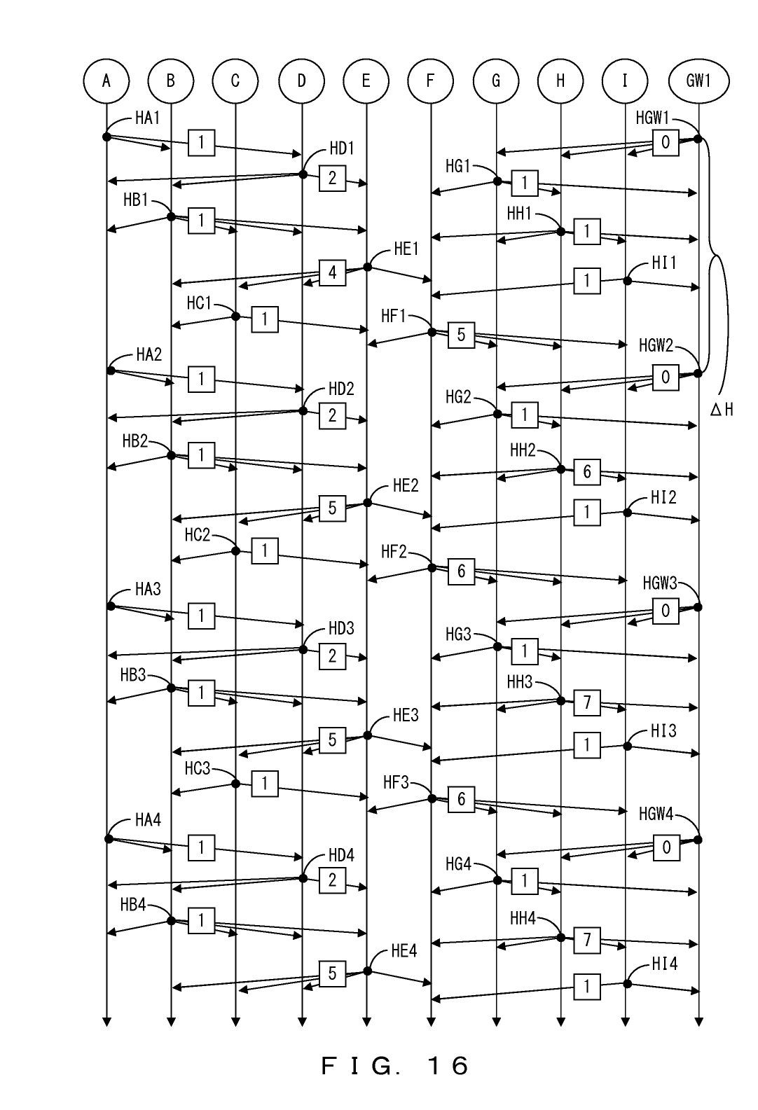

As explained above relating to the first through second embodiments, it is preferable that the transmission data volume is notified as embedded in a packet used in a normal communication. Then, to be more concrete in the following description, the third embodiment in which the transmission data volume is embedded in a data packet is explained with reference to FIGS. 6 through 15, and the fourth embodiment in which the transmission data volume is embedded in a hello packet is explained with reference to FIGS. 16 through 21.

Described next is the fifth through eleventh embodiments obtained by transforming the third or fourth embodiment. In the following explanation, the network 400 in FIG. 4 is referenced as a concrete example of a network. Furthermore, the network 400 may be a cable ad hoc network, but mainly described below is the case in which the network 400 is a wireless ad hoc network for convenience of explanation.

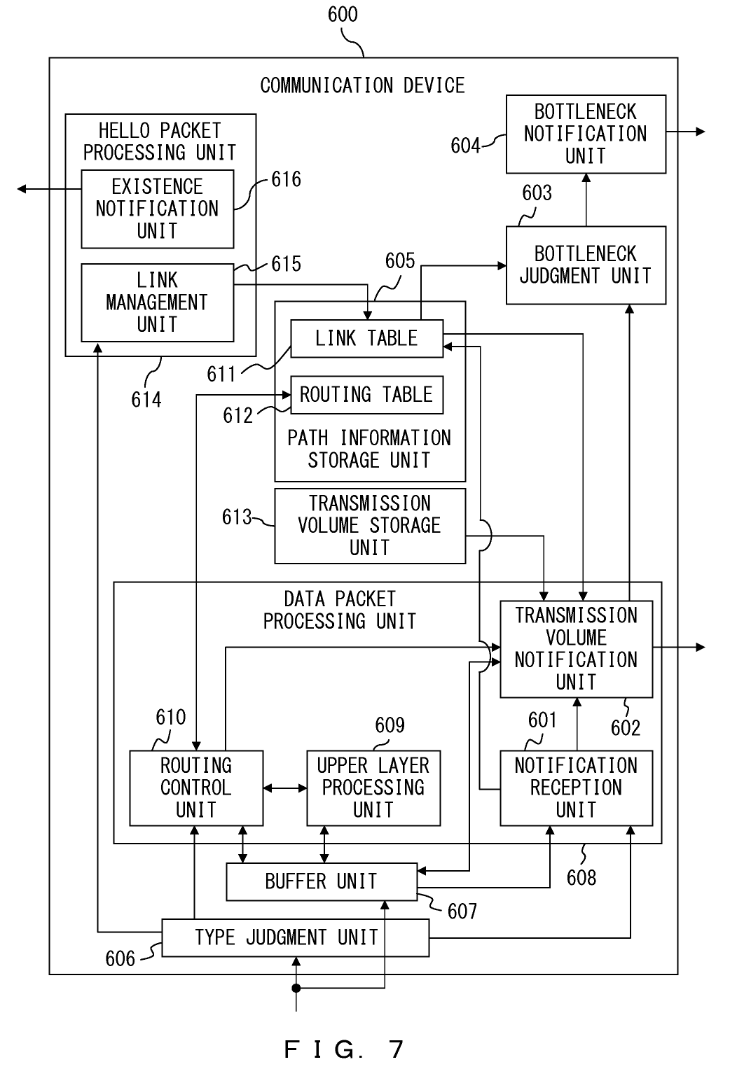

FIG. 6 is a timing chart relating to the transmission and reception of a data packet according to the third embodiment. The timing chart in FIG. 6 illustrates the transmission and reception of a data packet when each of the nodes A through I in FIG. 4 is a communication device 600 according to the third embodiment described later with reference to FIG. 7.

In the third embodiment, it is assumed that the final destination of the data packet in the network 400 is concretely the gateway GW1. It is also assumed that the destination of a notification of a judgment result relating to a bottleneck from each of the nodes A through I is also the gateway GW1.

The nodes A through I transmit a data packet with appropriate timing. In FIG. 6, each data packet is identified by a 3-character reference code. The first character is “D” indicating a data packet. The second character is a numeral for identification of each data packet.

The data packet is a target of a multihop transmission in the third embodiment, and the value of a field of a part of the data packet is rewritten for each hop. Then, to identify a change for each hop, the third character of the reference code of each data packet is an alphabetical character as a reference code of a direct source node in each hop.

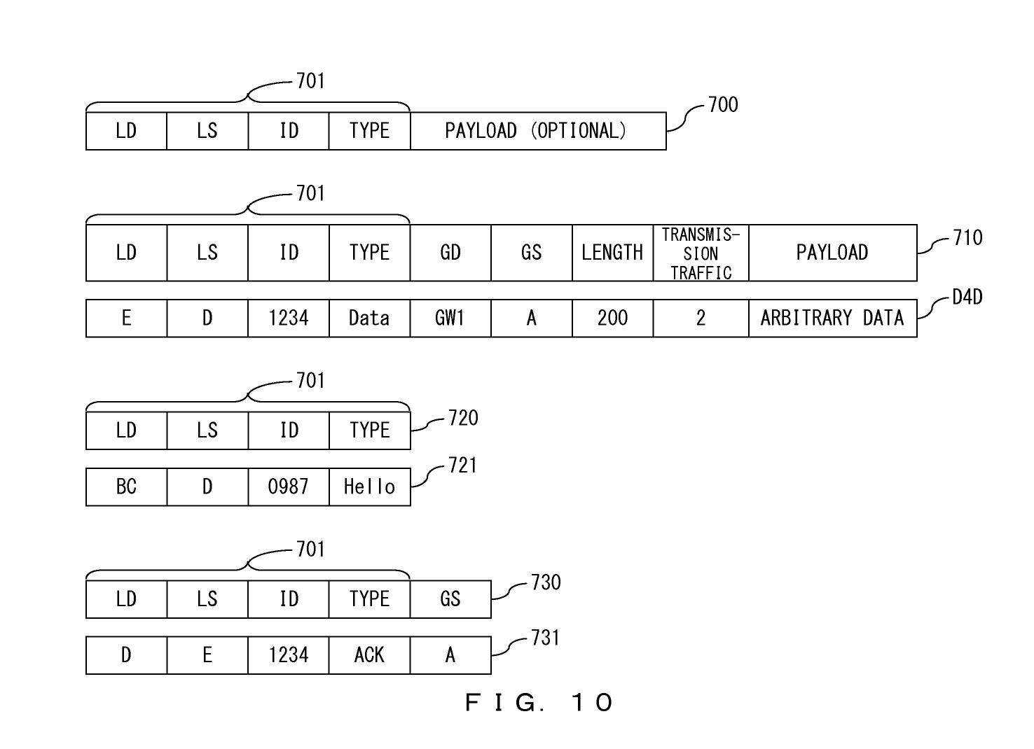

Furthermore, as described later in detail with reference to FIG. 10, a data packet includes a field of “transmission traffic” in the third embodiment. The values corresponding to the first and second transmission data volumes explained with reference to the first embodiment are set as transmission traffic in the third embodiment. Then, the value of the transmission traffic is rewritten for each hop.

In FIG. 6, each arrow indicates the transmission in one hop of each data packet. Then, the value in the rectangle overwritten on each arrow indicates the value of the transmission traffic in the data packet indicated by the arrow.

For convenience in the following explanation, as with the explanation relating to FIG. 4, it is assumed that the expected value of the volume of the data which is generated in a specified period by each of the nodes A through I and addressed to the gateway GW1 is “1”. In addition, it is also assumed that the threshold for judgment of a bottleneck is “5”.

When a setting is practically made so that a node generates a specified volume of data in a specified period and is addressed to the gateway GW1, and when an operation is performed according to the setting, the above-mentioned “expected value” is the specified set volume. Therefore, in this case, an actual bottleneck may be detected.

Furthermore, the above-mentioned “expected value” may be planned or predicted. For example, a value planned after changing a setting may be used as an “expected value” for the purpose of, for example, “checking before actually changing a set value as to whether or not there is a possibility that a bottleneck is newly caused by changing the set value”. In this case, a bottleneck may be predicted.

The nodes A through I may generate and transmit a data packet including the data output from the sensor as a payload according to, for example, a specified schedule. Otherwise, the nodes A through I may generate and transmit a data packet with variable timing not determined in advance depending on the change of the output of a sensor. That is, the timing with which each of the nodes A through I in the network 400 transmits a data packet is arbitrary.

In addition, “the time taken to transmit a data packet addressed to the gateway GW1 at least once by each of the nodes A through I in the network 400, and allow the data packet to reach the gateway GW1” is referred to as “1 round” for convenience. As understood from the example in FIG. 6 described below, the time taken to predict or detect any bottleneck in the network 400 is 1 round at most regardless of the sequence in which the data packets are transmitted by each of the nodes A through I.

In FIG. 6, for example, the following case is exemplified.

First, the node F transmits a data packet D1F. The value of the transmission traffic set in the data packet D1F is “1” because the node F has not received any data packet from other nodes before the transmission of the data packet D1F. Therefore, “1” as the expected value of the volume of the data addressed to the gateway GW1 in a specified period by the node F is set as transmission traffic in the data packet D1F.

Furthermore, the final destination in the network 400 of the data packet D1F is the gateway GW1. However, as indicated by the arrow in solid line in FIG. 4, the packet transmitted by the node F to the gateway GW1 is directly transmitted to the node H adjacent to the node F, and reaches the gateway GW1 by way of the node H.

In the following descriptions, the final destination of the packet in the network 400 is referred to as a GD (global destination), and the first source of the packet in the network 400 is referred to as a GS (global source). In addition, the direct destination when the transmission in one hop is considered is referred to as an LD (local destination), and the direct source is referred to as an LS (local source).

For example, for the packet transmitted by the node F and addressed to the gateway GW1, the GD is the gateway GW1, and the GS is the node F. The GD and the GS are not changed while a packet is multi-hop transmitted in the network 400.

On the other hand, the LD and the LS change for each hop. That is, when a packet having the gateway GW1 as a GD is transmitted from the node F, the LD is the node H, and the LS is the node F. However, when the packet is relayed by the node H, the LD is the gateway GW1, and the LS is the node H. Therefore, for the above-mentioned data packet D1F, the GD is the gateway GW1, the GS is the node F, the LD is the node H, and the LS is the node F.

Upon receipt of the data packet D1F from the node F, the node H transmits a data packet D1H whose LD, LS, and transmission traffic have been rewritten. The LD and the LS of the data packet D1H are the gateway GW1 and the node H respectively.

Furthermore, in the example in FIG. 6, the node H has not received any data packet from other nodes before the reception of the data packet D1F. Therefore, “2” as a sum of the value of “1”, which is set in the data packet D1F, and the value of “1” as an expected value of the volume of the data that is addressed to the gateway GW1 and transmitted by the node H in a specified period is set in the transmission traffic of the data packet D1H. Then, the data packet D1H transmitted by the node H is received by the gateway GW1.

In the example in FIG. 6, the node H next generates and transmits a new data packet D2H addressed to the gateway GW1. Since there is an arrow in solid line in FIG. 4 from the node H to the gateway GW1, the data packet D2H reaches the gateway GW1 in one hop.

Furthermore, the node H has already received the data packet D1F from the node F before the transmission of the data packet D2H. Therefore, in the data packet D2H as with the data packet D1H, the value of “2” as transmission traffic is set. Then, the data packet D2H is received by the gateway GW1.

Furthermore, in the example in FIG. 6, the node D next generates and transmits a new data packet D3D addressed to the gateway GW1. As indicated by the arrow in solid line in FIG. 4, a data packet transmitted by the node D and addressed to the gateway GW1 reaches the gateway GW1 by way of the nodes E, F, and H.

According to FIG. 6, the node D has not received any data packet from other nodes before the transmission of the data packet D3D. Therefore, “1” as an expected value of the volume of the data that is addressed to the gateway GW1 and transmitted by the node D in a specified period is set as transmission traffic in the data packet D3D.

The data packet D3D transmitted from the node D is received by the adjacent node E. Upon receipt of the data packet D3D, the node E transmits a data packet D3E for which the LD, the LS, and the transmission traffic have been rewritten. The LD and the LS of the data packet D3E are nodes F and E respectively.

In the example in FIG. 6, the node E has not received any data packet from other nodes before the reception of the data packet D3D. Therefore, a sum “2” of the value “1” set in the data packet D3D and the value “1” as an expected value of the volume of the data that is addressed to the gateway GW1 and transmitted by the node E in a specified period is set in the transmission traffic of the data packet D3E. Then, the data packet D3E transmitted by the node E is received by the node F.

Upon receipt of the data packet D3E, the node F transmits a data packet D3F whose LD, LS, and transmission traffic have been rewritten. The LD and the LS of the data packet D3F are nodes H and F respectively.

Furthermore, according to FIG. 6, the node F has not received any data packet from other nodes before the reception of the data packet D3E. Therefore, the value “3” as a sum of the value “2” set in the data packet D3E and the value “1” as an expected value of the volume of the data that is addressed to the gateway GW1 and transmitted by the node F in a specified period is set in the transmission traffic of the data packet D3F. Then, the data packet D3F transmitted by the node F is received by the node H.

Upon receipt of the data packet D3F, the node H transmits a data packet D3H whose LD, LS, and transmission traffic have been rewritten. The LD and the LS of the data packet D3H are the gateway GW1 and the node H respectively.

The node H has already received the data packet D1F before the reception of the data packet D3F. However, since the LS of the previously received data packet D1F is equal to the LS of the currently received data packet D3F, the node H ignores the value of the transmission traffic set in the data packet D1F.

As a result, “4” as a sum of the value of “3” set in the data packet D3F and “1” as an expected value of the volume of the data that is addressed to the gateway GW1 and transmitted by the node H in a specified period is set in the transmission traffic of the data packet D3H. Then, the data packet D3H transmitted by the node H is received by the gateway GW1.

In the example in FIG. 6, the node A next generates and transmits a new data packet D4A addressed to the gateway GW1. As indicated by the arrows in solid lines in FIG. 4, the data packet addressed to the gateway GW1 and transmitted by the node A reaches the gateway GW1 by way of the nodes D, E, F, and H.

According to FIG. 6, the node A has not received any data packet from other nodes before the transmission of the data packet D4A. Therefore, “1” as an expected value of the volume of the data that is addressed to the gateway GW1 and transmitted by the node A in a specified period is set as transmission traffic in the data packet D4A.

The data packet D4A transmitted from the node A is received by the adjacent node D. Upon receipt of the data packet D4A, the node D transmits a data packet D4D whose LD, LS, and transmission traffic have been rewritten. The LD and the LS of the data packet D4D are the node E and the node D respectively.

In the example in FIG. 6, the node D has not received any data packet from other nodes before the reception of the data packet D4A. Therefore, “2” as a sum of the value of “1” set in the data packet D4A and “1” as an expected value of the volume of the data that is addressed to the gateway GW1 and transmitted by the node D in a specified period is set in the transmission traffic of the data packet D4D. Then, the data packet D4D transmitted by the node D is received by the node E.

Upon receipt of the data packet D4D, the node E transmits a data packet D4E whose LD, LS, and transmission traffic have been rewritten. The LD and the LS of the data packet D4E are the node F and the node E respectively.

The node E has already received the data packet D3D before the reception of the data packet D4D. However, since the LS of the previously received data packet D3D is equal to the LS of the currently received data packet D4D, the node E ignores the value of the transmission traffic set in the data packet D3D.

As a result, “3” as a sum of the value of “2” set in the data packet D4D and “1” as an expected value of the volume of the data that is addressed to the gateway GW1 and transmitted by the node E in a specified period is set in the transmission traffic of the data packet D4E. Then, the data packet D4E transmitted by the node E is received by the node F.

Upon receipt of the data packet D4E, the node F transmits a data packet D4F whose LD, LS, and transmission traffic have been rewritten. The LD and the LS of the data packet D4F are node H and the node F respectively.

In addition, the node F has already received the data packet D3E before the reception of the data packet D4E. However, since the LS of the previously received data packet D3E is equal to the LS of the currently received data packet D4E, the node F ignores the value of the transmission traffic set in the data packet D3E.

As a result, “4” as a sum of the value of “3” set in the data packet D4E and “1” as an expected value of the volume of the data that is addressed to the gateway GW1 and transmitted by the node F in a specified period is set in the transmission traffic of the data packet D4F. Then, the data packet D4F transmitted by the node F is received by the node H.

Upon receipt of the data packet D4F, the node H transmits a data packet D4H whose LD, LS, and transmission traffic have been rewritten. The LD and the LS of the data packet D4H are gateway GW1 and the node H respectively.

Furthermore, the node H has already received the data packets D1F and D3F before the reception of the data packet D4F. However, since the LS of each of the previously received data packets D1F and D3F is equal to the LS of the currently received data packet D4F, the node H ignores the values of the transmission traffic set in the data packets D1F and D3F.

As a result, “5” as a sum of the value of “4” set in the data packet D4F and “1” as an expected value of the volume of the data that is addressed to the gateway GW1 and transmitted by the node H in a specified period is set in the transmission traffic of the data packet D4H. Then, the data packet D4H transmitted by the node H is received by the gateway GW1.

In the example in FIG. 6, the node C next generates and transmits a new data packet D5C addressed to the gateway GW1. As indicated by the arrow in solid line in FIG. 4, the data packet addressed by the node C to the gateway GW1 reaches the gateway GW1 through the nodes E, F, and H.

According to FIG. 6, the node C has not received any data packet from other nodes before the transmission of the data packet D5C. Therefore, “1” as an expected value of the volume of the data that is addressed to the gateway GW1 and transmitted by the node C in a specified period is set as transmission traffic in the data packet D5C.

The data packet D5C transmitted from the node C is received by the adjacent node E. Upon receipt of the data packet D5C, the node E transmits a data packet D5E whose LD, LS, and transmission traffic have been rewritten. The LD and the LS of the data packet D5E are the node F and the node E respectively.

The node E has already received the data packets D3D and D4D before the reception of the data packet D5C. The LS of each of the data packets D3D and D4D is node D, but the LS of the data packet D5C is node C.

Therefore, the node E ignores the value of the transmission traffic set in the data packet D3D which is older between the two data packets D3D and D4D having the equal LS, but considers the value of the transmission traffic set in the newer data packet D4D. In addition, the node E also considers the value of the transmission traffic set in the data packet D5C having a different LS from the node D.

Therefore, “4” as a sum of the values of “2” and “1” set in the data packets D4D and D5C respectively and “1” as an expected value of the volume of the data that is addressed to the gateway GW1 and transmitted by the node E in a specified period is set in the transmission traffic of the data packet D5E. Then, the data packet D5E transmitted by the node E is received by the node F.

Upon receipt of the data packet D5E, the node F transmits a data packet D5F whose LD, LS, and transmission traffic have been rewritten. The LD and the LS of the data packet D5F are nodes H and F respectively.

In addition, the node F has already received the data packets D3E and D4E before the reception of the data packet D5E. However, since the LS of each of the previously received data packets D3E and D4E is equal to the LS of the currently received data packet D5E, the node F ignores the value of the transmission traffic set in the data packets D3E and D4E.

As a result, “5” as a sum of the value of “4” set in the data packet D5E and “1” as an expected value of the volume of the data that is addressed to the gateway GW1 and transmitted by the node F in a specified period is set in the transmission traffic of the data packet D5F. Then, the data packet D5F transmitted by the node F is received by the node H.

Upon receipt of the data packet D5F, the node H transmits a data packet D5H whose LD, LS, and transmission traffic have been rewritten. The LD and the LS of the data packet D5H are the gateway GW1 and the node H respectively.

The node H has already received the data packets D1F, D3F, and D4F before the reception of the data packet D5F. However, since the LS of each of the previously received data packets D1F, D3F, and D4F is equal to the LS of the currently received data packet D5F, the node H ignores the value of the transmission traffic set in the data packets D1F, D3F, and D4F.

As a result, “6” as a sum of the value of “5” set in the data packet D5F and “1” as an expected value of the volume of the data that is addressed to the gateway GW1 and transmitted by the node H in a specified period is set in the transmission traffic of the data packet D5H. Then, the data packet D5H transmitted by the node H is received by the gateway GW1.

In addition, based on the assumption above, the threshold for judgment of a bottleneck is “5”, and the expression 6>5 holds true. Therefore, the node H judges that “the node H is a bottleneck in the network 400” when the data packet D5F is received, and a judgment result is notified to the gateway GW1.

For convenience in the following explanation, the notification of the judgment result of a bottleneck is also referred to as a “bottleneck notification”. In FIG. 6, the bottleneck notification is omitted.

The bottleneck notification may be transmitted to the gateway GW1 after routing in the network 400 like, for example, the normal data packet. Otherwise, the bottleneck notification may be transmitted to the gateway GW1 in a method different from the normal data packet.

For example, in a multi-channel communication system, a bottleneck notification may be transmitted through a radio frequency channel different from the radio frequency channel used for a normal data packet. A bottleneck notification is a kind of warning. Thus, the bottleneck notification may preferably be transmitted to the gateway GW1, which is the destination, certainly by avoiding a collision with communication of a normal data packet. Such avoidance of a collision may be realized by using a radio frequency channel dedicated for a bottleneck notification. Even when the radio frequency channel dedicated for a bottleneck notification is used, the bottleneck notification may be routed in the network in a manner similar to that used for routing a data packet.

Otherwise, a bottleneck notification may be transmitted according to a communication standard different from the communication standard used in transmission and reception of normal data packets. For example, a normal data packet may be transmitted in accordance with the IEEE 802.15.4 standard, which is featured by low energy consumption. On the other hand, the bottleneck notification may be transmitted in accordance with the IEEE 802.11b standard, which is higher in energy consumption but has a longer communication distance than the IEEE 802.15.4 standard.

Then, in a normal operation, the merit of low energy consumption may be utilized. On the other hand, when a bottleneck is predicted or detected, the gateway GW1 may recognize a bottleneck certainly with high output power and quickly in a small hop count.

When two different communication standards as described above are used, the bottleneck notification routing path is normally different from the path through which a data packet is routed. Thus, each node manages the path information about each of the two standards.

At the reception of the data packet D5F, after the node H transmits the data packet D5H and the bottleneck notification in the example in FIG. 6, the node B next generates and transmits a new data packet D6B addressed to the gateway GW1. As indicated by the arrows in solid lines in FIG. 4, the data packet that is addressed to the gateway GW1 and transmitted by the node B reaches the gateway GW1 by way of the nodes E, F, and H.

According to FIG. 6, the node B has not received any data packet from other nodes before the transmission of the data packet D5B. Therefore, “1” as an expected value of the volume of the data that is addressed to the gateway GW1 and transmitted by the node B in a specified period is set as transmission traffic in the data packet D5B.

The data packet D6B transmitted from the node B is received by the adjacent node E. Upon receipt of the data packet D6B, the node E transmits a data packet D6E whose LD, LS, and transmission traffic have been rewritten. The LD and the LS of the data packet D6E are the nodes F and E respectively.

The node E has already received the data packets D3D, D4D, and D5C before the reception of the data packet D6B. The LS of each of the data packets D3D and D4D is the node D. The LS of the data packet D5C is the node C. The LS of the data packet D6B is the node B.

Therefore, the node E ignores the value of the transmission traffic set in the data packet D3D which is older between the two data packets D3D and D4D having an equal LS, but considers the value of the transmission traffic set in the data packet D4D which is newer between them. In addition, the node E also considers the value of the transmission traffic set in the data packet D5C having a different LS from the node D. Furthermore, the node E also considers the value of the transmission traffic set in the data packet D6B having different LS from the nodes D and C.

Therefore, “5” is set in the transmission traffic of the data packet D6E. The value of “5” is a sum of “2”, “1”, and “1” respectively set in the data packets D4D, D5C, and D6B, and “1” as an expected value of the volume of the data that is addressed to the gateway GW1 and transmitted by the node E in a specified period. Then, the data packet D6E transmitted by the node E is received by the node F.

Upon receipt of the data packet D6E, the node F transmits a data packet D6F whose LD, LS, and transmission traffic have been rewritten. The LD and the LS of the data packet D6F are the nodes H and F respectively.

In addition, the node F has already received the data packets D3E, D4E, and D5E before the reception of the data packet D6E. However, since the LS of each of the previously received data packets D3E, D4E, and D5E is equal to the LS of the currently received data packet D6E, the node F ignores the value of the transmission traffic set in the data packets D3E, D4E, and D5E.

As a result, “6” as a sum of “5” set in the data packet D6E and “1” as an expected value of the volume of the data that is addressed to the gateway GW1 and transmitted by the node F in a specified period is set in the transmission traffic of the data packet D6F. Then, the data packet D6F transmitted by the node F is received by the node H.

In addition, by the assumption above, the threshold for judgment of a bottleneck is “5”, and the expression 6>5 holds true. Therefore, when the data packet D6E is received, the node F judges that “the node F is a bottleneck in the network 400”, and transmits a bottleneck notification addressed to the gateway GW1.

Then, upon receipt of the data packet D6F, the node H transmits a data packet D6H whose LD, LS, and transmission traffic have been rewritten. The LD and the LS of the data packet D6H are the gateway GW1 and the node H respectively.

In addition, the node H has already received the data packets D1F, D3F, D4F, and D5F before the reception of the data packet D6F. However, since the LS of each of the previously received data packets D1F, D3F, D4F, and D5F is equal to the LS of the currently received data packet D6F, the node H ignores the value of the transmission traffic set in the data packets D1F, D3F, D4F, and D5F.

As a result, “7” as a sum of “6” set in the data packet D6F and “1” as an expected value of the volume of the data that is addressed to the gateway GW1 and transmitted by the node H in a specified period is set in the transmission traffic of the data packet D6H. Then, the data packet D6H transmitted by the node H is received by the gateway GW1.

Based on the assumption above, the threshold for the judgment of the bottleneck is “5”, and the expression 7>5 holds true. Therefore, the node H transmits the bottleneck notification again to the gateway GW1 when the data packet D6H is received.

Next, in the example in FIG. 6, the node I generates and transmits a new data packet D7I addressed to the gateway GW1. Since there is an arrow in solid line from the node I to the gateway GW1 in FIG. 4, the data packet D7I reaches the gateway GW1 in 1 hop.

Furthermore, according to FIG. 6, the node I has not received any data packet from other nodes before the transmission of the data packet D7I. Therefore, “1” as an expected value of the volume of the data that is addressed to the gateway GW1 and transmitted by the node I in a specified period is set as the transmission traffic in the data packet D7I. Then, the data packet D7I transmitted by the node I is received by the gateway GW1.

Then, in the example in FIG. 6, the node E generates and transmits a new data packet D8E addressed to the gateway GW1. As indicated by the arrows in solid lines in FIG. 4, the data packet addressed to the gateway GW1 and transmitted by the node E reaches the gateway GW1 by way of the nodes F and H.

According to FIG. 6, the node E has already received the data packets D3D, D4D, D5C, and D6B before the transmission of the data packet D8E. The LS of each of the data packets D3D and D4D is node D. The LS of the data packet D5C is node C, and the LS of the data packet D6B is the node B.

Furthermore, the node E sets “5” as the transmission traffic in the data packet D8E as with the data packet D6E. Then, the data packet D8E transmitted by the node E is received by the node F.

The data packet D8E transmitted from the node E is received by the adjacent node F. Upon receipt of the data packet D8E, the node F transmits a data packet D8F whose LD, LS, and transmission traffic have been rewritten. The LD and the LS of the data packet D8F are the node H and the node F respectively.

The node F has already received the data packets D3E, D4E, D5E, and D6E before the reception of the data packet D8E. However, since the LS of each of the previously received data packets D3E, D4E, D5E, and D6E is equal to the LS of the currently received data packet D8E, the node F ignores the value of the transmission traffic set in the data packets D3E, D4E, D5E, and D6E.

As a result, “6” as a sum of the value of “5” set in the data packet D8E and “1” as an expected value of the volume of the data that is addressed to the gateway GW1 and transmitted by the node F in a specified period is set in the transmission traffic of the data packet D8F. Furthermore, the node F transmits again the bottleneck notification addressed to the gateway GW1 when the data packet D8E is received as when the data packet D6E was received.

Then, the data packet D8F transmitted by the node F is received by the node H. Upon receipt of the data packet D8F, the node H transmits a data packet D8H whose LD, LS, and transmission traffic have been rewritten. The LD and the LS of the data packet D8H are the gateway GW1 and the node H respectively.

Furthermore, the node H has already received the data packets D1F, D3F, D4F, D5F, and D6F before the reception of the data packet D8F. However, the LS of each of the previously received data packets D1F, D3F, D4F, D5F and D6F is equal to the LS of the currently received data packet D8F. Therefore, the node H ignores the value of the transmission traffic set in the data packets D1F, D3F, D4F, D5F, and D6F.

As a result, “7” as a sum of the value of “6” set in the data packet D8F and “1” as an expected value of the volume of the data that is addressed to the gateway GW1 and transmitted by the node H in a specified period is set in the transmission traffic of the data packet D8H. Then, the data packet D8H transmitted by the node H is received by the gateway GW1.

Furthermore, the node H transmits again the bottleneck notification addressed to the gateway GW1 when the data packet D8F is received as when the data packet D6F was received.

Then, in the example in FIG. 6, the node G generates and transmits a new data packet D9G addressed to the gateway GW1. In FIG. 4, since there is an arrow in solid line from the node G to the gateway GW1, the data packet D9G reaches the gateway GW1 in 1 hop.

In addition, according to FIG. 6, before the transmission of the data packet D9G, the node G has not received any data packet from other nodes. Therefore, “1” as an expected value of the volume of the data that is addressed to the gateway GW1 and transmitted by the node G in a specified period is set as transmission traffic in the data packet D9G. Then, the data packet D9G transmitted by the node G is received by the gateway GW1.

As described above, FIG. 6 exemplifies a timing chart in 1 round. As clearly illustrated by the example in FIG. 6, the bottleneck notification is transmitted from the nodes F and H until the end of the 1 round. In the third embodiment, since the transmission traffic is embedded in the data packet, the value of the transmission traffic is accumulated along the path along which the data packet is actually routed. Thus, when there is a node as a bottleneck in the network, a bottleneck notification is transmitted certainly at latest within 1 round after the path becomes stable.

The concrete realization of the operation of each node described above with reference to FIG. 6 is described below in detail with reference to FIGS. 7 through 15.

FIG. 7 is a block diagram of a configuration of the communication device according to the third embodiment. In the third embodiment, each of the nodes A through I is configured as the communication device 600 in FIG. 7.

The communication device 600 in FIG. 7 includes a notification reception unit 601, a transmission volume notification unit 602, a bottleneck judgment unit 603, and a bottleneck notification unit 604 respectively similar to the notification reception unit 101, the transmission volume notification unit 102, the bottleneck judgment unit 103, and the transmission bottleneck notification unit 104 in FIG. 1. The communication device 600 also includes a path information storage unit 605 similar to the path information storage unit 105 in FIG. 1.

Furthermore, the communication device 600 includes a type judgment unit 606 for judging the type of a received packet, and a buffer unit 607 for temporarily storing a data packet. The communication device 600 also includes a data packet processing unit 608 for performing the process relating to the transmission and reception of a data packet, and the data packet processing unit 608 includes the above-mentioned notification reception unit 601 and the transmission volume notification unit 602. The data packet processing unit 608 further includes an upper layer processing unit 609 for performing the process relating to the payload of a data packet, and a routing control unit 610 for determining the LD depending on the GD of a data packet (that is, determining the path for routing a data packet).

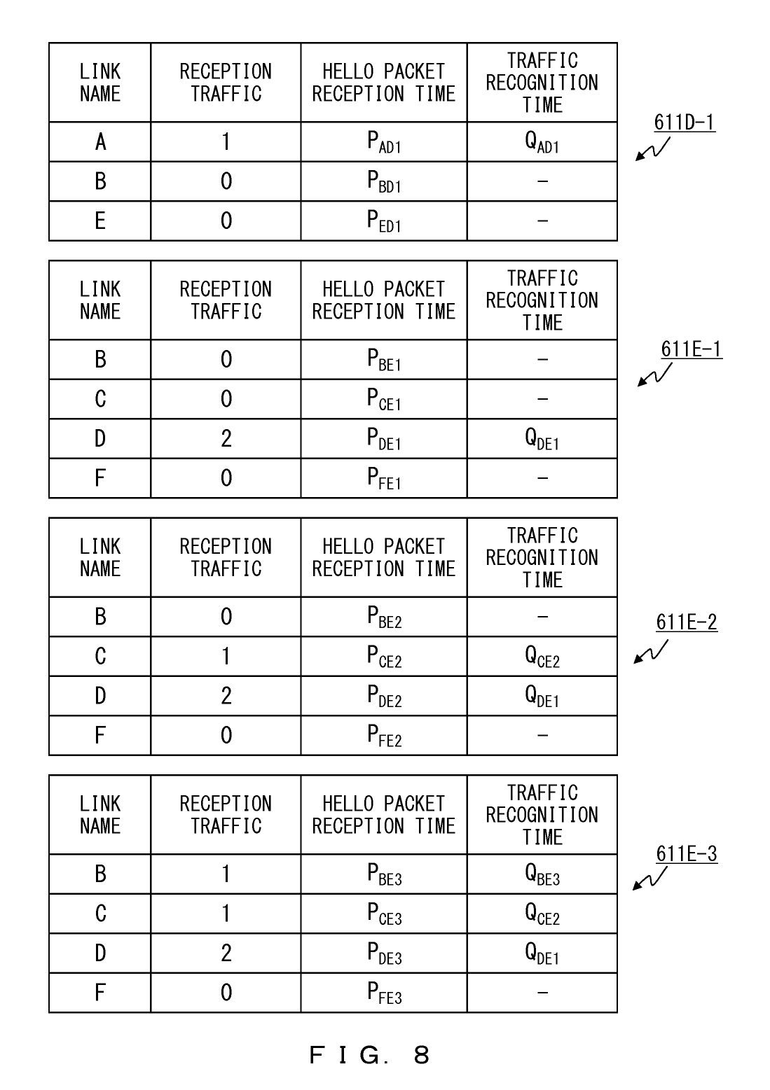

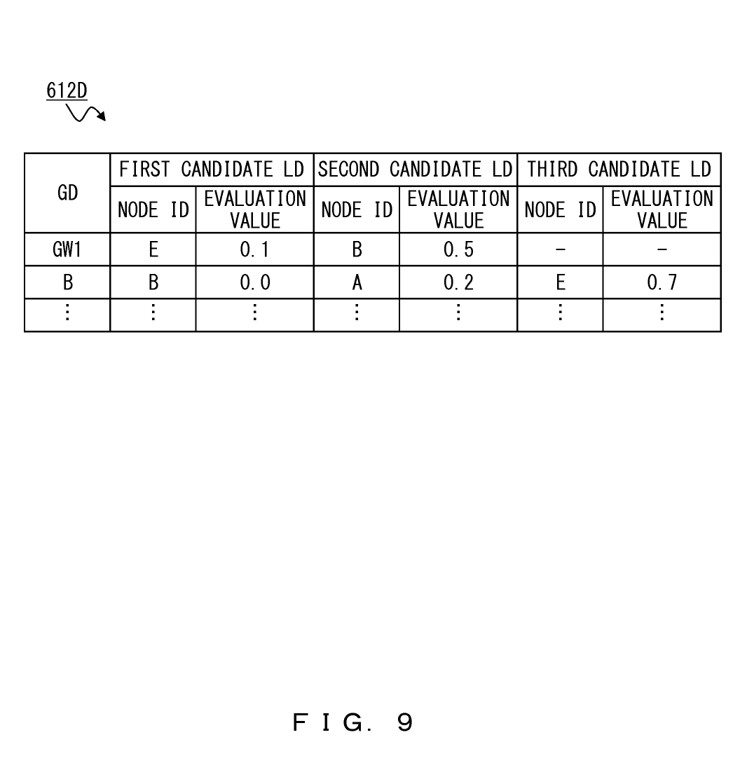

The path information storage unit 605 also includes a link table 611 which stores the information about other communication devices adjacent to the communication device 600. The path information storage unit 605 further includes a routing table 612 which stores the information for determination of the LD of a data packet. A concrete example of each of the link table 611 and the routing table 612 is described below with reference to FIGS. 8 and 9.

The communication device 600 includes a transmission volume storage unit 613 which stores an expected value of the volume of the data packets generated and transmitted toward the gateway GW1 by the communication device 600 itself in a specified period. For example, in the example in FIG. 6, the transmission volume storage unit 613 stores the value of “1”.

The communication device 600 includes a hello packet processing unit 614 for performing the process relating to the transmission and reception of a hello packet. The hello packet processing unit 614 concretely includes a link management unit 615 for updating the link table 611 based on the received hello packet, and an existence notification unit 616 for periodically transmitting a hello packet.

It is not always requested that the gateway GW1 is configured like the communication device 600. However, for simple explanation, it is assumed below that, in the third embodiment, the gateway GW1 includes each component other than the bottleneck notification unit 604 illustrated in FIG. 7.

When the communication device 600 is a device used in a wireless network, the communication device 600 may be realized by, for example, the communication device 200 in FIG. 2. For example, when the 802.15.4 PHY/MAC chip 205 receives a packet, the packet may be stored in the DRAM 203 as the buffer unit 607. Then, the MPU 201 may judge the type of a packet as the type judgment unit 606.

Otherwise, the 802.15.4 PHY/MAC chip 205 may be configured so that it may judge the type of packet as the type judgment unit 606 instead of the MPU 201. In this case, the 802.15.4 PHY/MAC chip 205 may output the entire packet to the MPU 201 if the received packet is a control packet. On the other hand, if the received packet is a data packet, the 802.15.4 PHY/MAC chip 205 outputs only the header of the packet to the MPU 201, and the entire packet including the header may be stored in the DRAM 203 as the buffer unit 607.

The MPU 201 may further perform each process as the data packet processing unit 608. To realize the upper layer processing unit 609 in the data packet processing unit 608, the sensor 207 may also be used. The transmission volume notification unit 602 in the data packet processing unit 608 may be realized by the MPU 201 and the 802.15.4 PHY/MAC chip 205.

The path information storage unit 605 and the transmission volume storage unit 613 may be realized by the DRAM 203, and by the flash memory 204.

In addition, the bottleneck judgment unit 603 may also be realized by the MPU 201. The bottleneck notification unit 604 may be realized by the MPU 201 and the 802.15.4 PHY/MAC chip 205, but may be the MPU 201 and the 802.11b PHY/MAC chip 206.

Then, the link management unit 615 may be also realized by the MPU 201. The existence notification unit 616 may be realized by the MPU 201, the timer IC 202, and the 802.15.4 PHY/MAC chip 205.

Contrary to what is described above, when the communication device 600 is used in a cable network, the communication device 600 may be realized by, for example, the communication device 300 in FIG. 3. For example, when any of the physical ports 301a through 301d receives a packet, the packet may be output to the memory 305 or the memory 307 as the buffer unit 607 through a corresponding PHY chip (that is, any of the PHY chips 302a through 302d).

The type judgment unit 606 may be realized by the FPGA 303 or the MPU 306. For example, the FPGA 303 may judge the type, the MPU 306 may process the packet only when the received packet is a data packet, and the FPGA 303 may process the packet when the received packet is a control packet.

Furthermore, the MPU 306 may perform each process as the data packet processing unit 608. To realize the upper layer processing unit 609 in the data packet processing unit 608, the sensor 308 may further be used. In addition, the transmission volume notification unit 602 in the data packet processing unit 608 may be realized by the MPU 306, the FPGA 303, the PHY chips 302a through 302d, and the physical ports 301a through 301d.

The path information storage unit 605 may be realized by the memory 305. The transmission volume storage unit 613 may be realized by the memory 307.

Then, the bottleneck judgment unit 603 also may be realized by the MPU 306. The bottleneck notification unit 604 may be realized by the MPU 306, the FPGA 303, the PHY chips 302a through 302d, and the physical ports 301a through 301d.

Furthermore, the link management unit 615 may be realized by the FPGA 303. The existence notification unit 616 may be realized by the FPGA 303 including the timer 304, the PHY chips 302a through 302d, and the physical ports 301a through 301d.

FIG. 8 illustrates examples of link tables 611 according to the third embodiment. FIG. 8 illustrates four concrete examples of the link tables 611. First, the forms of the link tables 611 are described, and then the respective contents of the four concrete link tables 611 are described.

Each entry of the link tables 611 corresponds to each communication device adjacent to the communication device 600. The communication device adjacent to the communication device 600 may be the gateway GW1. Then, as illustrated in FIG. 8, each entry in the link tables 611 includes the fields of “link name”, “reception traffic”, “hello packet reception time”, and “traffic recognition time”.

The link name is information for identification of each link between the communication device 600 and another communication device adjacent to the communication device 600. That is, the link name is the information for identification of each communication device adjacent to the communication device 600.

For example, when a unique node ID (identification) in a network is assigned to each communication device in the network, the node ID of a adjacent communication device is available as a link name. The link name may be the address (for example, a MAC address etc.) of an adjacent communication device. For convenience of reference to the attached drawings, in FIG. 8, the reference numeral of each node in FIG. 4 is expressed as a link name.

The reception traffic indicates the value set in the transmission traffic field of the data packet received by the communication device 600 from the adjacent communication device identified by the link name.

For example, when the communication device 600 is the node H, the value of “1” is set in the data packet D1F received by the communication device 600 from the node F. The value of “1” indicates that the communication device 600 receives the data of the volume indicated by the value of “1” from the node F as the communication device adjacent to the communication device 600. Therefore, when the communication device 600 is the node H, the link table 611 at the time point when the communication device 600 receives the data packet D1F stores the value of “1” as reception traffic corresponding to the link name for identification of the node F.

In addition, the hello packet reception time indicates the latest time when the communication device 600 receives a hello packet from the adjacent communication device identified by the link name. The hello packet reception time is used so that the communication device 600 may correctly recognize the adjacent communication device which may depends of the dynamic change of the network.

That is, the link management unit 615 periodically performs aging processing according to an interrupt signal periodically output from, for example, the timer IC 202 or the timer 304. Concretely, the link management unit 615 deletes an entry having a difference between the current time and the hello packet reception time larger than a specified threshold (that is, an entry in an obsolete state not updated yet) from the link table 611. It is preferable that the above-mentioned threshold is determined based on the transmission interval of a hello packet.

The cause of a dynamic change of a network may be, for example, an added node, a deleted node, a moved node, an occurrence of a shield, a lost shield, a moved shield, an occurrence of a radio interference source, a lost radio interference source, a moved radio interference source, etc.

The traffic recognition time indicates the time when the communication device 600 receives a data packet from the adjacent communication device identified by the link name, and recognizes the value of the transmission traffic set in the data packet. When a bottleneck is predicted or detected using the value of the transmission traffic embedded in an obsolete data packet, the prediction or the detection may be incorrect. Therefore, to avoid the incorrect prediction or detection, the traffic recognition time is used.

That is, the link management unit 615 periodically initializes the reception traffic according to the interrupt signal periodically output from, for example, the timer IC 202 or the timer 304. Concretely, the link management unit 615 initializes to 0 the value of the reception traffic in the entry in which the difference between the current time and the traffic recognition time is larger than a specified threshold. For example, when each node periodically transmits a data packet at a specified interval, it is preferable that the above-mentioned threshold is determined based on the transmission interval of a data packet.

Concrete examples of the link table 611 including four above-mentioned fields are illustrated as (A1) through (A4) in FIG. 8.

(A1) link table 611D-1 of the node D immediately after the node D receives the data packet D4A

(A2) link table 611E-1 of the node E immediately after the node E receives the data packet D4D

(A3) link table 611E-2 of the node E immediately after the node E receives the data packet D5C

(A4) link table 611E-3 of the node E immediately after the node E receives the data packet D6B

The contents of these four link tables 611D-1 and 611E-1 through 611E-3 are described below with reference to FIGS. 4 and 6. Although the transmission and reception of hello packets are omitted in FIG. 6, the nodes A through I and gateway GW1 in the network 400 periodically transmit a hello packet to notify their adjacent devices of the existence of themselves.

For simple explanation in this example, it is assumed that the node D has already received a hello packet from each of the adjacent nodes A, B, and E when it receives the data packet D4A. Therefore, the link table 611D-1 includes three entries respectively corresponding to the nodes A, B, and E.

Although there are various routing algorithms of an ad hoc network, each node normally recognizes its adjacent node(s) first using a hello packet, and then a transmission path of a data packet is established. The timing chart in FIG. 6 specifically illustrates one round at the stage where the transmission path is established and enters a stable state, for example. Therefore, the above-mentioned assumption that the “node D has already received a hello packet from each of the adjacent nodes A, B, and E when the node D receives the data packet D4A” is a practical assumption.

In the example in FIG. 8, the latest times at which the node D receives hello packets from the nodes A, B, and E are P_{AD1}, P_{BD1}, and P_{ED1} respectively, as memorized as the hello packet reception times. The three pieces of time information refer to the time before the time Q_{AD1} when the node D receives the data packet D4A.

Upon receipt of the data packet D4A from the node A, the node D sets, in the reception traffic field of the first entry corresponding to the node A in the link table 611D-1, the value of “1” set as transmission traffic in the data packet D4A. The node D also sets, in the traffic recognition time field in the first entry, the time Q_{AD1} when the node D receives the data packet D4A.

The node D has not received any data packet from the node B or E by the time Q_{AD1} when the data packet D4A is received. Otherwise, assume as follows: even if the node D may have received a data packet from the node B or E in the transitional state, in which the path is unstable, before the time Q_{AD1}/an obsolete value of the reception traffic has already been initialized by the above-mentioned initializing process by time Q_{AD1}.

Therefore, the value of the reception traffic in the second and third entries corresponding to the nodes B and E is “0”. The traffic recognition time of the second and third entries is invalid.

Upon receipt of the data packet D4A, the link table 611 in the node D is the link table 611D-1 in FIG. 8. Furthermore, upon receipt of the data packet D4A, the node D transmits the data packet D4D. Then, the node E receives the data packet D4D.

For simple explanation in this example, it is assumed that the node E has already received a hello packet from each of the adjacent nodes B, C, D, and F when the node E receives the data packet D4D. Therefore, the link table 611E-1 includes four entries corresponding to the nodes B, C, D, and F.

In the example in FIG. 8, the latest times at which the node E receives hello packets from the nodes B, C, D, and F are P_{BE1}, P_{CE1}, P_{DE1} and P_{FE1} respectively, as memorized as the hello packet reception times. The four pieces of time information refer to the time before the time Q_{DE1} when the node E receives the data packet D4D.

Upon receipt of the data packet D4D from the node D, the node E sets, in the reception traffic field of the third entry corresponding to the node D in the link table 611E-1, the value of “2” set as transmission traffic in the data packet D4D. The node E also sets, in the traffic recognition time field of the third entry, the time Q_{DE1} when the node E received the data packet D4D.

The node E has not received any data packet from the node B, C, or F by the time Q_{DE1} when the data packet D4D is received. Otherwise, assume as follows: even if the node E may have received a data packet from the node B, C or F in the transitional state, in which the path is unstable, an obsolete value of the reception traffic has already been initialized by time Q_{DE1}.

Therefore, the values of the reception traffic in the first, second, and fourth entries corresponding to the nodes B, C, and F are “0”. Furthermore, the value of the traffic recognition time of the first, second, and fourth entries is still the invalid initial value.

After a while from the reception of the data packet D4D, as illustrated in FIG. 6, the node E receives the data packet D5C from the node C. The node E may receive a hello packet from each of the nodes B, C, D, and F in a period from the reception of the data packet D4D to the reception of the data packet D5C.

In the example in FIG. 8, the latest times at which the node E receives hello packets from the nodes B, C, D, and F are P_{BE2}, P_{CE2}, P_{DE2}, and P_{FE2} respectively, as memorized as the hello packet reception times. Precisely speaking, each of the four pieces of time information refers to the “latest” time with respect to the time Q_{CE2} when the node E receives the data packet D5C, and thus, each of the four pieces of time information naturally refers to the time before the time Q_{CE2}.

Upon receipt of the data packet D5C from the node C, the node E sets, in the reception traffic field of the second entry corresponding to the node C in the link table 611E-2, the value of “1” set as transmission traffic in the data packet D5C. The node E also sets, in the traffic recognition time field of the second entry, the time Q_{CE2} when the node E receives the data packet D5C. The values of the reception traffic of other entries are not changed.

Therefore, upon receipt of the data packet D5C, the node E calculates the sum of the values of the reception traffic of all entries in the link table 611E-2 and the value held by the node E itself in the transmission volume storage unit 613, thereby obtaining the result of “4”. Then the node E sets the calculated value of “4” as transmission traffic in the data packet D5E.

After a while from the reception of the data packet D5C, as illustrated in FIG. 6, the node E receives the data packet D6B from the node B. The node E may receive a hello packet from each of the nodes B, C, D, and F from the reception of the data packets D5C to the reception of the data packet D6B.

In the example in FIG. 8, the latest times at which the node E receives hello packets from the nodes B, C, D, and F are P_{BE3}, P_{CE3}, P_{DE3}, and P_{FE3} respectively, as memorized as hello packet reception times. The four pieces of time information refer to the latest time from the time Q_{BE3} when the node E received the data packet D6B, it is naturally the time before the time Q_{BE3}.

Upon receipt of the data packet D6B from the node B, the node E sets, in the reception traffic field of the first entry corresponding to the node B in the link table 611E-3, the value of “1” set as transmission traffic in the data packet D6B. The node E also sets, in the traffic recognition time field of the first entry, the time Q_{BE3} when the node E received the data packet D6B. The values of the reception traffic of other entries are not changed.

Therefore, upon receipt of the data packet D6B, the node E calculates the sum of the values of the reception traffic of all entries in the link table 611E-3 and the value held by the node E itself in the transmission volume storage unit 613, thereby obtaining the result of “5”. Then the node E sets the calculated value of “5” as transmission traffic in the data packet D6E.

FIG. 9 is an example of the routing table 612 according to the third embodiment. The information stored in the routing table 612 may be in any format so far as the information allows the routing control unit 610 to determine the LD from the GD. FIG. 9 illustrates the routing table 612D held by the node D as an example in the third embodiment.

Each entry of the routing table 612D corresponds to each node that may be the GD. FIG. 9 exemplifies two entries corresponding to the gateway GW1 and the node B respectively. However, depending on the embodiments, a network may be operated according to the policy that “any node other than a particular node in a network (for example, the gateway GW1) is not specified as the GD”.

Each entry of the routing table 612D includes the fields of: “GD”; “node ID” and “evaluation value” of “first candidate LD”; “node ID” and “evaluation value” of “second candidate LD”; and “node ID” and “evaluation value” of “third candidate LD”. That is, each entry may memorize up to three candidates for the LD selectable for the GD corresponding to the entry. Furthermore, each candidate for the LD is identified by the node ID, and the preferability as the LD is evaluated based on the evaluation value.

Obviously, depending on the embodiments, the routing table 612 may take the form of storing the information about three or more candidates or less than three candidates for one node that may be a GD. In addition, the number of candidates for the LD corresponding to one node that may be a GD is arbitrarily changed.

The contents of the routing table 612 are described below in more detail.

That is, the first entry corresponds to the case in which the gateway GW1 is a GD. In the first entry, two nodes E and B are registered as a candidate for a node in which the node D is selectable as an LD when the gateway GW1 is a GD. Then, the preferability for the node E as an LD is expressed by the evaluation value of “0.1”, and the preferability for the node B as an LD is expressed by the evaluation value of “0.5”.

In the description below, it is assumed that the evaluation value is 0 or more and less than or equal to 1 for convenience of explanation, and the highest evaluation is “0” while the lowest evaluation is “1”. Therefore, for the node D having the routing table 612D, the node E having the evaluation value of “0.1” is more preferable than the node B having the evaluation value of “0.5” as the LD for a case where the GD is the gateway GW1.

Therefore, when the data packet including the gateway GW1 as a GD is transmitted according to the routing table 612D, the node D selects as an LD (that is the direct destination) the node E which is more preferable between the two candidates as selectable LDs. The arrow in solid line from the node D to the node E in FIG. 4 indicates a result of the selection based on the evaluation value of the routing table 612D above.

In the routing table 612, up to three candidates for an LD are sorted based on the evaluation value, and are registered sequentially from the first candidate for an LD according to the result of sorting. The routing control unit 610 sorts the candidates for an LD again when the evaluation value is changed.

Furthermore, in the example in FIG. 9, the routing table 612D also includes the second entry. The second entry corresponds to the case in which the node B is a GD. In the second entry, three nodes B, A, and E are registered as candidates for a node selectable by node D as an LD when the node B is a GD. Then, the preferability of the node B as an LD is expressed by the evaluation value of “0.0”, the preferability of the node A as an LD is expressed by the evaluation value of “0.2”, and the preferability of the node E as an LD is expressed by the evaluation value of “0.7”.

Next, an example of a packet used in the third embodiment is described below with reference to FIG. 10. A packet 700 used in the third embodiment includes an ad hoc header 701, and also an appropriate payload depending on the type. Since a payload is optional, the packet 700 may include no payload depending on the type. Furthermore, the packet 700 may further include a trailer including an error detection code.

The ad hoc header 701 concretely includes four fields of “LD”, an “LS”, an “ID”, and a “type”. Depending on the embodiments, the sequence and the length of a field may be appropriately changed.

In the ad hoc header 701, the LD field and the LS field respectively stores the information for identification of the LD and LS nodes of the packet 700. The information for identification of a node may be, for example, a unique node ID in the network, or an address such as a MAC address. For convenience in displaying the attached drawings, the reference numeral of each node in FIG. 4 is used in FIG. 10 as the information for identification of a node.

In the ad hoc header 701, the ID field stores an ID associated by a node which has generated the packet 700. For convenience in displaying the attached drawings, a 4-digit sequence number is used as an ID in FIG. 10. However, it is obvious that the number of digits of an ID and the form is arbitrary depending on the embodiments.

Furthermore, in the ad hoc header 701, a value for identification of the type of the packet 700 is set in the type field. In the third embodiment, at least three types of packets, that is, a data packet, a hello packet, and an ACK packet, are used. In FIG. 10, a data packet 710, a hello packet 720, and an ACK packet 730 are illustrated as concrete examples of the packet 700. For convenience in displaying the attached drawings, the values for identification of the three types above are indicated as “data”, “hello”, and “ACK” respectively in FIG. 10.

Obviously, other types of packets may be further used depending on the embodiments. On the other hand, since a packet is successfully transmitted at almost 100% in a cable network, the use of the ACK packet 730 may be omitted. Furthermore, the format of the value for identification of a type is arbitrary depending on the embodiments, and the type may be identified by, for example, according to a numeral.

The data packet 710 includes five fields of “GD”, “GS”, “length”, “transmission traffic”, and “payload” as payloads in the packet 700.

The GD field and the GS field respectively store the information for identification of GD and GS nodes of the data packet 710. The length field indicates the length of a payload field. The transmission traffic field is described above with reference to FIG. 6. The payload field stores arbitrary data (for example, the data output from the sensor 207 or the sensor 308) used in an upper layer than the protocol which defines the data packet 710.

FIG. 10 illustrates the data packet D4D in FIG. 6 as a concrete example of the data packet 710. As illustrated in FIG. 6, the data packet D4D is obtained by rewriting by the node D a part of the data packet D4A generated and addressed by the node A to the gateway GW1, and is transmitted from the node D to the node E.

Therefore, in the data packet D4D, the node E is an LD, and the node D is an LS. According to FIG. 10, The ID of “1234” assigned to the data packet D4A when the node A generates the data packet D4A is set as is as the ID in the data packet D4D. Then, the value of the type of the data packet D4D is “data” indicating a data packet.

Furthermore, in the data packet D4D, the gateway GW1 is a GD, and the node A is a GS. In the example in FIG. 10, the length of the payload field is “200”. Furthermore, as illustrated in FIG. 6, the value of the transmission traffic field in the data packet D4D is “2”.

The unit of the length field may be different from the unit of the transmission traffic field. For example, the unit of the length field may be “byte” while the unit of the transmission traffic field may be “kilobyte/5 min.”.

The hello packet 720 of the third embodiment has no payload. In addition, the hello packet 720 is broadcast within the range of 1 hop, and is not a target of a multi-hop transmission.

For example, the hello packet 720 and a hello packet 721 concretely include similar contents. The hello packet 721 is transmitted from the node D at a certain time point.

As described above, the hello packet 721 is broadcast. Therefore, a broadcast address (expressed as “BC” in FIG. 10) indicating a broadcast in the scope of 1 hop is set in the LD of the hello packet 721.

In addition, since the hello packet 721 is transmitted from the node D, the LS of the hello packet 721 is the node D. Then, the value of “0987” assigned by the node D is set in the ID of the hello packet 721. The value of the type of the hello packet 721 is “hello” indicating a hello packet.

FIG. 10 further illustrates the ACK packet 730. The ACK packet 730 is an acknowledgment for the data packet 710. The ACK packet 730 concretely includes a “GS” field as a payload in the packet 700.

Since the value of the ID of the data packet 710 is assigned by the node of the GS of the data packet 710, different nodes may incidentally assign the same ID to different data packets 710. Therefore, the identity of the data packet 710 which is not changed even after a multi-hop transmission is correctly identified by a combination of the values of the GS and the ID of the data packet 710.

Therefore, the ACK packet 730 includes not only the ID but also the GS field to clearly indicate the acknowledgement for the data packet 710.

For example, the values of the GS and the ID of an ACK packet 731 transmitted by the node E corresponding to the data packet D4D received from the node D are equal to the values of the GS and the ID in the data packet D4D. Furthermore, the LD of the ACK packet 731 is equal to the LS of the data packet D4D, and is the node D. The LS of the ACK packet 731 is equal to the LD of the data packet D4D, and is the node E.

In the following description, the operation of the communication device 600 in FIG. 7 is described with reference to some flowcharts. Using the communication device 600 which operates as described below as the nodes A through I in FIG. 4, a bottleneck may be detected or predicted as described above with reference to FIG. 6.

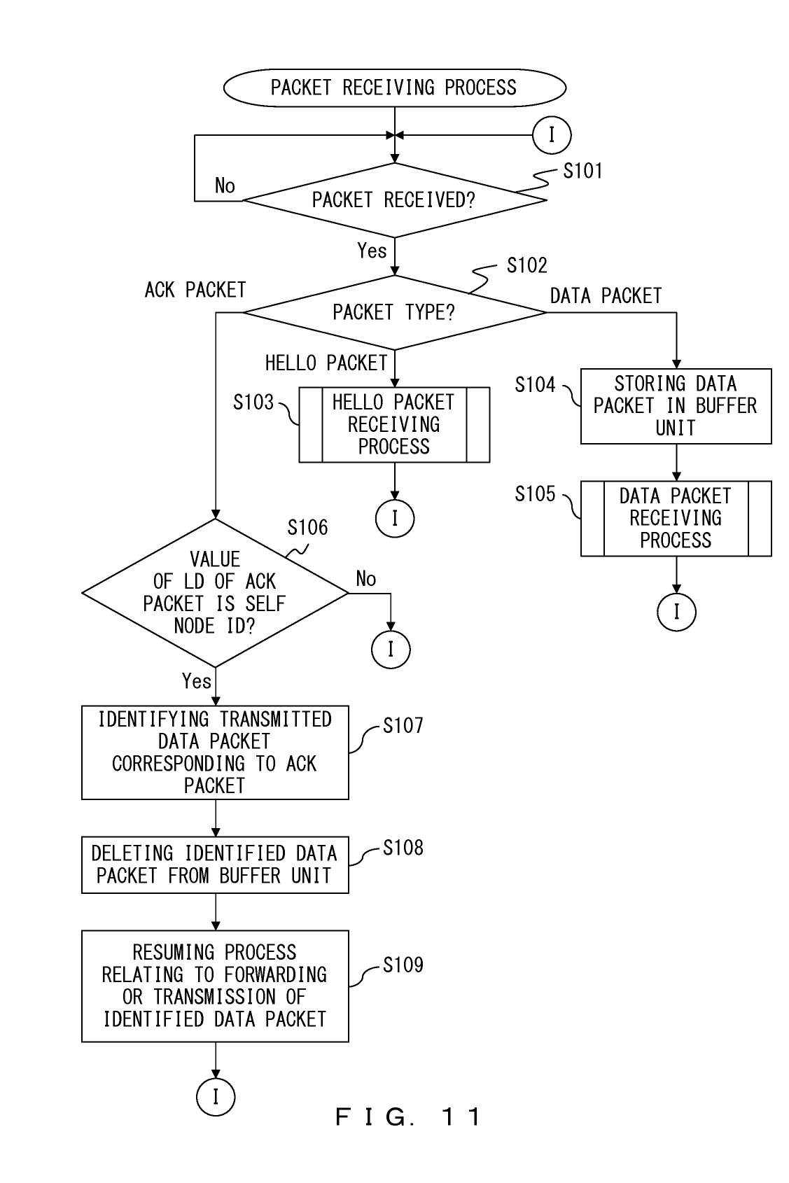

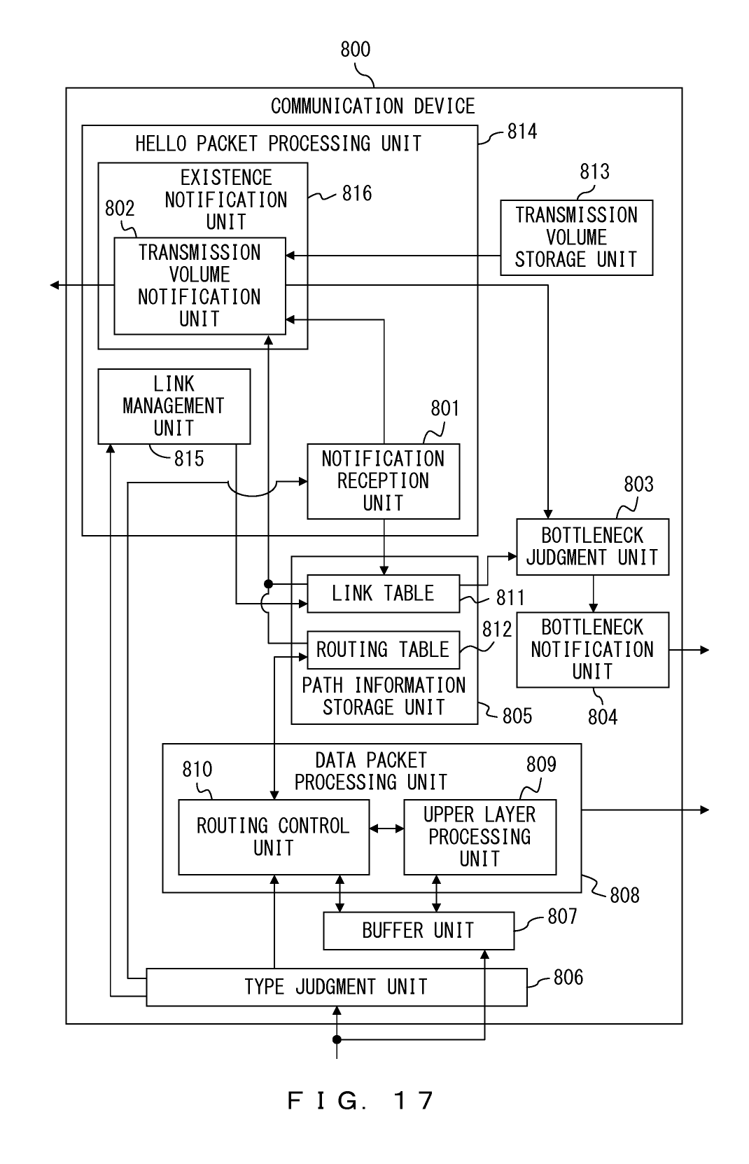

FIG. 11 is a flowchart of a packet receiving process commonly used in some embodiments. For convenience of explanation in the description below, the case in which the process in FIG. 11 is performed by the communication device 600 according to the third embodiment is described as a concrete example. However, for example, a communication device 800 according to the fourth embodiment described later with reference to FIG. 17 is also performs a process similar to that illustrated in FIG. 11.

In step S101, the communication device 600 waits for the reception of the packet 700. Then, upon receipt of the packet 700, the process proceeds to step S102.

In step S102, the type judgment unit 606 judges the type of the packet 700 from the value of the type of the ad hoc header 701 of the received packet 700.

If the type judgment unit 606 judges that “the received packet 700 is the hello packet 720”, it outputs the hello packet 720 to the link management unit 615 in the hello packet processing unit 614. Then, the process proceeds to step S103.

When the type judgment unit 606 judges that “the received packet 700 is the data packet 710”, it notifies the notification reception unit 601 and the routing control unit 610 of the reception of the data packet 710. Then, the process proceeds to step S104.

Otherwise, if the type judgment unit 606 judges that “the received packet 700 is the ACK packet 730”, it outputs the ACK packet 730 to the routing control unit 610. Then, the process proceeds to step S106.

In step S103, the link management unit 615 performs the hello packet receiving process. The contents of the hello packet receiving process are different between the third and fourth embodiments. In the third embodiment, the link management unit 615 concretely performs the following process in step S103.

The link management unit 615 searches the link table 611 for an entry having the same value as the LS of the received hello packet 720 as a link name. If an entry is found as a result of the search, the link management unit 615 sets the current time as a hello packet reception time in the found entry.

On the other hand, if no entry has been found, the link management unit 615 adds a new entry to the link table 611. Then, the link management unit 615 sets the value of the LS of the received hello packet 720 as the link name in the new entry. Furthermore, the link management unit 615 initializes the value of the reception traffic in the new entry to “0”. Furthermore, the link management unit 615 sets the current time as the hello packet reception time in the new entry, and initializes the traffic recognition time in the new entry to an invalid value.

When the above-mentioned hello packet receiving process is completed, the communication device 600 waits for the reception of the packet 700 again in step S101.

In step S104, the received data packet 710 is stored in the buffer unit 607.

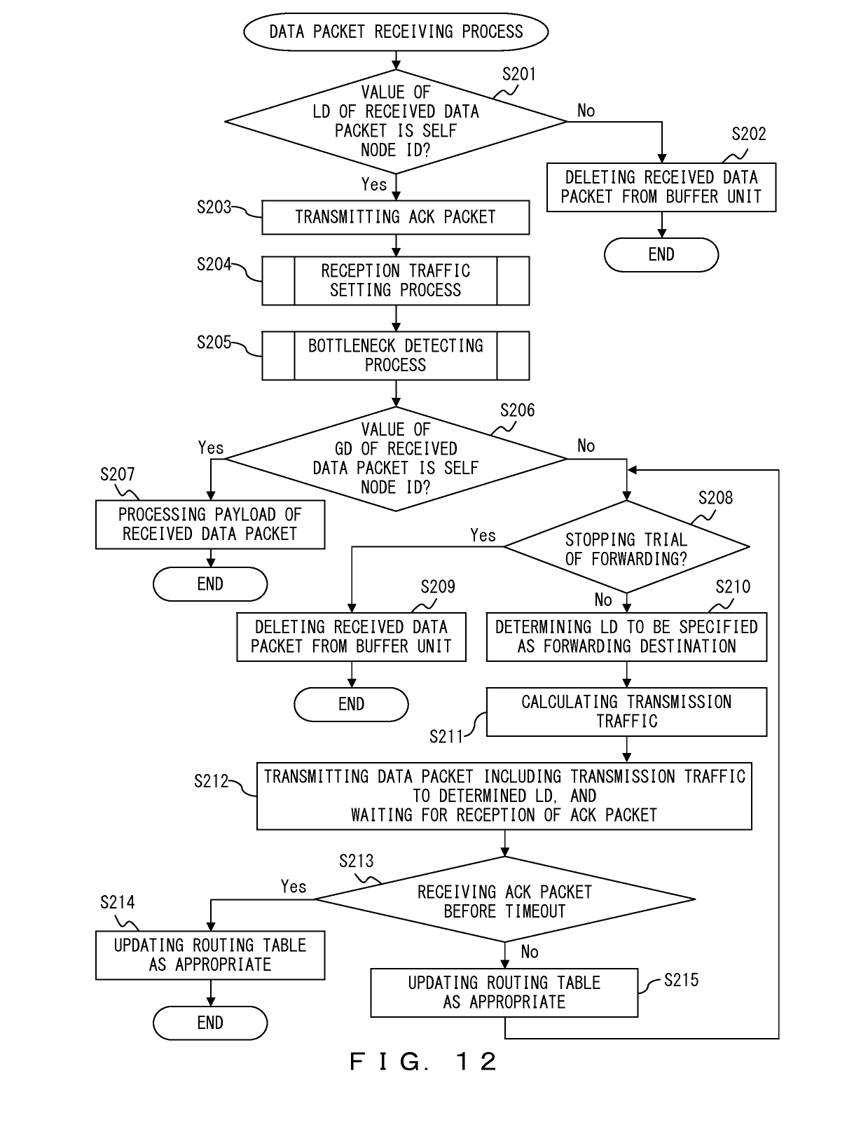

Then, in the next step S105, the communication device 600 performs the data packet receiving process. The contents of the data packet receiving process are different between the third and fourth embodiments. In the third embodiment, the communication device 600 concretely performs the process illustrated in FIG. 12. When the data packet receiving process is completed, the communication device 600 wais for the reception of the packet 700 again in step S101.

In step S106, the routing control unit 610 judges whether or not the value of the LD of the received ACK packet 730 is the self node ID (that is, the node ID of the communication device 600 itself).

The case in which the value of the LD of the received ACK packet 730 is different from the node ID of the communication device 600 itself refers to that the ACK packet 730 for the data packet 710 which has been transmitted before by another communication device other than the communication device 600 may be incidentally received by the communication device 600. In this case, the ACK packet 730 may be ignored, and the process returns to step S101.

On the other hand, if the value of the LD of the received ACK packet 730 is the node ID of the communication device 600 itself, then it refers to that the ACK packet 730 for the data packet 710 previously transmitted by the communication device 600 is received. Therefore, in this case, the process proceeds to step S107.

In step S107, the routing control unit 610 in the data packet processing unit 608 identifies the transmitted data packet 710 corresponding to the received ACK packet 730. The communication device 600 according to the third embodiment holds in the buffer unit 607 the data packet 710 transmitted for retrial. Then, in step S107, the routing control unit 610 searches the buffer unit 607, and identifies the transmitted data packet 710 having the same GS and ID as the received ACK packet 730.

Then, in the next step S108, the routing control unit 610 deletes the data packet 710 identified in step S107 from the buffer unit 607.

Furthermore, in the next step S109, the routing control unit 610 resumes the process (or thread) relating to the forwarding or transmission of the data packet 710 identified in step S107. The details are described later, but the process of forwarding the data packet 710 received from other communication devices and the process of transmitting the new data packet 710 generated by the upper layer processing unit 609 include the step of waiting for reception of the ACK packet 730. While waiting for the reception of the ACK packet 730, the process sleeps.

Therefore, in step S109, the routing control unit 610 resumes the sleeping process upon receipt of the ACK packet 730. The resumed process is performed concurrently with the process in FIG. 11. On the other hand, the process in FIG. 11 returns to step S101.

FIG. 12 is a flowchart of a data packet receiving process performed in step S105 illustrated in FIG. 11 according to the third embodiment.

In step S201, the routing control unit 610 judges whether or not the value of the LD of the data packet 710 received by the communication device 600 is the self node ID (that is, the node ID of the communication device 600 itself). If the value of the LD of the data packet 710 is different from the node ID of the communication device 600 itself, the process proceeds to step S202. On the other hand, if the value of the LD of the data packet 710 is the same as the node ID of the communication device 600 itself, the process proceeds to step S203.

In step S202, the routing control unit 610 deletes the received data packet 710 from the buffer unit 607. Then, the data packet receiving process terminates.

For example, in the example in FIG. 6, the LD of the data packet D1F transmitted by the node F is the node H. However, node F is adjacent not only to the node H but also to the nodes E, G, and I. Therefore, the data packet D1F may be received also in the nodes E, G, and I. In this case, the routing control units 610 of the nodes E, G, and I delete the data packet D1F from the buffer unit 607 in step S202.

On the other hand, in step S203, the routing control unit 610 generates and transmits a new ACK packet 730 corresponding to the received data packet 710. The transmitting function of the ACK packet 730 may be realized, for example, by the 802.15.4 PHY/MAC chip 205.

For example, when the node E receives the data packet D4D in FIG. 10, the routing control unit 610 of the node E generates and transmits the ACK packet 731 in step S203.

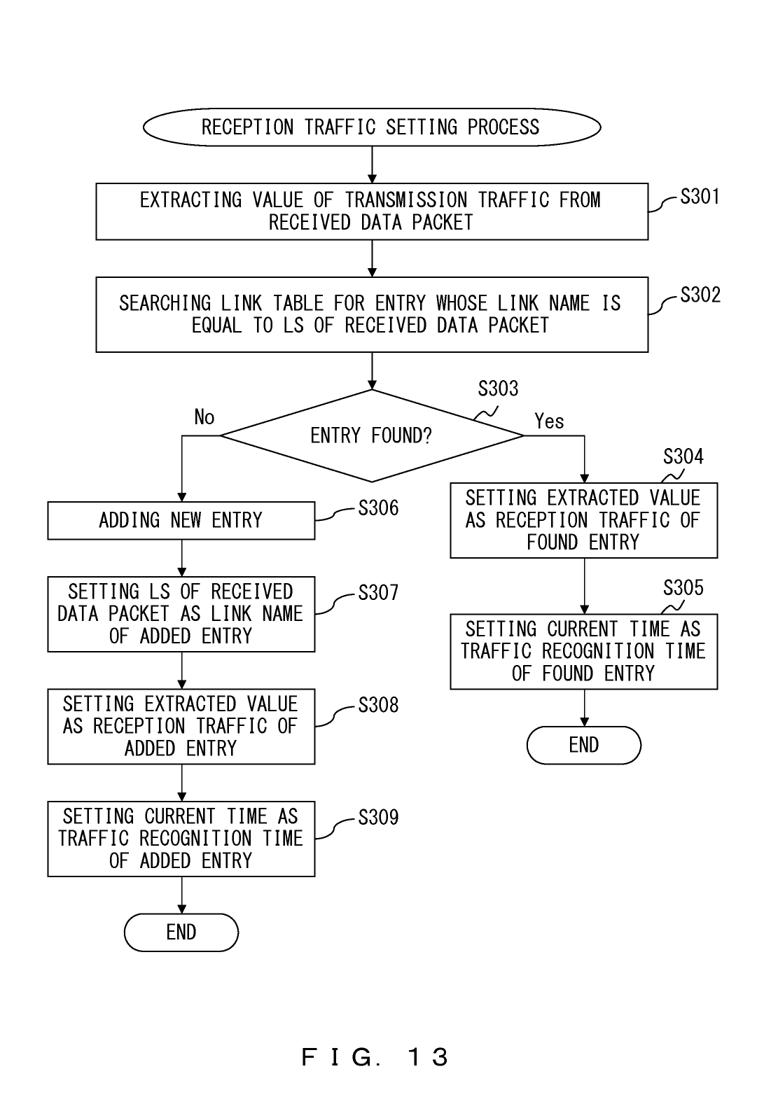

In addition, in the next step S204, the notification reception unit 601 performs the reception traffic setting process illustrated in detail in FIG. 13, and updates the link table 611. For example, the notification reception unit 601 of the node E updates the link table 611 from the state of the link table 611E-1 to the state of the link table 611E-2 in FIG. 8 by the processes in step S204 performed at time Q_{CE2}.

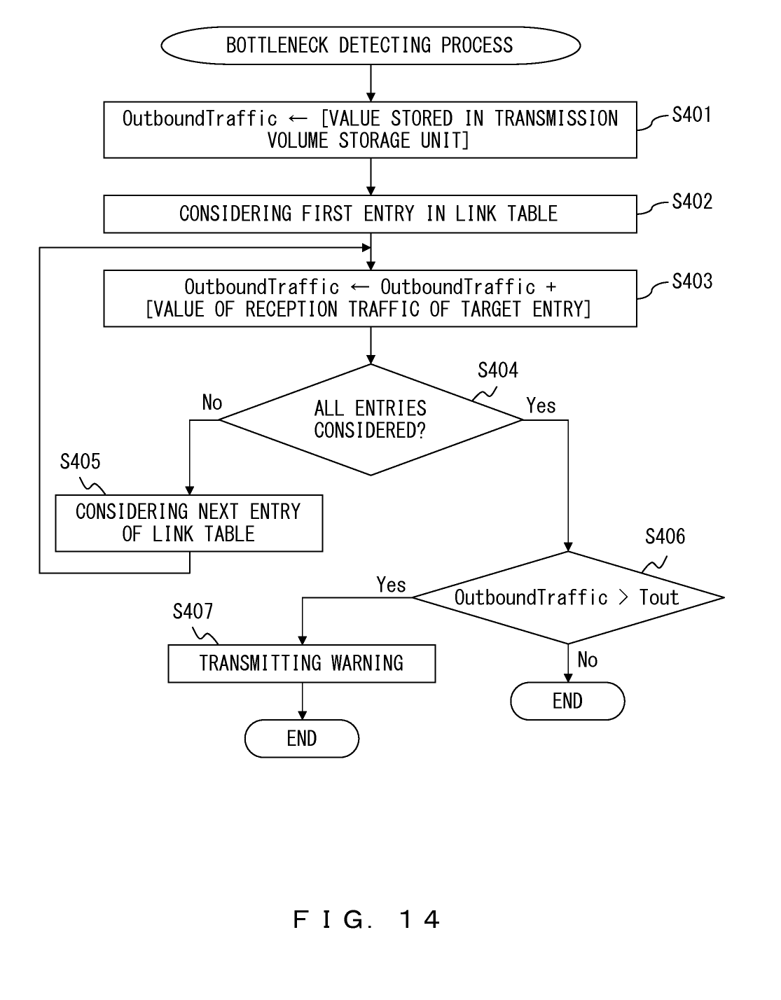

Next, in step S205, the bottleneck detecting process illustrated in detail in FIG. 14 is performed. As a result, the bottleneck notification is transmitted as appropriate. For example, when the node H receives the data packet D5F, the bottleneck notification is transmitted in step S205.

Then, in step S206, the routing control unit 610 judges whether or not the value of the GD of the received data packet 710 refers to the self node ID (that is, the node ID of the communication device 600 itself). If the value of the GD of the data packet 710 is the node ID of the communication device 600 itself, the process proceeds to step S207. On the other hand, if the value of the GD of the data packet 710 is different from the node ID of the communication device 600 itself, the process proceeds to step S208.

In step S207, the upper layer processing unit 609 appropriately processes the payload of the received data packet 710. When the payload processing is terminated, the upper layer processing unit 609 deletes the data packet 710 from the buffer unit 607. Then, the data packet receiving process in FIG. 12 also terminates.

For example, as described above in the third embodiment, the gateway GW1 includes components similar to those of the communication device 600 except the bottleneck notification unit 604. The upper layer processing unit 609 of the gateway GW1 appropriately processes the payload of the data packet for which the gateway GW1 is specified as a GD in step S207.

On the other hand, the processes in and after step S208 are performed when the value of the GD of the data packet 710 is not the node ID of the communication device 600 itself. Concretely, first in step S208, the routing control unit 610 judges whether or not the condition of stopping the trial for forwarding holds true.

The routing algorithm according to which the routing control unit 610 operates may be variable depending on the embodiment. Therefore, according to the routing algorithm, the condition of stopping the trial for the forwarding above may also be variable. Since the details of the condition of stopping the trial of forwarding are related to steps S210 through S215, they are described later.

When the condition of stopping the trial for the forwarding holds true, the process proceeds to step S209. On the other hand, when the condition of stopping the trial for the forwarding does not hold true, the process proceeds to step S210.

In step S209, the routing control unit 610 deletes the data packet 710 received by the communication device 600 from the buffer unit 607. Then, the data packet receiving process terminates. That is, in case when “the communication device 600 receives the data packet 710 for which another communication device is specified as a GD, but the data packet 710 was not forwarded by finding an adjacent node of an appropriate forwarding destination”, the data packet 710 is discarded.

On the other hand, in step S210, the condition of stopping the trial for the forwarding does not hold true. Therefore, the routing control unit 610 first determines the LD to be specified as a forwarding destination of the data packet 710 for the trial for the forwarding. Then, the routing control unit 610 notifies the transmission volume notification unit 602 of the determined LD.

Concretely, the routing control unit 610 searches the routing table 612 for an entry having the value of the GD equal to the value of the GD of the received data packet 710. Then, the routing control unit 610 refers to the entry found as a result of the search, and selects one of the candidates for the LD included in the entry. A candidate for the LD may be selected by various methods depending on the routing algorithm according to which the routing control unit 610 operates, and the details are described later.

In the next step S211, the transmission volume notification unit 602 calculates the transmission traffic again in the same method as in step S205. The transmission volume notification unit 602 stores the result calculated in step S205, and may use the stored result as transmission traffic in step S211.

In the next step S212, the transmission volume notification unit 602 transmits the data packet 710 including the transmission traffic obtained in step S211 to the LD determined by the routing control unit 610. Then, the data packet processing unit 608 including the transmission volume notification unit 602 etc. waits for the reception of the ACK packet 730. That is, the data packet processing unit 608 allows the process illustrated in FIG. 12 to sleep until specified time determined in advance as “ACK timeout time” has passed or until the ACK packet 730 corresponding to the transmitted data packet 710 is received. The passage of the ACK timeout time may be detected by, for example, the timer IC 202 or the timer 304.

For example, step S212 is described in detail below with reference to the example in which the data packet receiving process in FIG. 12 is performed when the data packet D4D illustrated in FIGS. 6 and 10 is received.

As illustrated in FIG. 6, the LD determined in step S210 is the node F. Furthermore, as clearly described on the link table 611E-1 in FIGS. 6 and 8, the value of the transmission traffic obtained in step S211 is “3”.

Therefore, in step S212, the transmission volume notification unit 602 rewrites the values of the LD, the LS, and the transmission traffic into the node ID of the node F, the node ID of the node E itself, and “3” in the data packet D4D in FIG. 10 stored in the buffer unit 607. Then, the transmission volume notification unit 602 transmits the data packet D4E obtained by the rewrite above. After the transmission, the data packet processing unit 608 waits for the reception of the ACK packet 730 for the data packet D4E.

In step S213 after step S212, the process in FIG. 12 which has transitorily slept is performed after being resumed by the passage of the ACK timeout time or by the reception of the ACK packet 730. In step S213, the routing control unit 610 judges whether or not the ACK packet 730 has been received before the ACK timeout time passes.

If the ACK packet 730 has been received before the ACK timeout time passes (that is, if the process resumes upon receipt of the ACK packet 730), the forwarding of the data packet 710 in step S212 has been successfully performed. Thus, the process proceeds to step S214.

On the other hand, if no ACK packet 730 is received before the ACK timeout time passes (that is, if the process resumes when the ACK timeout time passes), the forwarding of the data packet 710 fails in step S212. Thus, the process proceeds to step S215.

In step S214, the routing control unit 610 updates the routing table 612 as appropriate to reflect the successful forwarding of the data packet 710. Then, the data packet receiving process terminates.

For example, in step S214, the routing control unit 610 may set a smaller evaluation value (that is, may increase the evaluation) for the LD selected in step S210 in the entry of the routing table 612 referenced in step S210. The reduction level of the evaluation value depends on the embodiment.

The routing control unit 610 updates the routing table 612 as appropriate to reflect the unsuccessful forwarding of the data packet 710 in step S215. Then, the process returns to step S208. As a result, the trial for the forwarding is repeated until the communication device 600 successfully forwards the data packet 710 or it is judged that “an appropriate forwarding destination is not found”.

For example, in step S215, the routing control unit 610 may increase the evaluation value of the LD selected in step S210 (that is, may lower the evaluation) in the entry of the routing table 612 referenced in step S210. The increase level of the evaluation value depends on the embodiment.

Steps S208 and S210 for which detailed descriptions have been omitted also relate to step S215. Therefore, the relationships among steps S208, S210, and S215 are exemplified below.

As described above, the trial for the forwarding is performed one or plural times until the condition of stopping the trial for the forwarding is satisfied. For example, according to a routing algorithm, the routing control unit 610 may select a candidate for an LD having the highest evaluation (that is, the smallest evaluation value) in the first trials in step S210.

If no ACK packet 730 is received before the ACK timeout time passes, the routing control unit 610 updates the evaluation value in step S215. Then, in the second and subsequent trials in step S210, the routing control unit 610 may simply select a candidate for the LD having the highest evaluation, or may select a candidate for the LD having the highest evaluation from among those that have not been selected in step S210 in the preceding trials.

Furthermore, for example, it is assumed that the range of the evaluation value is 0 or more and smaller than 1, and 1 indicates the lowest evaluation. In this case, the routing control unit 610 may judge in step S208 that the condition of stopping the trial for the forwarding is satisfied, for example, when at least one of the following conditions (B1) and (B2) is satisfied.

(B1) There is no candidate for the LD having the evaluation value smaller than 1.

(B2) All candidates for the LD having an evaluation value smaller than 1 have already been selected in step S210 in the previous repetition of the trial.

In addition, although the explanation is omitted with reference to FIG. 12, a certain routing algorithm provides a mechanism for enabling a node in a network to find an appropriate path autonomously in a distributed manner by performing trial and error when the data packet 710 is actually transmitted. Concretely, when the data packet 710 which has been once transmitted by the transmission volume notification unit 602 is returned to the communication device 600 after looping in the network, the routing control unit 610 may detect the loop.

For example, in the initial state, each node in FIG. 4 does not recognize which adjacent node is to be appropriately selected as the LD for the data packet 710 for which the gateway GW1 is specified as the GD. Therefore, for example, the following situation may occur.

Assume that the node D transmits the data packet 710 for which the gateway GW1 is specified as the GD. In this case, it is assumed that the node D incidentally selects the node E as the LD. Then, the node E receives the data packet 710. It is assumed that the node E incidentally selects the node B as the LD. Then, for example, the data packet 710 may return to the node E by way of nodes B and C.

In the situation above, the node E may recognize from the combination of the GS and the ID of the data packet 710 that “the data packet 710 which has been transmitted to the node B has looped and returned from the node C”. That is, the node E may detect a loop by memorizing the GS and the ID for each forwarded data packet 710. Based on the result of the loop detection above, the node E may learn that the node B is not appropriate for the LD, and change the evaluation value of the node B to the maximum value (that is, the worst evaluation).

Furthermore, when the node E detects a loop as described above, it tries to select another candidate for the LD as a forwarding destination. In this case, the node E considers the LS (that is, the node D) which has first transmitted the data packet 710 as a candidate having the lowest priority in the selection in step S210 regardless of the record in the routing table 612.

For convenience, the LS which first receives the data packet 710 identified by the combination of a GS and an ID is referred to as an “original LS”. In the example above, the original LS for the node E is the node D.

The node E may recognize as described above that the priority of the node D is the lowest. This recognition is realized by memorizing not only the GS and the ID but also the original LS for each forwarded data packet 710. That is, the original LS is selectable only at the last repetition step even if the original LS may be selected as the LD in step S210.

For example, the node E learns that the node B is inappropriate as the LD from the result of the loop detection above. Then, the node E selects the next candidate for the LD other than the node D which is the original LS from among the adjacent nodes (that is, the nodes C and F). For example, the node E may next select the node F as the LD in step S210.

As a result, if the data packet 710 is successfully forwarded, the node E learns that the node F is appropriate as the LD. Concretely, the routing control unit 610 of the node E reflects the learning result by the evaluation value of the routing table 612.

Based on the discussion above relating to the original LS, the routing control unit 610 may use the condition of “‘C1 or C2’ and ‘C3 or C4’” as a “condition of stopping the trial for the forwarding” in step S208.

(C1) In the routing table 612, there is no candidate for the LD that is not the original LS, and has the evaluation value smaller than 1.

(C2) In the routing table 612, all candidates for the LD that are not the original LS, and have the evaluation value smaller than 1 have already been selected in step S210 in the previous repetition.

(C3) The original LS has already been selected in step S210 in the previous repletion as the last candidate for the LD.

(C4) The GS of the data packet 710 is the communication device 600 itself (that is, the original LS is not defined).

As described above, as explained with reference to FIG. 12, the process for predicting or detecting a bottleneck is incorporated into a series of processes such as forwarding performed upon receipt of a normal data packet 710 in the third embodiment. In addition, the information used in predicting or detecting a bottleneck is also included in the normal data packet 710, not in a dedicated control packet. Therefore, a load generated in the network for the prediction or detection of a bottleneck is low.

FIG. 13 is a flowchart of a reception traffic setting process performed in step S204 in FIG. 12 according to the third embodiment.

The notification reception unit 601 in step S301 extracts the value of the transmission traffic from the received data packet 710.

Then, in the next step S302, the notification reception unit 601 searches the link table 611 for an entry whose link name is equal to the LS of the received data packet 710. For example, the notification reception unit 601 of the node E, which receives the data packet D4D in FIG. 10, searches for an entry having the link name of node D.

Then, in step S303, the notification reception unit 601 judges whether or not the entry has been found as a result of the search in step S302. If the entry has been found, the process proceeds to step S304. On the other hand, the entry has not been found, the process proceeds to step S306. Normally, the entry is found. The entry is not found in an exceptional case in which, for example, the communication device 600 receives the data packet 710 before the reception of the hello packet 720 from a new adjacent node.

In step S304, the notification reception unit 601 sets the value extracted in step S301 as the reception traffic of the entry found as a result of the search in step S302. Then, in the next step S305, the notification reception unit 601 sets the current time as the traffic recognition time of the entry found as a result of the search in step S302. Then, the reception traffic setting process also terminates. The orders of steps S304 and S305 are arbitrarily exchangeable.

For example, the notification reception unit 601 of the node E which has received the data packet D4D in FIG. 10 sets “2” in the reception traffic in the entry in which the link name in the link table 611 is node D, and sets the current time Q_{DE1} as the traffic recognition time. As a result, the link table 611 of the node E becomes the link table 611E-1 in FIG. 8.

On the other hand, in step S306, the notification reception unit 601 adds a new entry to the link table 611.

Then, in the next step S307, the notification reception unit 601 sets the value of the LS of the received data packet 710 as the link name of the new entry added in step S306. In addition, in the next step S308, the notification reception unit 601 sets the value extracted in step S301 as the reception traffic of the new entry added in step S306.

Furthermore, in the next step S309, the notification reception unit 601 sets the current time as the traffic recognition time of the new entry added in step S306. Then, the reception traffic setting process also terminates. The orders of steps S307 through S309 are arbitrarily exchangeable.

FIG. 14 is a flowchart of a bottleneck detecting process performed in step S205 in FIG. 12 according to the third embodiment.

In step S401, the transmission volume notification unit 602 assigns the value stored in the transmission volume storage unit 613 to the variable OutboundTraffic indicating the volume of the transmission traffic.

Then, in the next step S402, the transmission volume notification unit 602 considers (i.e., focuses on) the first entry in the link table 611. The entry currently considered may be referred to as a “target entry”. Then, the process proceeds to step S403.

In step S403, the transmission volume notification unit 602 calculates the sum of the value of the variable OutboundTraffic and the value of the reception traffic of the entry considered in the link table 611, and assigns the calculation result to the variable OutboundTraffic.

Then, in the next step S404, the transmission volume notification unit 602 judges whether or not all entries in the link table 611 have been considered. If there is any remaining entry not considered yet by the transmission volume notification unit 602, the process proceeds to step S405. On the other hand, if all entries have been considered by the transmission volume notification unit 602, the process proceeds to step S406.

In step S405, the transmission volume notification unit 602 considers (i.e., focuses on) the next entry in the link table 611. Then, the process returns to step S403.

On the other hand, in step S406, the transmission volume notification unit 602 notifies the bottleneck judgment unit 603 of the value of the variable OutboundTraffic. Then, the bottleneck judgment unit 603 compares the notified value with a specified threshold Tout.

If the value of the variable OutboundTraffic is larger than the threshold Tout, then the bottleneck judgment unit 603 judges that “the communication device 600 is a bottleneck”, and notifies the bottleneck notification unit 604 of the judgment result. Then, the process proceeds to step S407.

On the other hand, if the value of the variable OutboundTraffic is equal to or smaller than the threshold Tout, the bottleneck judgment unit 603 judges that “the communication device 600 is not a bottleneck”. Then, the bottleneck detecting process terminates.

In step S407, the bottleneck notification unit 604 which has received the notification from the bottleneck judgment unit 603 transmits a warning (that is, a bottleneck notification).

As described above, the bottleneck notification may be transmitted according to the same protocol as the normal data packet 710, or transmitted according to another protocol. Furthermore, the bottleneck notification may refer to a multi-hop transmission in which a particular destination (for example, the gateway GW1) is the GD, or may flood in the entire network 400.

For example, the transmission volume notification unit 602 and the existence notification unit 616 may transmit the data packet 710 and the hello packet 720 respectively according to the IEEE 802.15.4 standard. On the other hand, the bottleneck notification unit 604 may transmit a bottleneck notification according to the IEEE 802.11b standard.

In this case, in the link table 611 and the routing table 612, the nodes in the communicable range in accordance with the IEEE 802.15.4 standard are managed as adjacent nodes. On the other hand, the bottleneck notification unit 604 may hold a table not illustrated in the attached drawings for managing the nodes in the communicable range in accordance with the IEEE 802.11b standard as adjacent nodes.

In addition, when the bottleneck notification is transmitted to a particular destination, the bottleneck notification may be for example a packet 700 as having the GD and GS fields in addition to the ad hoc header 701 in FIG. 10. In this case, the bottleneck notification unit 604 sets the node ID of the destination of the bottleneck notification (for example, the gateway GW1) as the GD, and sets the node ID of the communication device 600 itself as the GS. In addition, each node in the network (that is, the communication device 600) routes the bottleneck notification in the method similar to that of a normal data packet 710.

Otherwise, according to the use of a network, a bottleneck notification may be used by each node in autonomously judging the need of a transmission standard. To attain this, the bottleneck notification may be broadcast and flood in the entire network.

For example, the type of the packet for a bottleneck notification may be defined as follows. The bottleneck notification includes, for example, the GD and GS fields in addition to the ad hoc header 701 in FIG. 10. Then, the GD and the LD are set to particular values for broadcast, and the GS indicates a node of a bottleneck.

Then, the communication device 600 which receives a packet for a bottleneck notification performs the following process when the type judgment unit 606 judges that “the received packet is a packet for a bottleneck notification”.

That is, upon receipt of a packet for a bottleneck notification, the communication device 600 continues storing a pair of the ID and the GS of the received packet for a specified time. Then, the communication device 600 judges whether or not there is the same pair of the ID and GS in the stored pairs of the ID and GS as the pair of the ID and the GS of the received packet.

When the same pair of the ID and the GS as the pair of the ID and the GS of the received packet is found, the communication device 600 judges that “the same packet as the packet for a bottleneck notification which has been received before has been received again”, and discards the received packet. On the other hand, when the same pair of the ID and the GS as the pair of the ID and the GS of the received packet is not found, the communication device 600 rewrites only the LS of the received packet for a bottleneck notification, and broadcasts the packet for a bottleneck notification.

By the process above, a packet for a bottleneck notification is broadcast in the entire network. Therefore, each node in the network (that is, the communication device 600) may recognize that a bottleneck has been detected in the node having the GS of the packet. Based on the recognition above, the communication device 600 may take countermeasures such as “reducing the volume of data generated and transmitted by the communication device 600 itself”.

The process described above with reference to FIGS. 11 through 14 is performed by the communication device 600 upon receipt of the packet 700 of any type. However, the communication device 600 also performs some processes independent of the reception of the packet 700.

For example, the existence notification unit 616 of the communication device 600 periodically transmits the hello packet 720. For example, when an interrupt signal is periodically output at specified intervals from the timer IC 202 or the timer 304, the existence notification unit 616 generates and transmits the hello packet 720.

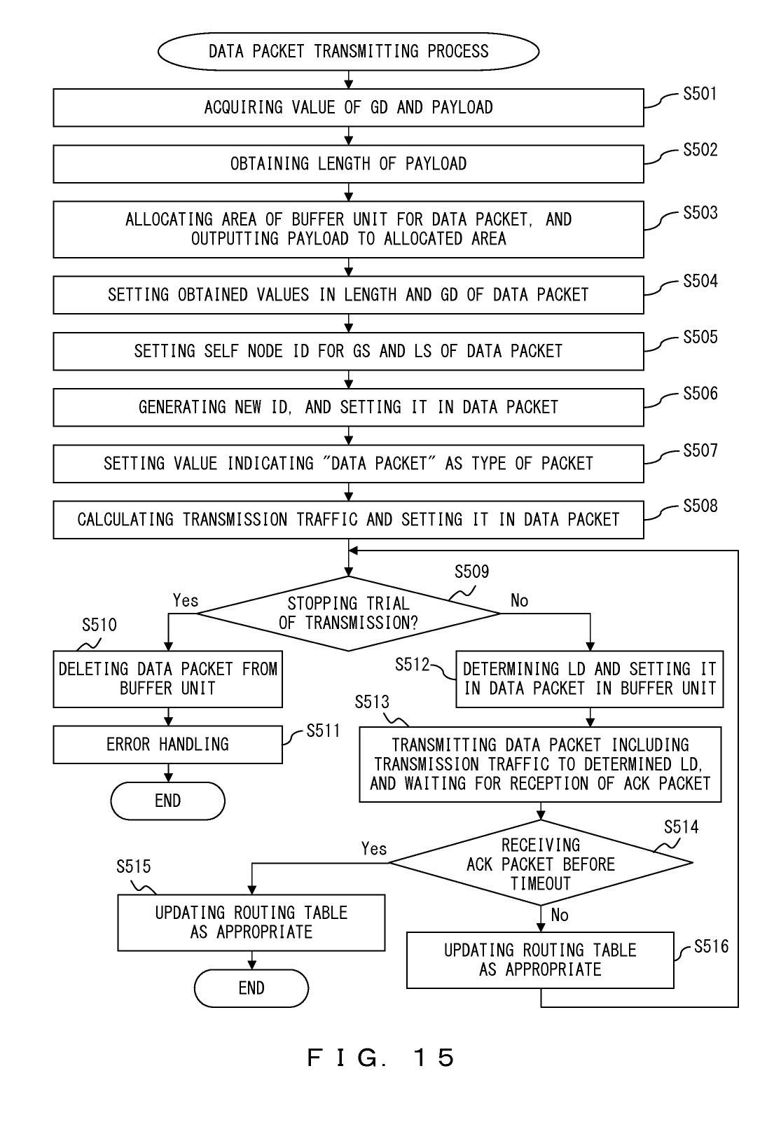

In addition, the communication device 600 periodically or irregularly transmits the data packet 710 as a GS. Concretely, the communication device 600 performs the process in FIG. 15. FIG. 15 is a flowchart of a data packet transmitting process in the third embodiment. For example, the node F generates and transmits the data packet D1F in FIG. 6 by the process in FIG. 15.

First in step S501, the upper layer processing unit 609 acquires the value of the GD and the payload.

The value of the GD may be fixedly determined as the node ID of a particular node (for example, the gateway GW1) in the network. Otherwise, the upper layer processing unit 609 may dynamically determine the value of the GD.

Furthermore, the contents of the payload are arbitrary. The upper layer processing unit 609 may acquire the output from, for example, the sensor 207 or the sensor 308 as a payload.

Next, in step S502, the upper layer processing unit 609 obtains the length of the payload.

Then, in step S503, the upper layer processing unit 609 allocates an area of the buffer unit 607 for a new data packet 710. The upper layer processing unit 609 may determine the size of the assigned area based on the length obtained in step S502. Then, the upper layer processing unit 609 outputs the payload to the assigned area.

Next, in step S504, the upper layer processing unit 609 sets the values respectively obtained in steps S502 and S501 in the length field and the GD field of the data packet 710.

Furthermore, in the next step S505, the upper layer processing unit 609 sets the self node ID (that is, the node ID of the communication device 600 itself) in the GS field and the LS field of the data packet 710.

Furthermore, in step S506, the upper layer processing unit 609 generates anew ID. Then, the upper layer processing unit 609 sets the value of the newly generated ID in the ID field of the data packet 710.

In step S507, the upper layer processing unit 609 sets the value indicating a data packet (the value “Data” in the example in FIG. 10) as the type of the data packet 710.

In step S508, the upper layer processing unit 609 requests the routing control unit 610 to transmit the data packet 710. Then, the routing control unit 610 requests the transmission volume notification unit 602 to calculate the transmission traffic, and the transmission volume notification unit 602 calculates the transmission traffic as in steps S401 through S405 in FIG. 14. Then, the transmission volume notification unit 602 sets the calculated value as the transmission traffic of the data packet 710.

By the steps S503 through S508 above, a new data packet 710 for which the fields other than the LD are appropriately set is completed in the buffer unit 607. The orders of steps S504 through S508 are appropriately exchangeable.

In step S509 after step S508, the routing control unit 610 judges whether or not the condition of stopping the trial for a transmission is satisfied. If the condition of stopping the trial for the transmission is satisfied, the process proceeds to step S510. On the other hand, if the condition of stopping the trial for the transmission is not satisfied, the process proceeds to step S512. The condition of stopping the trial for the transmission is described later in detail.

In step S510, the condition of stopping the trial for the transmission is satisfied. Therefore, the routing control unit 610 deletes the data packet 710 from the buffer unit 607.

Then, in the next step S511, the routing control unit 610 reports to the upper layer processing unit 609 about the unsuccessful transmission. Then, the upper layer processing unit 609 appropriately performs error handling, thereby terminating the data packet transmitting process.

On the other hand, in step S512, the condition of stopping the trial for the transmission is not satisfied. Therefore, the routing control unit 610 first determines the LD to be specified as the destination of the data packet 710 for the trial for a transmission. Then, the routing control unit 610 sets the value of the determined LD in the data packet 710 in the buffer unit 607.

For example, the routing control unit 610 searches the routing table 612 for an entry whose GD has the same value as the value of the GD set in the data packet 710. Then, the routing control unit 610 refers to the entry that has been found as the search result, and selects one of the candidates for the LD included in the found entry. There may be various methods of selecting a candidate for the LD depending on the routing algorithm according to which the routing control unit 610 operates, and the details are described later.

In the next step S513, the transmission volume notification unit 602 transmits the data packet 710 including the transmission traffic to the LD determined by the routing control unit 610 in step S512. Then, the data packet processing unit 608 including the transmission volume notification unit 602 etc. waits for the reception of the ACK packet 730. That is, the data packet processing unit 608 allows the process in FIG. 15 to sleep until the ACK timeout time passes or the ACK packet 730 corresponding to the transmitted data packet 710 is received.

The next step S514 after the step S513 is performed when the temporarily sleeping process in FIG. 15 is resumed when the ACK timeout time passes or the ACK packet 730 is received. In step S514, the routing control unit 610 judges whether or not the ACK packet 730 has been received before the ACK timeout time passes.

If the ACK packet 730 has been received before the ACK timeout time passes (that is, if the process resumes upon receipt of the ACK packet 730), the data packet 710 is successfully transmitted in step S513. Thus, the process proceed to step S515.

On the other hand, if no ACK packet 730 is received before the ACK timeout time passes (that is, if the process resumes when the ACK timeout time passes), the data packet 710 has been unsuccessfully transmitted in step S513. Thus, the process proceeds to step S516.

In step S515, the routing control unit 610 updates the routing table 612 as appropriate to reflect the successful transmission of the data packet 710. Then, the data packet transmitting process terminates. For example, as in step S214 in FIG. 12, the routing control unit 610 may reduce the evaluation value of the LD selected in step S512 (that is, it may enhance the evaluation).

On the other hand, in step S516, the routing control unit 610 updates the routing table 612 as appropriate to reflect the unsuccessful transmission of the data packet 710. Then, the process returns to step S509. For example, as in step S215 in FIG. 12, the routing control unit 610 may increase the evaluation value of the LD selected in step S512 (that is, may reduce the evaluation).

As described above, the trial for a transmission is performed once or plural times until the condition of stopping the trial for the transmission is satisfied. For example, according to a routing algorithm, the routing control unit 610 may select a candidate for the LD having the highest evaluation (that is, having the smallest evaluation value) in the first step S512.

Then, if the ACK packet 730 is not received before the ACK timeout time passes, the routing control unit 610 updates the evaluation value in step S516. Then, in the second and subsequent step S512, the routing control unit 610 may simply select a candidate for the LD having the highest evaluation, or may select a candidate for the LD having the highest evaluation in those not selected yet in step S512 in the previous repetition.

Furthermore, for example, it is assumed that the range of the evaluation value is determined as equal to or larger than 0 and smaller than 1, and 1 indicates the lowest evaluation. In this case, the routing control unit 610 may judge that the condition of stopping the trial for the transmission is satisfied when the following (D1) or (D2) holds true in step S509.

(D1) In the entry of the routing table 612 having the same value of the GD as the value of the GD set in the data packet 710, there is no candidate for the LD having the evaluation value smaller than 1.

(D2) In the entry of (D1) above, all candidates for the LD having the evaluation value smaller than 1 have been already selected in step S512 in the previous repetition.

The loop detection similar to that described with reference to FIG. 12 may be performed. That is, the communication device 600 may associate the ID generated in step S506 with the node ID of the communication device 600 itself (that is, the node ID indicating the GS) and store the ID, and may use the values of the stored ID and GS for loop detection.

Then, the fourth embodiment in which the transmission traffic is embedded in a hello packet unlike the third embodiment described above is described below with reference to FIGS. 16 through 21.

FIG. 16 is a timing chart relating to transmission and reception of a hello packet in the fourth embodiment. The timing chart in FIG. 16 illustrates the transmission and reception of a hello packet when each of the nodes A through I in FIG. 4 is the communication device 800 according to the fourth embodiment described later with reference to FIG. 17.

The gateway GW1 is not always to be configured like the nodes A through I, but the gateway GW1 performs operations similar to those of the nodes A through I relating at least to the transmission of a hello packet. For simple explanation, it is assumed that the nodes A through I and the gateway GW1 periodically transmit a hello packet at the same interval ΔH.

In FIG. 16, each hello packet is identified by a 3- or 4-character reference numeral. The first character is “H” indicating a hello packet. The last character is a numeral for distinction of a plurality of hello packets transmitted from the same node. The one or two middle characters indicate the node for transmitting a hello packet.

It is assumed that the final destination of a data packet in the network 400 is the gateway GW1 as in the third embodiment. Furthermore, it is assumed that the notification destination of a judgment result relating to a bottleneck from each of the nodes A through I is also the gateway GW1.

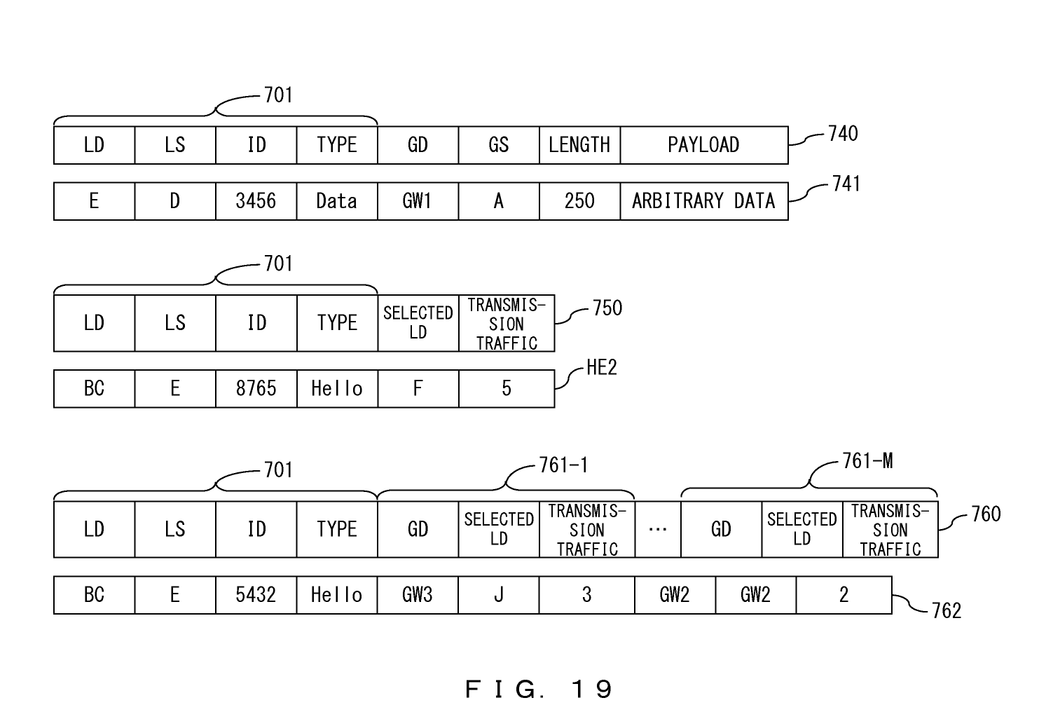

Although the details are described later with reference to FIG. 19, a hello packet, not a data packet, includes a “transmission traffic” field in the fourth embodiment. Furthermore, the hello packet also includes a “selected LD” field indicating that “which adjacent node is selected as an LD when the source node of the hello packet transmits a data packet for which the gateway GW1 is specified as a GD”.

Then, the hello packet is broadcast within the range of 1 hop. In FIG. 16, a plurality of arrows from the same point indicate the broadcast of the hello packet. In addition, the value in the square superimposed on the arrow is the value of the transmission traffic in the hello packet indicated by the arrow.

For convenience of explanation in the following description, the expected value of the volume of data generated by each of the nodes A through I and transmitted to the gateway GW1 in a specified period is assumed to be “1” as with the explanation relating to FIG. 4. In addition, the threshold for judgment of a bottleneck is defined as “5”. The meaning of the “expected value” is similar to that according to the third embodiment.

Furthermore, in the following explanation relating to FIG. 16, it is assumed that “the path indicated by the arrow in solid line in FIG. 4 has already been generated”. The meaning of the assumption is that “the result of the prediction or detection of a bottleneck based on the value of the transmission traffic included in the hello packet transmitted and received before the path is generated and becomes stable is only a provisional result which reflects a transitional path being generated”. That is, the assumption above is supplemented with the following description.

In the ad hoc network, a plurality of nodes generally transmit the respective hello packets to issue the notifications about the existence of themselves, thereby enabling each node to recognize the existence of other adjacent nodes. The path through which a data packet is routed is generated after the recognition of a adjacent node in many cases depending on the path construction algorithm.

Obviously, a hello packet is repeatedly transmitted even after the construction of a path because the adjacency relation between nodes may change. In addition, a path is not always fixed, and may be appropriately reconstructed depending on the change of the adjacency relation between nodes.

Thus, a hello packet is repeatedly transmitted before the path becomes stable (that is, during the construction of the path) and after the path becomes stable. Then, the hello packet transmitted before the path becomes stable may include the transmission traffic.

However, the result of the prediction or the detection of a bottleneck based on the value of the transmission traffic included in the hello packet transmitted and received before the path becomes stable is only a provisional result which reflects the transitional path being constructed. In the fourth embodiment, if a hello packet is transmitted at a certain frequency after the path is constructed and becomes stable, then a result of an appropriate bottleneck prediction or detection may be obtained by reflecting a stable path.

Accordingly, in the following explanation relating to FIG. 16 it is assumed that “the path indicated by the arrow in solid line in FIG. 4 is already constructed” as described above. Under the assumption above, provided is the following explanation that “an appropriate result of the bottleneck prediction or detection is obtained when a hello packet is transmitted at a certain frequency as described above after the construction of a path”.

A hello packet may be transmitted some times excessively until the influence of the transmission traffic included in the hello packet transmitted before the path becomes stable disappears after the construction of the path. Therefore, to shorten the time taken to remove the influence, each node may set “0” as the transmission traffic in the hello packet until it is recognized that the path has become stable.

For example, after initial powerup, each node may monitor the history of the node selected as the LD when the data packet addressed to the gateway GW1 is transmitted. Until the path becomes stable, each node selects the LD with trial and error. Therefore, a loop may occur, and an adjacent node selected as the LD may be changed each time a data packet is transmitted. However, if the path becomes stable, the same adjacent node is continuously selected as the LD.

Therefore, each node may assume that “the path has become stable” if, for example, the same adjacent node is first selected as the LD a specified number of times continuously for the same GD after initial powerup. Then, each node may set “0” as the transmission traffic in the hello packet until the path is recognized as stable.

For simple explanation in the following description, it is assumed that the transmission traffic of “0” is set in the hello packet transmitted by the time when the path becomes stable. According to the assumption, omitted is the explanation about the removal of the influence of the transmission traffic included in the hello packet transmitted until the path becomes stable.

FIG. 16 exemplifies the following process sequence as an example after the path becomes stable.

First, the node A transmits a hello packet HA1. The value of the transmission traffic set in the hello packet HA1 is “1” because the node A has not received from other nodes before the transmission of the hello packet HA1 any hello packet for which the transmission traffic other than “0” is set. Therefore, “1” as the expected value of the volume of the data that is addressed to the gateway GW1 and transmitted by the node A in a specified period is set as the transmission traffic in the hello packet HA1.

As indicated by the arrow in solid line in FIG. 4, when transmitting a data packet for which the gateway GW1 is specified as the GD, the node A selects the node D as the LD. Therefore, the node D is specified as the selected LD in the hello packet HA1.

As illustrated in FIG. 4, the nodes B and D are adjacent to the node A. Therefore, the hello packet HA1 is received by the nodes B and D.

Since the node B is not the selected LD specified by the hello packet HA1, it ignores the value of the transmission traffic of the hello packet HA1. On the other hand, since the node D is the selected LD, it stores the value of “1” of the transmission traffic set in the hello packet HA1 as associated with the node A as the LS of the hello packet HA1.

In the example in FIG. 16, the gateway GW1 transmits a hello packet HGW1 almost simultaneously with the transmission of the hello packet HA1 incidentally. In the hello packet HGW1, the value of the transmission traffic is “0”, and the value of the selected LD is a particular value invalid as a node ID because the gateway GW1 itself does not transmit a data packet to another nodes.

In addition, as illustrated in FIG. 4, the nodes G, H, and I are adjacent to the gateway GW1. Therefore, the hello packet HGW1 is received by the nodes G, H, and I. However, since any of the nodes G, H, and I is not the selected LD, the value of the transmission traffic of the hello packet HGW1 is ignored.

Then, in the example in FIG. 16, the node D next transmits a hello packet HD1. The value of the transmission traffic set in the hello packet HD1 is “2” because the node D has already received the hello packet HA1, and stores the value of “1” associated with the node A. Accordingly, the node D sets “2” as the transmission traffic in the hello packet HD1. The value “2” is a sum of the values of “1”, which is stored and associated with the node A, and “1” as the expected value of the volume of the data that is addressed to the gateway GW1 and transmitted by the node D itself in a specified period.

Furthermore, as indicated by the arrow in solid line in FIG. 4, the node D selects the node E as the LD when transmitting a data packet for which the gateway GW1 is specified as the GD. Therefore, the node E is specified as the selected LD in the hello packet HD1.

As illustrated in FIG. 4, the nodes A, B, and E are adjacent to the node D. Therefore, the hello packet HD1 is received by the nodes A, B, and E.

However, since the nodes A and B are not the selected LD specified by the hello packet HD1, the value of the transmission traffic of the hello packet HD1 is ignored. On the other hand, since the node E is the selected LD, it stores the value of “2” of the transmission traffic set in the hello packet HD1 as associated with the node D as the LS of the hello packet HD1.

Furthermore, in the example in FIG. 16, the node G transmits a hello packet HG1 almost simultaneously with the hello packet HD1 incidentally. The value of the transmission traffic set in the hello packet HG1 is “1” because the node G has not received before the transmission of the hello packet HG1 from other nodes any hello packet for which the transmission traffic other than “0” is set. Therefore, “1” as an expected value of the volume of data that is addressed to the gateway GW1 and transmitted by the node G in a specified period is set as the transmission traffic in the hello packet HG1.

As indicated by the arrow in solid line in FIG. 4, the node G selects the gateway GW1 as the LD when transmitting the data packet for which the gateway GW1 is specified as the GD. Therefore, the gateway GW1 is specified as the selected LD for the hello packet HG1.

As illustrated in FIG. 4, the nodes F and H, and the gateway GW1 are adjacent to the node G. Therefore, the hello packet HG1 is received by the nodes F and H, and the gateway GW1. However, since the nodes F and H are not the selected LD, they ignore the value of the transmission traffic of the hello packet HG1. In addition, since the gateway GW1 does not judge whether or not “the gateway GW1 itself is a bottleneck” in the fourth embodiment, the gateway GW1 also ignores the value of the transmission traffic.

Then, in the example in FIG. 16, the node B next transmits a hello packet HB1. The value of the transmission traffic set in the hello packet HB1 is “1” because the node B has already received the hello packet HD1, but it does not consider the value of the transmission traffic of the hello packet HD1 as described above. Therefore, “1” as the expected value of the volume of the data that is addressed to the gateway GW1 and transmitted by the node B in a specified period is set as the transmission traffic in the hello packet HB1.

Furthermore, as indicated by the arrow in solid line in FIG. 4, the node B selects the node E as the LD when the data packet for which the gateway GW1 is specified as the GD is transmitted. Therefore, the node E is specified as the selected LD in the hello packet HB1.

As illustrated in FIG. 4, the nodes A, C, D, and E are adjacent to the node B. Accordingly, the hello packet HB1 is received by the nodes A, C, D, and E.

However, since the nodes A, C, and D are not the selected LD specified for the hello packet HB1, they ignore the value of the transmission traffic of the hello packet HB1. On the other hand, since the node E is the selected LD, it stores the value of “1” of the transmission traffic set in the hello packet HB1 as associated with the node B as the LS of the hello packet HB1.

In the example in FIG. 16, the node H next transmits a hello packet HH1. The value of the transmission traffic set in the hello packet HH1 is “1” because the node H has already received the hello packets HGW1 and HG1, but it does not consider the value of the transmission traffic of the hello packets HGW1 and HG1 as described above. Therefore, “1” as the expected value of the volume of the data that is addressed to the gateway GW1 and transmitted by the node H in a specified period is set as the transmission traffic in the hello packet HH1.

As indicated by the arrow in solid line in FIG. 4, the node H selects the gateway GW1 as the LD when transmitting the data packet for which the gateway GW1 is specified as the GD. Therefore, the gateway GW1 is specified as the selected LD in the hello packet HH1.

As illustrated in FIG. 4, the nodes F, G, and I, and the gateway GW1 are adjacent to the node H. Therefore, the hello packet HH1 is received by the nodes F, G, and I, and the gateway GW1. However, since the nodes F, G, and I are not the selected LD, they ignore the value of the transmission traffic of the hello packet HH1. Furthermore, the gateway GW1 also ignores the value of the transmission traffic of the hello packet HH1 as with the hello packet HG1.

Next, in the example in FIG. 16, the node E transmits a hello packet HE1. The value of the transmission traffic set in the hello packet HE1 is “4” because the node E has already received the hello packets HD1 and HB1, and stores the values “2” and “1” as associated with the nodes D and B respectively. Accordingly, the node E sets, as the transmission traffic in the hello packet HE1, the value “4” that is a sum of the stored values “2” and “1”, and “1” as the expected value of the volume of the data that is addressed to the gateway GW1 and transmitted by the node E itself in a specified period.

Furthermore, as indicated by the arrow in solid line in FIG. 4, the node E selects the node F as the LD when transmitting the data packet for which the gateway GW1 is specified as the GD. Therefore, the node F is specified as the selected LD in the hello packet HE1.

As illustrated in FIG. 4, the nodes B, C, D, and F are adjacent to the node E. Therefore, the hello packet HE1 is received by the nodes B, C, D, and F.

However, since the nodes B, C, and D are not the selected LD specified by the hello packet HE1, they ignore the value of the transmission traffic of the hello packet HE1. On the other hand, since the node F is the selected LD, it stores the value of “4” of the transmission traffic set in the hello packet HE1, in association with the node E, which is the LS of the hello packet HE1.

Then, in the example in FIG. 16, the node I next transmits a hello packet HI1. The value of the transmission traffic set in the hello packet HI1 is “1” because the node I has already received the hello packets HGW1 and HH1, but does not consider the value of the transmission traffic of the hello packets HGW1 and HH1 as described above. Therefore, “1” as the expected value of the volume of the data that is addressed to the gateway GW1 and transmitted by the node I in a specified period is set as the transmission traffic in the hello packet HI1.

Furthermore, as indicated by the arrow in solid line in FIG. 4, the node I selects the gateway GW1 as the LD when transmitting the data packet for which the gateway GW1 is specified as the GD. Therefore, the gateway GW1 is specified as the selected LD in the hello packet HI1.

As illustrated in FIG. 4, the nodes F and H, and the gateway GW1 are adjacent to the node I. Therefore, the hello packet HI1 is received by the nodes F and H, and the gateway GW1. However, since the nodes F and H are not the selected LD, they ignore the value of the transmission traffic of the hello packet HI1. In addition, the gateway GW1 also ignores the value of the transmission traffic of the hello packet HI1 as with the hello packets HG1 and HH1.

Then, in the example in FIG. 16, the node C transmits a hello packet HC1. The value of the transmission traffic set in the hello packet HC1 is “1” because the node C has already received the hello packets HB1 and HE1, but do not consider the value of the transmission traffic of the hello packets HB1 and HE1 as described above. Therefore, “1” as the expected value of the volume of the data that is addressed to the gateway GW1 and transmitted by the node C in a specified period is set as the transmission traffic in the hello packet HC1.

Furthermore, as indicated by the arrow in solid line in FIG. 4, the node C selects the node E as the LD when transmitting the data packet for which the gateway GW1 is specified as the GD. Therefore, the node E is specified as the selected LD in the hello packet HC1.

As illustrated in FIG. 4, the nodes B and E are adjacent to the node C. Therefore, the hello packet HC1 is received by the nodes B and E. Since the node B is not the selected LD specified in the hello packet HC1, they ignore the value of the transmission traffic of the hello packet HC1. On the other hand, since the node E is the selected LD, it stores the value of “1” of the transmission traffic set in the hello packet HC1 as associated with the node C as the LS of the hello packet HC1.

Next, in the example in FIG. 16, the node F transmits a hello packet HF1. The value of the transmission traffic set in the hello packet HF1 is “5” because, first, the node F does not consider the value of the transmission traffic of the hello packets HG1, HH1, and HI1 in the already received hello packets as described above. Second, the node F stores the value of “4” of the transmission traffic of the already received hello packet HE1 as associated with the node E. Therefore, the node F sets “5” as a sum of the stored value of “4” and “1” as the expected value of the volume of the data that is addressed to the gateway GW1 and transmitted by the node F itself in a specified period as the transmission traffic in the hello packet HF1.

Furthermore, as indicated by the arrow in solid line in FIG. 4, the node F selects the node H as the LD when transmitting the data packet for which the gateway GW1 is specified as the GD. Therefore, the node H is specified as the selected LD in the hello packet HF1. Therefore, the node H is specified as the selected LD in the hello packet HF1.

As illustrated in FIG. 4, the nodes E, G, H, and I are adjacent to the node F. Therefore, the hello packet HF1 is received by the nodes E, G, H, and I.

However, since the nodes E, G, and I are not the selected LD specified in the hello packet HF1, they ignore the value of the transmission traffic of the hello packet HF1.

On the other hand, since the node H is the selected LD, it stores the value of “5” of the transmission traffic set in the hello packet HF1 as associated with the node F as the LS of the hello packet HF1. Furthermore, the sum of the “1” as the expected value of the volume of the data that is addressed to the gateway GW1 and transmitted by the node H in a specified period and the value of “5” above exceeds the threshold of “5”. Therefore, the node H judges that “the node H is a bottleneck in the network 400”, and transmits a bottleneck notification.

In the example in FIG. 16, the node A transmits a hello packet HA2 at an interval AH from the transmission of the hello packet HA1. In addition, at the interval ΔH from the transmission of the hello packet HGW1, the gateway GW1 transmits the hello packet HGW2. Furthermore, at the interval ΔH from the transmission of the hello packet HD1, the node D transmits the hello packet HD2.

Additionally, at the interval ΔH from the transmission of the hello packet HG1, the node G transmits the hello packet HG2. Then, at the interval ΔH from the transmission of the hello packet HB1, the node B transmits the hello packet HB2.

The transmission traffic having the same value as the hello packets HA1, HGW1, HD1, HG1, and HB1 are set respectively in the above-mentioned hello packets HA2, HGW2, HD2, HG2, and HB2. Therefore, a result caused by the transmission of the hello packets HA2, HGW2, HD2, HG2, and HB2 is the same as the result caused by the transmission of the hello packets HA1, HGW1, HD1, HG1, and HB1.

Afterwards, the node H transmits the hello packet HH2 at the interval ΔH from the transmission of the hello packet HH1. The node H has not received the hello packet HF1 at the time when the hello packet HH1 is transmitted. Therefore, the value of the transmission traffic of the hello packet HH1 is “1” as described above.

However, when the hello packet HH2 is transmitted, the node H has already received the hello packet HF1, and the value of “5” of the transmission traffic of the hello packet HF1 is memorized by the node H in association with the node F. Therefore, the value of the transmission traffic of the hello packet HH2 is, unlike that of the hello packet HH1, the value “6” that is a sum of the stored value of “5” and the value “1” as the expected value of the volume of the data that is addressed to the gateway GW1 and transmitted by the node H in a specified period.

However, as with the case of the hello packet HH1, the value of the transmission traffic of the hello packet HH2 is ignored by the nodes F, G, and I, and the gateway GW1. Therefore, the bottleneck is not transmitted upon receipt of the hello packet HH2.

Afterwards, the node E transmits a hello packet HE2 at the interval ΔH from the transmission of the hello packet HE1. The node E has not received the hello packet HC1 at the time point when the hello packet HE1 is transmitted. Therefore, the value of the transmission traffic of the hello packet HE1 is “4” as described above.

However, when the hello packet HE2 is transmitted, the node E has already received the hello packet HC1, and stores the value of “1” of the transmission traffic of the hello packet HC1 in association with the node C. Furthermore, upon receipt of the hello packet HD2, the node E has obviously stored the value of “2” of the transmission traffic of the hello packet HD2 in association with the node D. Furthermore, upon receipt of the hello packet HB2, the node E has stored the value of “1” of the transmission traffic of the hello packet HB2 in association with the node B.

Therefore, the value of the transmission traffic of the hello packet HE2 is, unlike that of the hello packet HE1, the value “5” that is a sum of the stored values of “1”, “2”, and “1”, and “1” as the expected value of the volume of the data that is addressed to the gateway GW1 and transmitted by the node E in a specified period.

Then, the hello packet HE2 is received by the nodes B, C, D, and F. Since the nodes B, C, and D are not the selected LD specified in the hello packet HE2, they ignore the value of the transmission traffic of the hello packet HE2.

However, since the node F is the selected LD, it stores the value of “5” of the transmission traffic set in the hello packet HE2 as associated with the node E as the LS of the hello packet HE2. That is, the node F updates to “5” the value of “4”, which has hitherto been stored in association with the node E.

The sum of “1” as the expected value of the volume of data that is addressed to the gateway GW1 and transmitted by the node F in a specified period and the value of “5” above exceeds the threshold of “5”. Therefore, the node F judges that “the node F is a bottleneck in the network 400”, and transmits a bottleneck notification.

Afterwards, the node I transmits a hello packet HI2 at the interval ΔH from the transmission of the hello packet HI1. The node C transmits a hello packet HC2 at the interval ΔH from the transmission of the hello packet HC1.

The transmission traffic of the same value as the hello packets HI1 and HC1 is set in the hello packets HI2 and HC2 respectively. Therefore, the result caused by the transmission of the hello packets HI2 and HC2 is the same as that caused by the transmission of the hello packets HI1 and HC1.

Afterwards, the node F transmits a hello packet HF2 at the interval ΔH from the transmission of the hello packet HF1. Upon receipt of the hello packet HE2, the node F updates the value stored in association with the node E, as described above. Therefore, with the update, the value of the transmission traffic set in the hello packet HF2 is different from the value set in the hello packet HE1. That is, “6” as the sum of the updated value of “5” and “1” as the expected value of the volume of the data that is addressed to the gateway GW1 and transmitted by the node F in a specified period is set as the transmission traffic of the hello packet HF2.

Then, the hello packet HF2 is received by the nodes E, G, H, and I. Since the nodes E, G, and I are not the selected LD specified in the hello packet HF2, they ignore the value of the transmission traffic of the hello packet HF2.

However, since the node H is the selected LD, it stores the value of “6” of the transmission traffic set in the hello packet HF2 in association with the node F, which is the LS of the hello packet HF2. That is, the node H updates to “6” the value of “5”, which has hitherto been stored in association with the node F.

In addition, the sum of “1” as the expected value of the volume of the data that is addressed to the gateway GW1 and transmitted by the node H in a specified period and the above-mentioned value of “6” exceeds the threshold of “5”. Therefore, the node H judges that “the node H is a bottleneck in the network 400”, and transmits a bottleneck notification.

Afterwards, the node A transmits a hello packet HA3 at the interval ΔH after the transmission of the hello packet HA2. The gateway GW1 transmits a hello packet HGW3 at the interval ΔH from the transmission of the hello packet HGW2. Furthermore, the node D transmits a hello packet HD3 at the interval ΔH from the transmission of the hello packet HD2.

The node G transmits a hello packet HG3 at the interval AH from the transmission of the hello packet HG2. Then, the node B transmits the hello packet HB3 at the interval ΔH from the transmission of the hello packet HB2.

The transmission traffic of the same value as the hello packets HA2, HGW2, HD2, HG2, and HB2 is set respectively in the above-mentioned hello packets HA3, HGW3, HD3, HG3, and HB3. Therefore, the result caused by the transmission of the hello packets HA3, HGW3, HD3, HG3, and HB3 is the same as the result caused by the transmission of the hello packets HA2, HGW2, HD2, HG2, and HB2.

Afterwards, the node H transmits a hello packet HH3 at the interval ΔH from the transmission of a hello packet HH2. Upon receipt of the hello packet HF2, the node H updates the value stored in association with the node F, as described above. Therefore, with the update, the value of the transmission traffic set in the hello packet HH3 is different from the value set in the hello packet HH2. That is, “7” as the sum of the updated value of “6” and “1” as the expected value of the volume of the data that is addressed to the gateway GW1 and transmitted by the node H in a specified period is set as the transmission traffic of the hello packet HH3.

As with the case of the hello packet HH1 and HH2, the value of the transmission traffic of the hello packet HH3 is ignored by the nodes F, G, and I, and the gateway GW1. Therefore, a bottleneck notification is not transmitted upon receipt of the hello packet HH3.

Similarly, each of the nodes A through I and the gateway GW1 in the network 400 repeats the transmission of the hello packet at the intervals ΔH. However, as illustrated in FIG. 16, the value of the transmission traffic converges at the time point of the transmission of the hello packet HH3.

As described above, the prediction or detection of a bottleneck are not perfectly performed only by transmitting a hello packet each time by each node after the path becomes stable depending on the order of transmitting a hello packet by each node in the network 400. However, while repeating the transmission of a hello packet for several times, the value of the transmission traffic converges, and a bottleneck may be predicted or detected without exception.

The maximum time taken to predict or detect a bottleneck without exception may be concretely formulated as follows.

In the network topology as FIG. 4, the GD may be regarded as a root node. In addition, between the two adjacent nodes connected by a link (that is, the arrow in solid line in FIG. 4) used in the transmission of a data packet, it is assumed that the node as an LS is regarded as a child node, and the node as an LD is regarded as a parent node.

Then, the value of the transmission traffic of the hello packet transmitted by a leaf node is constantly regarded as “already converged”. In addition, the value of the transmission traffic of the hello packet transmitted by a node which is not a leaf node may be regarded as “already converged” only after a certain node has received a hello packet including the transmission traffic which may be regarded as “already converged” from all child nodes.

Then, the time taken for a root node to receive a hello packet which may be regarded as “already converged” from all child nodes of the root node after the path has become stable is the maximum time described above when the definition above is made as to whether or not the value of the transmission traffic has been “already converged”,

According to the definition above, the nodes A, B, C, G, and I are leaf nodes. The value of the transmission traffic of the hello packet transmitted from these leaf nodes may be regarded as “already converged”, and is not changed after the path becomes stable as illustrated in FIG. 16.

In addition, according to the definition above, for example, the transmission traffic of the hello packet HE1 transmitted before the node E which is not a leaf node receives the hello packet HC1 from the node C as a child node is not regarded as “already converged”. However, the value of the transmission traffic of the hello packet HE2 may be regarded as “already converged”.

Similarly, the value of the transmission traffic of the hello packets HF1, HH1, and HH2 is not regarded as “already converged”. However, the value of the transmission traffic of the hello packets HF2 and HH3 may be regarded as “already converged”.

Therefore, in the example in FIG. 16, “the maximum time taken to predict or detect a bottleneck without exception” means “the time taken for the gateway GW1 to receive the hello packet HH3 after the path has become stable”.

The nodes A through I in the network 400 may transmit a hello packet in a random order. Furthermore, as clearly described above, the above-mentioned maximum time depends on the topology of the path through which a data packet is transmitted. Therefore, it is difficult to correctly recognize the above-mentioned maximum time in advance.

Therefore, as an approximate value of the above-mentioned maximum time, for example, a product of the transmission interval ΔH of a hello packet and the maximum hop count (or the value estimated as its approximate value) to the gateway GW1 in the network 400 may be referenced. For example, the gateway GW1 may judge that “there is no bottleneck node” unless it receives a warning after waiting for the maximum time.

The concrete realization of the operation of each node described above with reference to FIG. 16 is described below in more detail with reference to FIGS. 17 through 21.

FIG. 17 is a block diagram of a configuration of the communication device according to the fourth embodiment. In the fourth embodiment, each of the nodes A through I is configured as the communication device 800 in FIG. 17.

The communication device 800 in FIG. 17 includes a notification reception unit 801, a transmission volume notification unit 802, a bottleneck judgment unit 803, and a bottleneck notification unit 804 respectively similar to the notification reception unit 101, the transmission volume notification unit 102, the bottleneck judgment unit 103, and the transmission bottleneck notification unit 104 in FIG. 1. In addition, the communication device 800 includes a path information storage unit 805 similar to the path information storage unit 105 in FIG. 1.

Furthermore, the communication device 800 includes a type judgment unit 806 which judges the type of a received packet, and a buffer unit 807 which temporarily stores a data packet. In addition, the communication device 800 includes a data packet processing unit 808 which performs the process relating to the transmission and reception of a data packet. The data packet processing unit 808 includes an upper layer processing unit 809 which performs the process relating to the payload of a data packet, and a routing control unit 810 which determines the LD depending on the GD of a data packet (that is, determining the path for routing a data packet).

The path information storage unit 805 includes a link table 811 which stores the information relating to other communication devices adjacent to the communication device 800. The path information storage unit 805 further includes a routing table 812 which stores the information for determination of the LD of a data packet.

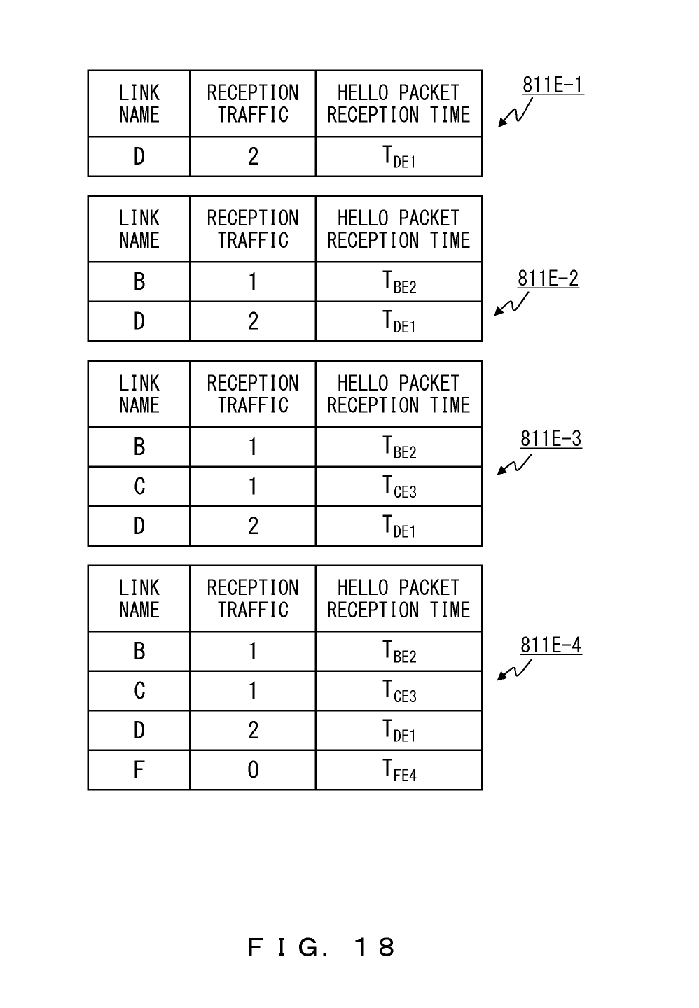

A concrete example of the link table 811 is described later with reference to FIG. 18. Since the routing table 812 has a format similar to that of a routing table 612D in FIG. 9, the detailed explanation is omitted here.

Additionally, the communication device 800 includes a transmission volume storage unit 813 which stores an expected value of the volume of the data packets generated by the communication device 800 itself in a specified period and addressed to the gateway GW1. For example, in the example in FIG. 16, the transmission volume storage unit 813 stores the value of “1”.

Then, the communication device 800 includes a hello packet processing unit 814 which performs the process relating to the transmission and reception of a hello packet. The hello packet processing unit 814 includes the notification reception unit 801 above. The hello packet processing unit 814 further includes a link management unit 815 which updates the link table 811 based on the received hello packet, and an existence notification unit 816 which periodically transmits a hello packet. The transmission volume notification unit 802 above is included in the existence notification unit 816.

When the communication device 800 is used in a wireless network, the communication device 800 may be realized by, for example, the communication device 200 in FIG. 2. For example, when the 802.15.4 PHY/MAC chip 205 receives a packet, the packet may be stored in the DRAM 203 as the buffer unit 807. Then, the MPU 201 may judge the type of the packet as the type judgment unit 806.

Otherwise, the 802.15.4 PHY/MAC chip 205 may be configured to judge the type of a packet as the type judgment unit 806 instead of the MPU 201. In this case, the 802.15.4 PHY/MAC chip 205 may output the entire packet to the MPU 201 if the received packet is a control packet. On the other hand, if the received packet is a data packet, the 802.15.4 PHY/MAC chip 205 may output only the header of the packet to the MPU 201, and store the entire packet including the header in the DRAM 203 as the buffer unit 807.

The MPU 201 may further perform various processes as the data packet processing unit 808. To realize the upper layer processing unit 809 in the data packet processing unit 808, the sensor 207 may be further used. The function of the data packet processing unit 808 which transmits a data packet may be realized by the MPU 201 and the 802.15.4 PHY/MAC chip 205.

The path information storage unit 805 and the transmission volume storage unit 813 may be realized by the DRAM 203 or the flash memory 204.

The bottleneck judgment unit 803 may also be realized by the MPU 201. The bottleneck notification unit 804 may be realized by the MPU 201 and the 802.15.4 PHY/MAC chip 205, but may also be realized by the MPU 201 and the 802.11b PHY/MAC chip 206.

Then, the hello packet processing unit 814 may be realized by the MPU 201. The existence notification unit 816 in the hello packet processing unit 814 may be realized by not only the MPU 201, but also the timer IC 202 and the 802.15.4 PHY/MAC chip 205.

On the other hand, when the communication device 800 is used in a cable network, the communication device 800 may be realized by, for example, the communication device 300 in FIG. 3. For example, when any of the physical ports 301a through 301d receives a packet, the packet may be output to the memory 305 or the memory 307 as the buffer unit 807 through a corresponding PHY chip (that is, any of the PHY chips 302a through 302d).

The type judgment unit 806 may be realized by the FPGA 303, and may be realized by the MPU 306. For example, the FPGA 303 may judge the type, the MPU 306 may process a packet only when the received packet is a data packet, and the FPGA 303 may process the packet when the received packet is a control packet.

The MPU 306 may perform various processes as the data packet processing unit 808. To realize the upper layer processing unit 809 in the data packet processing unit 808, the sensor 308 may further be used. The function of transmitting a data packet by the data packet processing unit 808 may be realized by the FPGA 303, the PHY chips 302a through 302d, and the physical ports 301a through 301d.

The path information storage unit 805 may be realized by the memory 305. In addition, the transmission volume storage unit 813 may be realized by the memory 307.

Then, the bottleneck judgment unit 803 may be realized by the MPU 306. The bottleneck notification unit 804 may be realized by the MPU 306, the FPGA 303, the PHY chips 302a through 302d, and the physical ports 301a through 301d.

Furthermore, the hello packet processing unit 814 may be realized by the FPGA 303. To realize the existence notification unit 816, the timer 304 in the FPGA 303 may be used. The existence notification unit 816 may be realized by not only the FPGA 303 but also the PHY chips 302a through 302d and the physical ports 301a through 301d.

FIG. 18 is an example of link tables according to the fourth embodiment. FIG. 18 illustrates four concrete examples of the link table 811. As illustrated in FIG. 18, each entry in the link table 811 includes fields of a “link name”, a “reception traffic”, and a “hello packet reception time”. That is, the format of the link table 811 is a format in which the traffic recognition time of the link table 611 according to the third embodiment is abbreviated.

Unlike the third embodiment, the value of the transmission traffic is embedded in a hello packet according to the fourth embodiment. Therefore, the hello packet reception time is equal to the traffic recognition time. Accordingly, it is not necessary for the link table 811 of the fourth embodiment to separately memorize both the hello packet reception time and the traffic recognition time. Therefore, the link table 811 includes no “traffic recognition time” field.

As a concrete example of the link table 811 including the above-mentioned three fields, FIG. 18 illustrates four examples, that is, the following (E1) through (E4).

(E1) A link table 811E-1 of the node E immediately after the node E receives the hello packet HD1

(E2) A link table 811E-2 of the node E immediately after the node E receives the hello packet HB1

(E3) A link table 811E-3 of the node E immediately after the node E receives the hello packet HC1

(E4) A link table 811E-4 of the node E immediately after the node E receives the hello packet HF1

The contents of the four link table 811E-1 through 811E-4 are described below with reference to FIG. 16.

Relating to FIG. 16, it is assumed as described above that the transmission traffic of “0” is set in the hello packet transmitted until the path becomes stable. Actually, when the communication device 800 receives a hello packet transmitted before the path becomes stable, an entry may be added to the link table 811 upon receipt of the hello packet. However, for convenience of explanation in FIG. 18, the entry added upon receipt of the hello packet before the path becomes stable is omitted.

As illustrated in FIG. 16, the node E receives from the node D the hello packet HD1 for which the node E is set as the selected LD. Then, the node E sets in the reception traffic field the value of “2” of the transmission traffic of the hello packet HD1 in the entry of the link table 811 in which the node D as the LS of the hello packet HD1 is specified as the link name. In addition, the node E sets in the hello packet reception time field the time T_{DE1} in which the hello packet HD1 is received in the entry.

Then, the node E receives the hello packet HB1 for which the node E is set as the selected LD as illustrated in FIG. 16. Then, the node E sets in the reception traffic field the value of “1” of the transmission traffic of the hello packet HB1 in the entry of the link table 811 in which the node B as the LS of the hello packet HB1 is specified as the link name. The node E also sets in the hello packet reception time field the time TQ_{BE2} at which the hello packet HB1 is received in the entry.

Afterwards, the node E receives the hello packet HC1 for which the node E is set as the selected LD as illustrated in FIG. 16. Then, the node E sets in the reception traffic field the value of “1” of the transmission traffic of the hello packet HC1 in the entry of the link table 811 in which the node C as the LS of the hello packet HC1 is specified as the link name. The node E sets in the hello packet reception time field the time T_{CE3} at which the hello packet HC1 is received in the entry.

Afterwards, the node E receives the hello packet HF1 for which the node H, not the node E, is set as the selected LD as illustrated in FIG. 16. In this case, the node E ignores the value of the transmission traffic of the hello packet HF1. That is, the node E sets to “0” the value of the reception traffic field in the entry of the link table 811 in which the node F as the LS of the hello packet HF1 is specified as the link name. The node E also sets in the hello packet reception time field the time T_{FE4} at which the hello packet HF1 is received in the entry.

As described above, the link table 811 of the node E is rewritten each time a hello packet is received as illustrated in FIG. 18.

Next, an example of a packet used in the fourth embodiment is described below with reference to FIG. 19. Also in the fourth embodiment, the general format of the packet 700 and the format of the ACK packet 730 are similar to those in the third embodiment in FIG. 10.

However, a data packet 740 in the fourth embodiment does not include a transmission traffic field unlike the data packet 710 in the third embodiment. A data packet 741 is a concrete example of the data packet 740.

For example, the LD and the LS of the data packet 741 refer to the nodes E and D respectively. In the data packet 741, the ID is the value of “3456”, and “Data” indicating a data packet is set as the type. Then, the GD and the GS of the data packet 741 respectively indicate the gateway GW1 and the node A. The payload of the data packet 741 may store any data. In the example in FIG. 19, the length of the payload is 250. Therefore, the value of “250” is set in the length field.

A hello packet 750 in the fourth embodiment includes two fields of “selected LD” and “transmission traffic” as a payload unlike the hello packet 720 in the third embodiment.

The hello packet 750 in the fourth embodiment is similar to the data packet 710 in the third embodiment in that they include a transmission traffic field, but only the hello packet 750 includes the selected LD field.

In the data packet 710 of the third embodiment, the LD field in the ad hoc header 701 itself indicates the LD (that is, the selected LD) when the data packet 710 is transmitted. Therefore, in the data packet 710, another field indicating the selected LD is not requested. Therefore, the data packet 710 includes no selected LD field.

On the other hand, the LD field in the ad hoc header 701 of the hello packet 750 does not refer to the LD when the data packet 740 is transmitted. Therefore, to obtain the accumulation of the transmission traffic along the path through which a data packet is actually transmitted, the hello packet 750 includes a selected LD field in addition to the LD field in the ad hoc header 701 of the hello packet 750. Then, the hello packet 750 indicates the LD used when the data packet 740 is transmitted by the selected LD field.

Concretely, for example, in the hello packet HE2 in FIG. 16, a special value indicating the broadcast in the 1-hop range is specified for the LD, and the node E is specified for the LS as illustrated in FIG. 19. Furthermore, in the hello packet HE2, the value of “8765” is set for the ID, and the value of “Hello” indicating a hello packet is set as the type.

Then, in the hello packet HE2, for the selected LD, the node F selected as the LD when the node E which transmits the hello packet HE2 transmits the data packet 740 addressed to the gateway GW1 is specified. Furthermore, as illustrated in FIG. 16, the value of the transmission traffic of the hello packet HE2 is “5”.

Depending on the embodiment, there may be a plurality of nodes which may be specified as the GD in the network. In this case, a hello packet in the format like a hello packet 760 may be used. The hello packet 760 is described later with reference to the eleventh embodiment.

The operation of the communication device 800 in FIG. 17 is described below with reference to some flowcharts. By using the communication device 800 which operates as described below as the nodes A through I in FIG. 4, a bottleneck may be detected or predicted as described above with reference to FIG. 16. The gateway GW1 includes at least the existence notification unit 816, but it may obviously further include a component in the communication device 800 other than the existence notification unit 816.

Like the communication device 600 in the third embodiment, the communication device 800 performs the process in FIG. 11. However, the details of the process in FIG. 11 are different in some points between the third and fourth embodiments. The main difference from the third embodiment is briefly described below.

In step S102, when the type judgment unit 806 judges that “the received packet 700 is the hello packet 750”, it outputs the hello packet 750 to the notification reception unit 801 and the link management unit 815 in the hello packet processing unit 814. Furthermore, when the type judgment unit 806 judges that “the received packet 700 is the data packet 740”, it notifies the routing control unit 810 of the reception of the data packet 740.

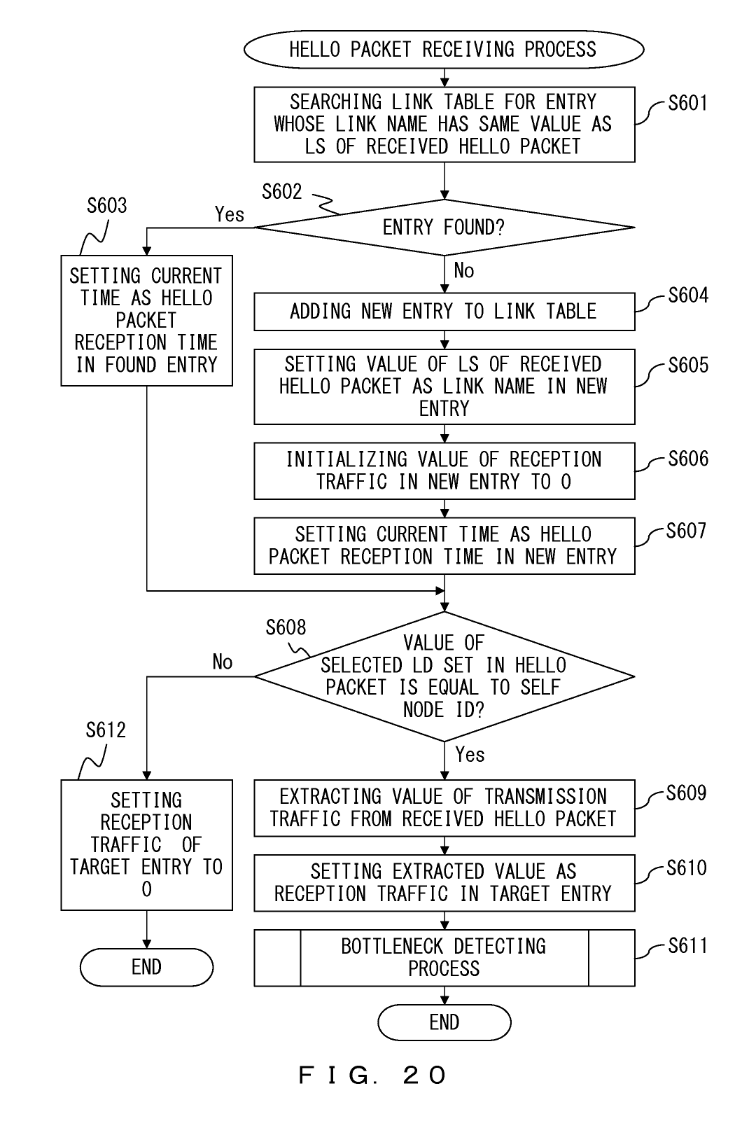

Furthermore, the hello packet receiving process in step S103 is illustrated in FIG. 20 in the fourth embodiment.

Then, the data packet receiving process in step S105 is concretely the process in which a part of the process in FIG. 12 is omitted in the fourth embodiment. That is, in the fourth embodiment, steps S204, S205, and S211 are omitted. Furthermore, in the fourth embodiment, the data packet processing unit 808 transmits the data packet 740 which does not include transmission traffic in step S212.

FIG. 20 is a flowchart of a hello packet receiving process performed in step S103 in FIG. 11 according to the fourth embodiment.

In step S601, the link management unit 815 searches the link table 811 for an entry whose link name has the same value as the LS of the received hello packet 750.

Then, in step S602, the link management unit 815 judges whether or not an entry has been found as a result of the search.

The case in which an entry is found is the case in which the communication device 800 receives the hello packet 750 from a known adjacent node. In this case, the process proceeds to step S603.

On the other hand, the case in which no entry is found, is the case in which the communication device 800 receives the hello packet 750 from an unknown new adjacent node. In this case, the process proceeds to step S604.

Then, the link management unit 815 sets the current time as the hello packet reception time in the found entry in step S603. The link management unit 815 also notifies the notification reception unit 801 of the found entry as the “target entry”. Then, the process proceeds to step S608.

On the other hand, the link management unit 815 adds the new entry to the link table 811 in step S604.

Then, in the next step S605, the link management unit 815 sets the value of the LS of the received hello packet 750 as the link name in the new entry.

Furthermore, in the next step S S606, the link management unit 815 initializes to “0” the value of the reception traffic in the new entry.

In addition, in the next step S607, the link management unit 815 sets the current time as the hello packet reception time in the new entry. Furthermore, the link management unit 815 notifies the notification reception unit 801 of the new entry added in step S804 as the “target entry”.

The order of executing steps S605 through S607 may be appropriately changed. After the execution of steps S605 through S607, the process proceeds to step S608.

In step S608, the notification reception unit 801 judges whether or not the value of the selected LD set in the received hello packet 750 is equal to the self node ID (that is, the node ID of the communication device 800 itself). If the value of the selected LD is equal to the node ID of the communication device 800 itself, the process proceeds to step S609. On the other hand, if the value of the selected LD is different from the node ID of the communication device 800 itself, the process proceeds to step S612.

In step S609, the notification reception unit 801 extracts the value of the transmission traffic from the received hello packet 750. For example, the notification reception unit 801 of the node F which has received the hello packet HE2 in FIG. 19 extracts the value of “5”.

Then, in the next step S610, the notification reception unit 801 sets the value extracted in step S609 as the reception traffic in the target entry notified from the link management unit 815.

Next, in step S611, the bottleneck detecting process similar to that in FIG. 14 is performed. In the fourth embodiment, the transmission volume notification unit 802, the bottleneck judgment unit 803, and the bottleneck notification unit 804 perform the bottleneck detecting process. When the bottleneck detecting process terminates, the hello packet receiving process also terminates.

On the other hand, in step S612, the notification reception unit 801 initializes to “0” the value of the reception traffic in the target entry. For example, when the network topology is changed due to the addition or deletion of a node, a part of the path may be changed depending on the change. Therefore, when a path changes, the notification reception unit 801 initializes to “0” the value of the reception traffic in the target entry in step S612 to perform the calculation of appropriate traffic depending on the change. When the initialization terminates, the hello packet receiving process also terminates.

The communication device 800 also performs some processes other than the process performed when the packet 700 is received as described above.

For example, the data packet processing unit 808 of the communication device 800 periodically or irregularly transmits the data packet 740 as the GS. Concretely, the data packet processing unit 808 performs the processes similar to those in FIG. 15. However, in the fourth embodiment, step S508 in FIG. 15 is omitted, and the data packet 740 which includes no transmission traffic is transmitted in step S513.

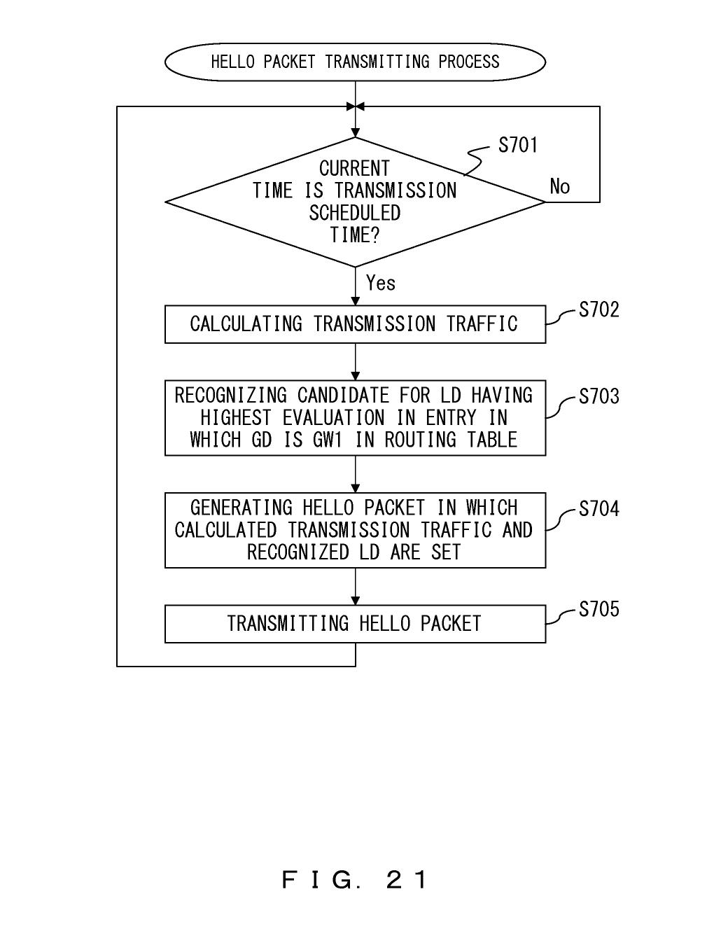

The existence notification unit 816 of the communication device 800 performs the process in FIG. 21. FIG. 21 is a flowchart of a hello packet transmitting process in the fourth embodiment.

In step S701, the existence notification unit 816 waits until the current time is the transmission schedule time of the hello packet 750. When the transmission schedule time of the hello packet 750 is reached, the process proceeds to step S702.

For example, it is preferable that the hello packet 750 is periodically transmitted. Therefore, for example, the timer IC 202 or the timer 304 may periodically output an interrupt signal at a specified interval. When the interrupt signal is output, the existence notification unit 816 recognizes that “the current time is the traffic schedule time of the hello packet 750”.

Then, in step S702, the transmission volume notification unit 802 calculates the value of the transmission traffic set in the hello packet 750 to be transmitted. Concretely, the transmission volume notification unit 802 calculates the value of the transmission traffic as with steps S401 through S405 in the bottleneck detecting process (refer to FIG. 14 for details) in step S611 in FIG. 20.

Furthermore, the transmission volume notification unit 802 refers to the routing table 812 in step S703. In the fourth embodiment, since only the gateway GW1 may be specified as the GD in the network 400, the transmission volume notification unit 802 searches the routing table 812 for an entry in which the value of the GD refers to the gateway GW1. Then, the transmission volume notification unit 802 recognizes a candidate for the LD having the highest evaluation (that is, the smallest evaluation value) in the entry found as a result of the search.

For example, the routing table 812 may have the same format as the routing table 612D in FIG. 9. In this case, up to three nodes may be registered in the routing table 812 as candidates for a selectable LD corresponding to the gateway GW1 as the GD.

Then, the transmission volume notification unit 802 recognizes a candidate having the highest evaluation in the candidates for a selectable LD. This recognition corresponds to the selection by the routing control unit 810. The routing control unit 810 first selects as the LD on the priority basis the candidate having the highest evaluation in transmitting the data packet 740 for which the gateway GW1 is specified as the GD.

Next, in step S704, the transmission volume notification unit 802 generates the hello packet 750 for which the transmission traffic calculated in step S702 and the LD recognized in step S703 (that is, the selected LD) are set.

In the ad hoc header 701 of the hello packet 750, the transmission volume notification unit 802 sets a particular value indicating a broadcast for the LD, and sets the node ID of the communication device 800 itself for the LS. Furthermore, the transmission volume notification unit 802 generates a new ID and sets it as the ID of the hello packet 750, and sets “Hello” as the type.

Then, in the next step S705, the transmission volume notification unit 802 transmits the hello packet 750 generated in step S704. Then, the process returns to step S701.

According to the fourth embodiment described above, each of the nodes A through I in the network 400 may autonomously detect or predict a bottleneck using the periodically transmitted hello packet 750. That is, since it is unnecessary to implement a dedicated control packet for prediction or detection of a bottleneck, only a small load is imposed on the network for prediction or detection of a bottleneck.

Next, the fifth embodiment in which a bottleneck is predicted or detected in accordance with a criterion different from that in the case in FIG. 14 is described. In the firth embodiment, the communication device 600 in FIG. 7 includes the bottleneck judgment unit 502 in FIG. 5 instead of the transmission volume notification unit 602 and the bottleneck judgment unit 603, and includes the reception bottleneck notification unit 503 instead of the bottleneck notification unit 604. Then, in the fifth embodiment, a bottleneck is predicted or detected based on the volume of the reception traffic, not based on the volume of the transmission traffic.

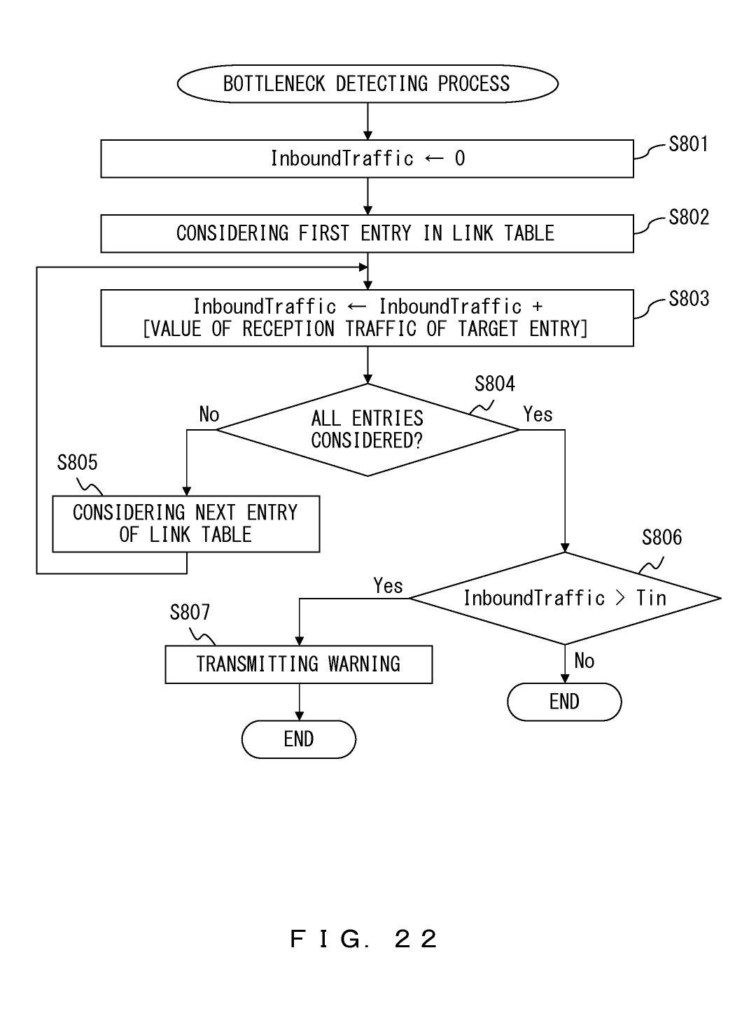

FIG. 22 is a flowchart of a bottleneck detecting process in the fifth embodiment. Since the fifth embodiment is similar to the third embodiment except the bottleneck detecting process, the detailed description is omitted here.

In step S801, the bottleneck judgment unit 502 initializes to “0” the variable InboundTraffic indicating the volume of the reception traffic.

In the next step S802, the bottleneck judgment unit 502 considers (i.e., focuses on) the first entry in the link table 611. The entry currently considered may be referred to as a “target entry”. Then, the process proceeds to step S803.

In step S803, the bottleneck judgment unit 502 calculates a sum of the value of the variable InboundTraffic and the value of the reception traffic of the entry considered on the link table 611, and substitutes the calculation result for the variable InboundTraffic.

Then, in the next step S804, the bottleneck judgment unit 502 judges whether or not all entries in the link table 611 have been completely considered. If there is any entry remaining unconsidered by the bottleneck judgment unit 502, the process proceeds to step S805. On the other hand, if the bottleneck judgment unit 502 has already completed considering all entries, the process proceeds to step S806.

In step S805, the bottleneck judgment unit 502 considers the next entry in the link table 611. Then, the process returns to step S803.

On the other hand, the bottleneck judgment unit 502 compares the value of the variable InboundTraffic with a specified threshold Tin in step S806.

If the value of the variable InboundTraffic is larger than the threshold Tin, the bottleneck judgment unit 502 judges that “the communication device 600 is a bottleneck”, and notifies the reception bottleneck notification unit 503 of the judgment result. Then, the process proceeds to step S807.

On the other hand, when the value of the variable InboundTraffic is equal to or smaller than the threshold Tin, the bottleneck judgment unit 502 judges that “the communication device 600 is not a bottleneck”. Then, the bottleneck detecting process terminates.

In step S807, upon receipt of the notification from the bottleneck judgment unit 502, the reception bottleneck notification unit 503 transmits a warning (that is, a bottleneck notification). Since the details of step S807 are similar to those in step S407 in FIG. 14, the description is omitted here.

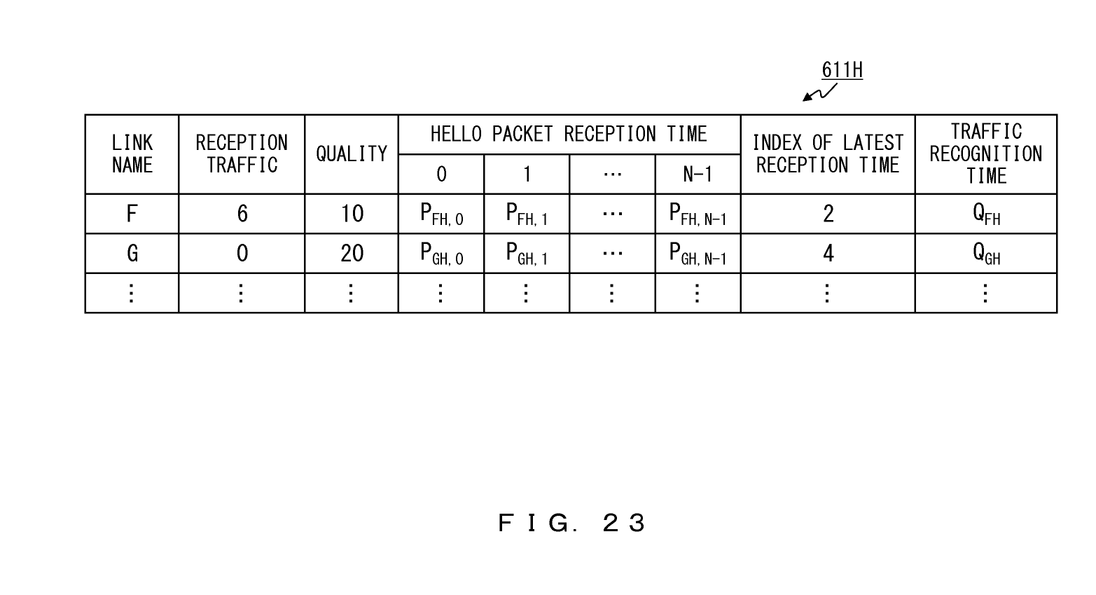

Then, the sixth embodiment in which a bottleneck is predicted or detected in accordance with a criterion different from those in FIGS. 14 and 22 is described below with reference to FIGS. 23 through 25 mainly relating to the difference from the third embodiment. Concretely, in the sixth embodiment, a judgment is made based on the “weighted number of transmission paths” described above with reference to the first embodiment.

The weight used in the calculation of the weighted number of transmission paths may be any value so far as the weight reflects the quality of a link. The criterion for measuring the quality of a link depends on the embodiments.

For example, in the sixth embodiment, the fluctuation of the reception interval of the hello packet 720 is used as the criterion for measuring the quality of a link. Therefore, in the sixth embodiment, the format of a link table is different from that in the third embodiment, and the details of the hello packet receiving process in step S103 in FIG. 11 are different from those in the third embodiment.

FIG. 23 is an example of a link table according to the sixth embodiment. Concretely, the link table 611H in FIG. 23 is the link table 611 in the node H after receiving the data packet D6F in the timing chart in FIG. 6.

As compared with the link tables 611D-1 and 611E-1 through 611E-3 in FIG. 8 in the third embodiment, the link table 611H in FIG. 23 includes newly added fields of “quality” and “latest reception time index”. In addition, the link table 611H includes not one but a plurality of (N concretely) hello packet reception time fields.

The quality field indicates the quality of a link between the adjacent nodes identified by the link name. The value of the quality is calculated based on the fluctuation of (N−1) reception intervals obtained from N pieces of hello packet reception time information.

Furthermore, N pieces of hello packet reception time information are associated with indexes 0 through (N−1), and stored in the same format as the ring buffer. The latest reception time index functions as a pointer in the ring buffer.

For example, assume that N is 20 (N=20), and that the value of the latest reception time index is “2”. In this case, the latest time information in the 20 stored pieces of hello packet reception time information refers to the time associated with the index of “2”. Then, the second latest time information refers to the time associated with the index of “1”, the third latest time information refers to the time associated with the index of “0”, and the fourth latest time information refers to the time associated with the index of “19”. The oldest time information refers to the time associated with the index of “3”.

As entries in the link table 611H in the above-mentioned format, FIG. 23 concretely exemplifies the following two entries.

In the first entry, the link name indicates the node F, and the value of the reception traffic is the value of “6” set as the transmission traffic in the data packets D6F and D8F. In addition, the value of the quality is “10”. Each index j (0≦j≦N−1) is associated with the hello packet reception time P_{FH, j}, and the value of the latest reception time index is “2”. The traffic recognition time is Q_{FH}.

In the second entry, the link name indicates the node G. Since the node H is not specified as the LD by the node G, the value of the reception traffic is “0”. Then, the value of the quality is “20”. Each index j (0≦j≦N−1) is associated with the hello packet reception time P_{GH, j}, and the value of the latest reception time index is “4”. The traffic recognition time is Q_{GH}.

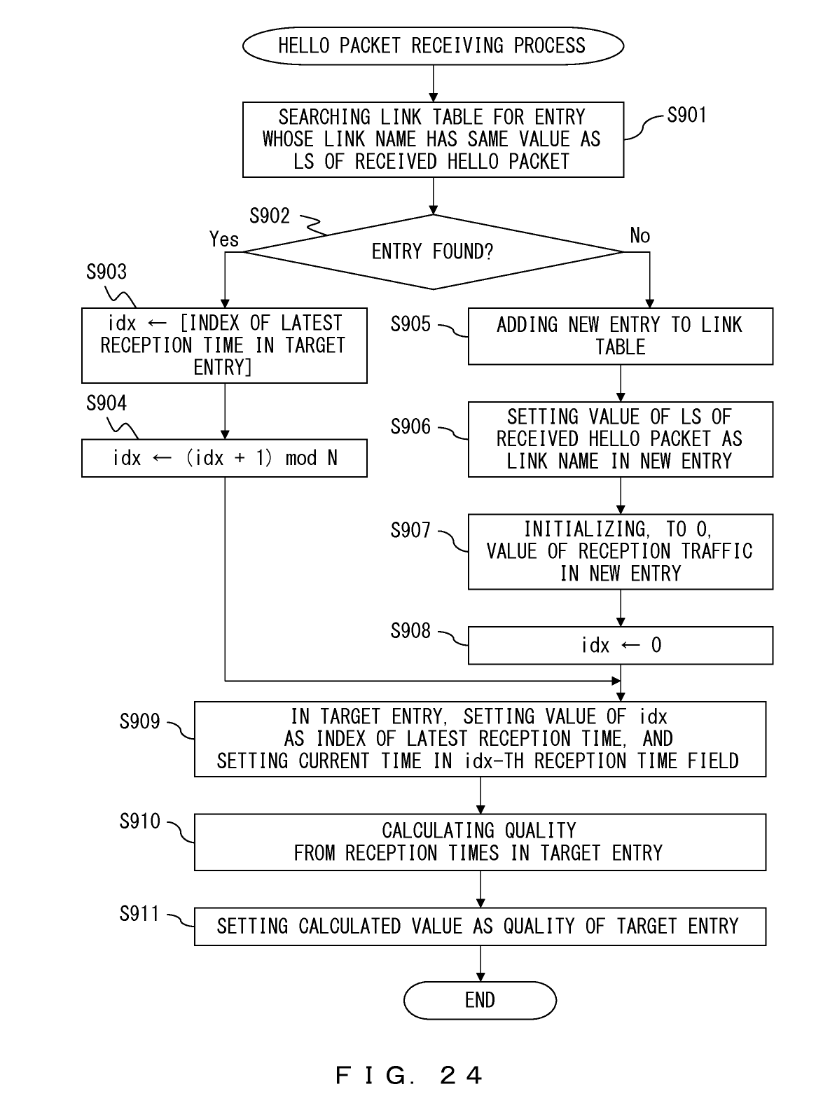

FIG. 24 is a flowchart of a hello packet receiving process in the sixth embodiment. The hello packet receiving process is performed in step S103 in FIG. 11. For convenience of explanation below, the node H including the link table 611H in FIG. 23 is considered as an example of the communication device 600 according to the sixth embodiment, and the process in FIG. 24 is described.

In step S901, the link management unit 615 searches the link table 611H for an entry whose link name has the value equal to the LS in the received hello packet 720.

Then, in step S902, the link management unit 615 judges whether or not the entry has been found as a result of the search.

The case in which an entry is found is the case in which the communication device 600 (for example, node H) receives the hello packet 720 from a known adjacent node. In this case, the process proceeds to step S903.

On the other hand, the case in which no entry is found is the case in which the communication device 600 receives the hello packet 720 from an unknown new adjacent node. In this case, the process proceeds to step S905.

Then, in step S903, the link management unit 615 substitutes the value of the latest reception time index in the found entry for the variable idx.

In the next step S904, the link management unit 615 calculates the remainder by dividing the value obtained by adding 1 to the variable idx by N, and substitutes the calculation result for the variable idx. Then, the process proceeds to step S909.

For example, when the LS of the received hello packet 720 indicates the node F, the value of the latest reception time index in the first entry in which the link name indicates the node F is 2 according to FIG. 23. Therefore, in step S904, the remainder obtained by dividing 3(=2+1) by N is calculated.

On the other hand, the link management unit 615 adds a new entry to the link table 611H in step S905. The value of each field of the new entry in the initial state is an invalid value such as null.

In the next step S906, the link management unit 615 set the value of the LS of the received hello packet 720 as the link name in the new entry

Furthermore, in the next step S907, the link management unit 615 initializes to “0” the value of the reception traffic in the new entry.

In the next step S908, the link management unit 615 substitutes “0” as the initial value for the variable idx. Then, the process proceeds to step S909.

For convenience of explanation below, the entry found as a result of the search in step S901 or added in step S905 is referred to as a “target entry”. In step S909, the link management unit 615 sets the value of the variable idx as the latest reception time index in the target entry. The link management unit 615 also sets the current time in the idx-th hello packet reception time field in the target entry.

Then, in the next step S910, the link management unit 615 calculates the quality from the hello packet reception times in the target entry.

For example, for convenience of explanation below, the calculation in step S910 is described below by assuming that N is 20 (N=20), and the LS of the received hello packet 720 indicates the node F. The calculation in step S910 may be concretely performed in the following three cases.

The first case is that the value of the latest reception time index is 0, and the hello packet reception time associated with each index from 1 to (N−1) is still an invalid value. That is, the first case is the case in which the node H has only once received the hello packet 720 from the node F, that is, the case in which a new entry has been added in step S905.

Therefore, in the first case, the reception interval of the hello packet 720 is not defined. Therefore, the link management unit 615 obtains a specified constant value as the value of the quality in step S910. The constant value may be, for example, the value of the quality expected on average based on the result of a preliminary experiment etc.

The second case is the case in which there is no invalid value in the hello packet reception time associated with the index from 0 to (N−1). That is, the second case is the case in which the node H has already received N or more hello packets 720 from the node F. In the second case, (N−1) reception intervals are defined from N hello packet reception times recorded in the target entry.

For convenience of explanation below, it is assumed that the oldest time in N pieces of hello packet reception time information is expressed as “t₀”, and the latest time is expressed as “t_{N-1}”. For example, when the latest reception time index is 2, the hello packet reception time associated with the index of “3” refers to the time tₒ, and the hello packet reception time associated with the index of “2” refers to the time t_{N-1}.

Then, the average μ of (N−1) reception intervals is expressed by the equation (1), and the standard deviation σ of (N−1) reception intervals is expressed by the equation (2).

$$\begin{matrix}μ = \frac{1}{N - 1} {\sum }_{j = 0}^{N - 2} ( {t}_{j + 1} - {t}_{j} ) & ( 1 ) \\ \begin{matrix}σ = \sqrt{\frac{1}{N - 1} {\sum }_{j = 0}^{N - 2} {( {t}_{j + 1} - {t}_{j} - μ )}^{2}} \\ = \sqrt{\{ \frac{1}{N - 1} {\sum }_{j = 0}^{N - 2} {( {t}_{j + 1} - {t}_{j} )}^{2} \} - {μ}^{2}}\end{matrix} & ( 2 )\end{matrix}$$

The link management unit 615 may obtain the standard deviation σ of the equation (2) as the value of quality. Otherwise, the link management unit 615 may obtain the value expressed as the function of the standard deviation 6 as the value of quality. That is, in the sixth embodiment, the smaller the value of quality, the better the quality is.

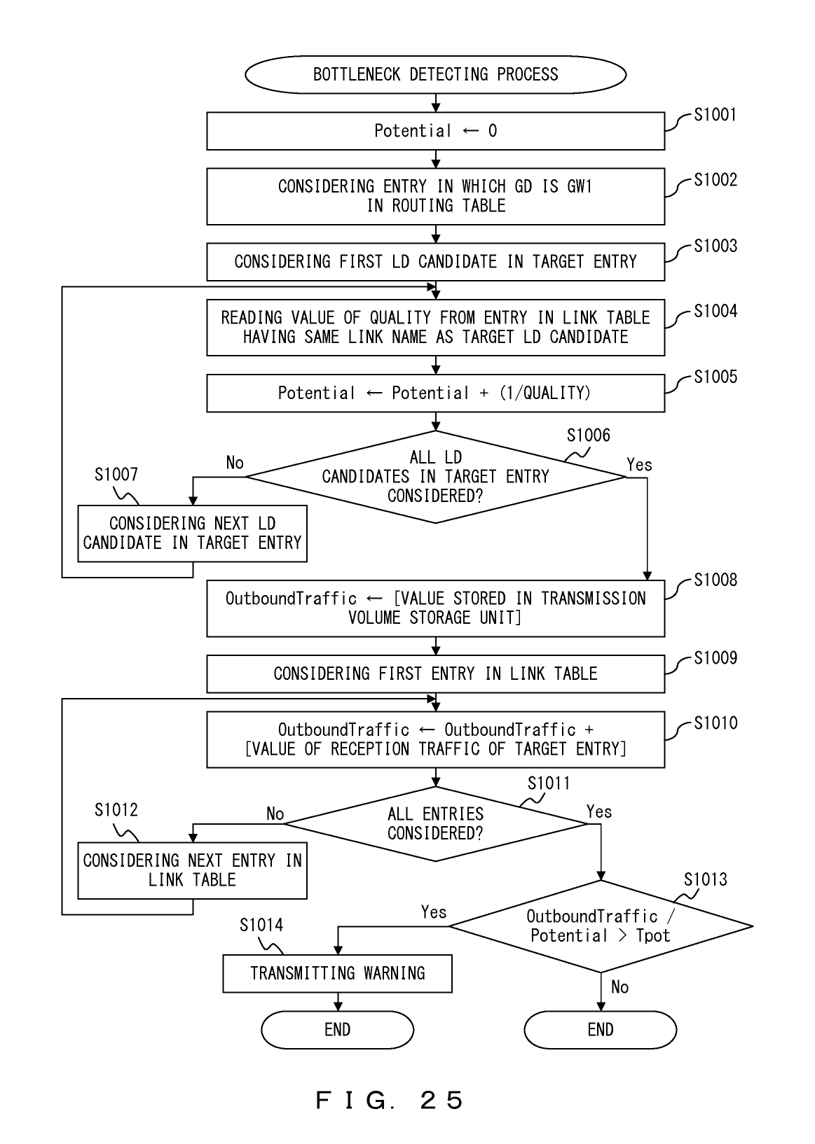

For example, in step S1005 in FIG. 25 described later, the value of quality is used as a divisor. Then, to avoid the value of quality of zero, the link management unit 615 may obtain a result (σ+α) obtained by adding a specified small constant value α to the standard deviation σ as the value of quality in step S910. Otherwise, the link management unit 615 may obtain an appropriate value such as the value (βσ+α) calculated using a specified constant values α and β expressed as the function of the standard deviation σ as the value of quality.

Furthermore, depending on the embodiments, the existence notification unit 616 may transmit a hello packet having a payload unlike the hello packet 720 having no payload. Concretely, the existence notification unit 616 may store the value of the above-mentioned standard deviation σ (or the value of quality) calculated by the link management unit 615 in the payload of a hello packet as associated with the link name.

Then, the link management unit 615 may calculate the value of quality using the value associated with the node ID of the communication device 600 itself in the payload of the received hello packet together with the standard deviation σ calculated by the link management unit 615 itself as described above. Then, two communication devices 600 adjacent through a link may obtain the same value with the bidirectional quality taken into account about the same link.

The third case relating to the calculation in step S910 is the case in which there is an invalid value in the hello packet reception time associated with the indexes from 0 to (N−1) and two or more valid values. That is, the third case is the case in which there are two or more, and less than N hello packets 720 received by the node H from the node F.

In the third case, at least one or more reception intervals are defined. Therefore, the link management unit 615 calculates the value of quality in step S910 by performing the calculation similar to that in the second case using all definable reception intervals.

Finally, in step S911, the notification reception unit 601 sets the value calculated in step S910 as the quality of the target entry.

FIG. 25 is a flowchart of a bottleneck detecting process in the sixth embodiment. The bottleneck detecting process is performed in step S205 in the data packet receiving process in FIG. 12 corresponding to step S105 in FIG. 11.

In step S1001, the transmission volume notification unit 602 initializes to “0” the value of the variable Potential indicating the weighted number of transmission paths (that is, the potential transmission capacity of the communication device 600).

Then, in the next step S1002, the transmission volume notification unit 602 considers (i.e., focuses on) the entry in which the gateway GW1 is specified as the GD in the routing table 612. The entry currently considered may be referred to as a “target entry”.

Furthermore, in the next step S1003, the transmission volume notification unit 602 considers (i.e., focuses on) the first candidate for the LD in the target entry. Then, the process proceeds to step S1004. The candidate currently considered may be referred to as a “target LD candidate”.

In step S1004, the transmission volume notification unit 602 reads the value of quality from the entry in the link table 611H having the link name equal to the target LD candidate.

Then, in step S1005, the transmission volume notification unit 602 adds the inverse of the value of quality read in step S1004 to the value of variable Potential, and substitutes the obtained sum newly for the variable Potential.

Furthermore, in the next step S1006, the transmission volume notification unit 602 judges whether or not all candidates for the LD in the target entry of the routing table 612 have been considered.

For example, assume that the routing table 612 has the format in which up to three candidates for the LD may be registered like the routing table 612D in FIG. 9. In this case, the “all candidates for the LD in the target entry” refer to all candidates for which a valid value is specified as the node ID in the first through third candidates.

Then, when there is a remaining candidate for the LD which has not been considered by the transmission volume notification unit 602 in the target entry of the routing table 612, the process proceeds to step S1007. On the other hand, if the transmission volume notification unit 602 has completely considered all candidates for the LD in the target entry of the routing table 612, the process proceeds to step S1008. The value of the variable Potential at the time when the process proceeds to step S1008 indicates the weighted number of transmission paths.

In step S1007, the transmission volume notification unit 602 considers the next candidate for the LD in the target entry of the routing table 612. Then, the process returns to step S1004.

On the other hand, in step S1008, the transmission volume notification unit 602 substitutes the value stored in the transmission volume storage unit 613 for the variable OutboundTraffic indicating the volume of the transmission traffic.

In the next step S1009, the transmission volume notification unit 602 considers (i.e., focuses on) the first entry of the link table 611H. Next, the process proceeds to step S1010. The entry currently considered may be referred to as a “target entry”.

In step S1010, the transmission volume notification unit 602 calculates the sum of the value of the variable OutboundTraffic and the value of the reception traffic of the entry considered in the link table 611H, and substitutes the calculation result for the variable OutboundTraffic.

Then, in the next step S1011, the transmission volume notification unit 602 judges whether or not all entries of the link table 611H have completely considered. If there is still an entry not considered by the transmission volume notification unit 602, the process proceeds to step S1012. On the other hand, if all entries have been considered by the transmission volume notification unit 602, the process proceeds to step S1013.

In step S1012, the transmission volume notification unit 602 considers the next entry of the link table 611H. Then, the process returns to step S1010.

On the other hand, in step S1013, the transmission volume notification unit 602 divides the value of the variable OutboundTraffic by the value of the variable Potential, and the obtained quotient is reported to the bottleneck judgment unit 603. Then, the bottleneck judgment unit 603 compares the notified value with a specified threshold Tpot.

When the value of the above-mentioned quotient is larger than the threshold Tpot, the bottleneck judgment unit 603 judges that “the communication device 600 is a bottleneck”, and notifies the bottleneck notification unit 604 of the judgment result. Then, the process proceeds to step S1014.

On the other hand, when the value of the above-mentioned quotient is equal to or smaller than the threshold Tpot, the bottleneck judgment unit 603 judges that “the communication device 600 is not a bottleneck”. Then, the bottleneck detecting process terminates.

In step S1014, upon receipt of the notification from the bottleneck judgment unit 603, the bottleneck notification unit 604 transmits a warning (that is, the bottleneck notification). The details of the transmission in step S1014 may be variable depending on the embodiments. Since the details of step S1014 are similar to those in step S407 in FIG. 14, the description is omitted here.

According to the sixth embodiment described above, a bottleneck is predicted or detected based on the potentially transmittable volume and the transmission traffic. Therefore, in the sixth embodiment, the evaluation of the risk that the communication device 600 is a bottleneck depending on the change of the network topology which may be potentially generated is performed. Described below is a concrete example of a calculation in the sixth embodiment.

For example, in the network 400 in FIG. 4, the expected value of the volume of the data generated by each of the nodes A through I in a specified period and addressed to the gateway GW1 is set to “1”. If the path is constructed as illustrated in FIG. 4, the transmission traffic calculated as the value of the variable OutboundTraffic by each of the nodes A through I is described as follows.

The transmission traffic of the node A is “1”. The transmission traffic of the node B is “1”. The transmission traffic of the node C is also “1”.

Then, the transmission traffic of the node D which relays the data packet 710 transmitted from the node A is “2”. The transmission traffic of the node E which relays the data packet 710 transmitted from the nodes B, C, and D is “5”.

The transmission traffic of the node F which relays the data packet 710 transmitted from the node E is “6”. On the other hand, the transmission traffic of the node G is “1”.

Furthermore, the transmission traffic of the node H which relays the data packet 710 transmitted from the node F is “7”. On the other hand, the transmission traffic of the node I is “1”.

For convenience of explanation below, it is assumed that two adjacent communication devices 600 adjacent through a link calculate the same value as the value of quality for the same link. Then, for example, the value of the quality of each link is described below.

It is assumed that the quality of the link between the nodes A and B, and between the nodes B and C is “40”. It is also assumed that the quality of the link between the nodes A and D, between the nodes B and D, between the nodes B and E, and between the nodes C and E is “30”. Then, it is assumed that the quality of the link between the nodes D and E is “20”, and the quality of the link between the nodes E and F is “10”.

Furthermore, it is assumed that the quality of the link between the nodes F and H, and between the node H and the gateway GW1 is “10”. It is assumed that the quality of the link between the nodes F and G, between the nodes F and I, between the nodes G and H, between the node G and the gateway GW1, between the nodes H and I, and between the node I and the gateway GW1 is “20”.

Additionally, it is assumed that the above-mentioned threshold Tpot (that is, the upper limit of the transmission traffic per weighted number of transmission paths) in FIG. 25 is “40”. Then, for example, the node E detects a bottleneck, and no bottleneck is detected in other nodes as described below.

For example, assume that the node A not only memorizes the node D as the first candidate for the LD, but also memorizes the node B as the second candidate for the LD. Then, the weighted number of transmission paths in the node A is about 0.06 (= 1/30+ 1/40).

Therefore, in step S1013, the value of about 17 is obtained by dividing the transmission traffic of “1” by the weighted number of transmission paths. Since the obtained value is equal to or smaller than the threshold Tpot, no bottleneck notification is transmitted from the node A.

In addition, it is assumed that the node B not only memorizes the node E as the first candidate for the LD, but also memorizes the nodes C and D as the second and third candidates for the LD respectively. Then, the weighted number of transmission paths in the node B is about 0.09 (= 1/30+ 1/40+ 1/30).

Therefore, in step S1013, the value of about 11 is obtained by dividing the transmission traffic of “1” by the weighted number of transmission paths. Since the obtained value is equal to or smaller than the threshold Tpot, no bottleneck notification is transmitted from the node B.

Then, assume that the node C not only memorizes the node E as the first candidate for the LD, but also memorizes the node B as the second candidate for the LD. Then, the weighted number of transmission paths in the node C is about 0.06 (= 1/30+ 1/40).

Therefore, in step S1013, the value of about 17 is obtained by dividing the transmission traffic of “1” by the weighted number of transmission paths. Since the obtained value is equal to or smaller than the threshold Tpot, no bottleneck notification is transmitted from the node C.

In addition, it is assumed that the node D not only memorizes the node E as the first candidate for the LD, but also memorizes the node B as the second candidate for the LD. Then, the weighted number of transmission paths in the node D is about 0.08 (= 1/20+ 1/30).

Therefore, in step S1013, the value of 24 is obtained by dividing the transmission traffic of “2” by the weighted number of transmission paths. Since the obtained value is equal to or smaller than the threshold Tpot, no bottleneck notification is transmitted from the node D.

It is assumed that the node E memorizes the node F as the first candidate for the LD, but does not memorize the second and third candidates. Then, the weighted number of transmission paths in the node E is 0.1 (= 1/10).

Therefore, in step S1013, the value of 50 is obtained by dividing the transmission traffic of “5” by the weighted number of transmission paths. Since the obtained value is larger than the threshold Tpot, a bottleneck notification is transmitted from the node E.

In addition, it is assumed that the node F not only memorizes the node H as the first candidate for the LD, but also memorizes the nodes G and I as the second and third candidates respectively for the LD. Then, the weighted number of transmission paths in the node F is 0.2 (= 1/10+ 1/20+ 1/20).

Therefore, in step S1013, the value of 30 is obtained by dividing the transmission traffic of “6” by the weighted number of transmission paths. Since the obtained value is equal to or smaller than the threshold Tpot, no bottleneck notification is transmitted from the node F.

Then, assume that the node G not only memorizes the gateway GW1 as the first candidate for the LD, but also memorizes the node H as the second candidate for the LD. The weighted number of transmission paths in the node G is 0.1 (= 1/20+ 1/20).

Therefore, in step S1013, the value of 10 is obtained by dividing the transmission traffic of “1” by the weighted number of transmission paths. Since the obtained value is equal to or smaller than the threshold Tpot, no bottleneck notification is transmitted from the node G.

In addition, it is assumed that the node H not only memorizes the gateway GW1 as the first candidate for the LD, but also memorizes the nodes G and I as the second and third candidates respectively for the LD. Then, the weighted number of transmission paths in the node H is 0.2 (= 1/10+ 1/20+ 1/20).

Therefore, in step S1013, the value of 35 is obtained by dividing the transmission traffic of “7” by the weighted number of transmission paths. Since the obtained value is equal to or smaller than the threshold Tpot, no bottleneck notification is transmitted from the node H.

Then, assume that the node I not only memorizes the gateway GW1 as the first candidate for the LD, but also memorizes the node H as the second candidate for the LD. The weighted number of transmission paths in the node I is 0.1 (= 1/20+ 1/20).

Therefore, in step S1013, the value of 10 is obtained by dividing the transmission traffic of “1” by the weighted number of transmission paths. Since the obtained value is equal to or smaller than the threshold Tpot, no bottleneck notification is transmitted from the node I.

Described next is the seventh embodiment. In the first through sixth embodiments, a single condition is used in detecting or predicting a bottleneck, but a combination of a plurality of conditions may be used in detecting or predicting a bottleneck. For example, any combination of two or more of the following conditions (F1) through (F8) may be available.

(F1) The volume of the reception traffic per unit time exceeds a threshold. This condition is used in the second and fifth embodiments. For example, the total sum InboundTraffic of the reception traffic from each LS exceeds the threshold Tin.

(F2) The volume of the transmission traffic per unit time exceeds a threshold. This condition is used in the first, third, and fourth embodiments. For example, the value OuntboundTraffic obtained by adding the value stored in the transmission volume storage unit 613 or 813 to the total sum of the reception traffic from each LS exceeds the threshold Tout.

(F3) The value obtained by dividing the volume of the transmission traffic per unit time by the weighted number of transmission paths exceeds a threshold. This condition is used in the sixth embodiment. That is, the expression of “OuntboundTraffic/Potential>Tpot” holds true.

(F4) The number of data packets received by a communication device per unit time exceeds a threshold. Regardless of a wireless communication or a wired communication, an overhead arises in header processing in a packet communication. In the wireless communication, the overhead of a waiting time (for example, a carrier sense time, a back off time, etc.) according to CSMA/CA (carrier sense multiple access/collision avoidance) is relatively large. Therefore, especially in the wireless communication, not only the volume of the data packets (that is, the length of data packets), but also the number of data packets are useful indexes for measurement of the load. Therefore, the conditions of (F4) and (F5) below may be used in detecting or predicting a bottleneck.

(F5) The number of data packets to be transmitted by a communication device per unit time exceeds a threshold. That is, a sum of the number of data packets that a communication device has practically and successfully transmitted and the number of data packets that the communication device has failed to transmit after the communication device attempted to transmit them (due to any reason such as a collision etc.) exceeds a threshold.

(F6) A certain value is calculated for each LS based on the volume of the reception traffic per unit time from the LS concerned and also based on the quality of the link to the LS concerned, the values thus calculated for all LSs are added, and the total sum of the thus calculated values exceeds a threshold. For example, the total sum for all LS obtained by adding the values each obtained by dividing the volume of the reception traffic from the LS concerned by the inverse of the quality of the link to the LS concerned exceeds a threshold.

(F7) The value calculated based on the volume of the transmission traffic per unit time and the quality of the link to the LD exceeds a threshold. For example, the value obtained by dividing the value of the variable OutboundTraffic by the inverse of the quality of the link to the LD exceeds a specified threshold. The condition (F7) corresponds to the condition (F3) when the sixth embodiment is modified so that the value of the variable Potential is calculated by considering only the candidate for the LD having the highest evaluation instead of calculating the value of the variable Potential by considering all candidates for the LD.

(F8) The value obtain by subtracting the number of data packets transmitted by a communication device per unit time from the number of data packets received by the communication device per unit time exceeds a threshold. Depending on the state of the link, it may take a long time to successfully forward a data packet after the communication device receives the data packet. As a result, the usage of the buffer unit 607 or buffer unit 807 may increase only and not decrease. Then, a buffer overflow may occur eventually. That is, there is a high probability that the communication device for which the condition (F8) is satisfied may be a bottleneck.

Various conditions obtained by arbitrarily combining all or a part of the conditions (F1) through (F8) are available in predicting or detecting a bottleneck. For example, the conditions such as “the condition (F2) or (F3) is satisfied”, “at least one of the conditions (F1) through (F8) is satisfied”, “‘(F1) or (F4)’ and ‘(F2) or (F5)’ are satisfied”, etc. are available.

Furthermore, relating to the conditions (F1) through (F8), two or more thresholds may be used for a judgment instead of the judgment by comparison with one threshold. For example, in the description of an example of the condition (F2), the bottleneck judgment unit 603 or 803 may judge to which of the following ranges (G1) through (G3) the value of the transmission traffic belongs:

(G1) equal to or smaller than the first threshold

(G2) larger than the first threshold, and equal to or smaller than the second threshold

(G3) larger than the second threshold

Then, the bottleneck judgment unit 603 or 803 may judge as “no problem” if the value of the transmission traffic belongs to the range (G1). In this case, the bottleneck notification unit 604 or 804 does not transmit a bottleneck notification.

In addition, the bottleneck judgment unit 603 or 803 may judge as “caution” if the value of the transmission traffic belongs to the range (G2). In this case, the bottleneck notification unit 604 or 804 transmits a bottleneck notification including particular information reporting that “it is preferable to monitor the communication device 600 or 800 because the communication device 600 or 800 may be a bottleneck”. The above-mentioned particular information may be simply expressed by a numeral such as “warning level=1” etc.

Furthermore, the bottleneck judgment unit 603 or 803 may judge as a bottleneck if the value of the transmission traffic belongs to the range (G3). In this case, the bottleneck notification unit 604 or 804 transmits a bottleneck notification including the particular information reporting that “the communication device 600 or 800 is a bottleneck”. The above-mentioned particular information may be simply expressed by a numeral such as “warning level=2” etc.

Furthermore, when a plurality of thresholds are used for one condition as described above, the bottleneck judgment unit 603 or 803 may judge the tendency of the judgment result from the history of the judgment, and consider the change of the judgment result. For example, the bottleneck judgment unit 603 or bottleneck judgment unit 803 may request the bottleneck notification unit 604 or 804 to transmit a bottleneck notification when the bottleneck judgment unit 603 or 803 judges that “the load of the communication device 600 or 800 is inclined to be gradually worse”.

Otherwise, when the bottleneck judgment unit 603 or 803 obtains only once the judgment result that “the value of the transmission traffic belongs to the range (G2)”, the bottleneck judgment unit 603 or 803 may still suppress requesting the bottleneck notification unit 604 or 804 to transmit a bottleneck notification. If the judgment result that “the value of the transmission traffic belongs to the range (G2)” is continuously obtained over a specified number of times, the bottleneck judgment unit 603 or 803 may request the bottleneck notification unit 604 or 804 to transmit a bottleneck notification.

Described next is the eighth embodiment. In the eighth embodiment, the bottleneck detecting process is not constantly performed, but is performed in a particular case.

For example, the communication device 600 in the third embodiment performs the bottleneck detecting process each time it receives the data packet 710, and the communication device 800 of the fourth embodiment performs the bottleneck detecting process each time it receives the hello packet 750. Thus, in each of the above-mentioned embodiments, the bottleneck detecting process is constantly performed. However, if the volume of the traffic on the network is stable, and the path is also stable, then the constant bottleneck detecting process is not necessarily requested.

According to the eighth embodiment, the bottleneck detecting process is not constantly performed to reduce the process load of each node imposed by performing the bottleneck detecting process. Concretely, each node normally operates in “the normal mode” in which the bottleneck detecting process and other processes relating to the bottleneck detecting process are omitted. Then, each node operates in “the detection mode” in which the bottleneck detecting process and other processes relating to the bottleneck detecting process are performed only when a particular condition is satisfied.

In the normal mode, for example, the bottleneck detecting process corresponding to step S205 in FIG. 12 or step S611 in FIG. 20 is omitted. Furthermore, in the normal mode, for example, other processes relating to the bottleneck detecting process such as the following (H1) through (H4) are also omitted.

(H1) steps S204 and S211 in FIG. 12

(H2) calculation of the transmission traffic in step S508 in FIG. 15

(H3) steps S608 through S610 and S612 in FIG. 20

(H4) steps S702 and S703 in FIG. 21

In the embodiment in which the transmission traffic is embedded in a data packet, a transmission traffic field may be omitted in a data packet transmitted in the normal mode. Otherwise, a particular constant such as “−1” may be set in the transmission traffic field.

In the embodiment in which the transmission traffic is embedded in a hello packet, the transmission traffic field and the selected LD field may be omitted in a hello packet transmitted in the normal mode. Otherwise, a particular constant may be set in both fields.

Furthermore, in the eights embodiment, the normal mode and the detection mode may be switched by a specified schedule, or by a particular control packet flooding in the entire network.

For example, a schedule such as “the operation is performed in the detection mode only from 3:00 to 3:15, and is performed in the normal mode in other periods every day” may be set in each of the nodes A through I in the network 400 in FIG. 4. Then, each of the nodes A through I may switch the operation mode according to the schedule.

Otherwise, a particular control packet such as “a detection start instruction packet” for an instruction to switch from the normal mode to the detection mode, “a detection terminate instruction packet” for an instruction to switch from the detection mode to the normal mode, etc. may be used.

For example, each of the nodes A through I operates in the normal mode until receiving the detection start instruction packet which is transmitted from the gateway GW1, broadcast in the entire network 400 and floods therein. Then, each of the nodes A through I returns the operation mode to the normal mode when it receives the detection terminate instruction packet which is transmitted from the gateway GW1, broadcast in the entire network 400, and floods therein.

Described next is the ninth embodiment.

The destination of the bottleneck notification as a warning of a detected or predicted bottleneck is one or more “fifth communication devices” in the first embodiment, and one or more “fourth communication devices” in the second embodiment. The gateway GW1 in the network 400 in FIG. 4 is exemplified as one of the concrete example of the destination of the bottleneck notification, and all nodes in the network 400 are exemplified as other concrete examples.

As described above, the destination of the bottleneck notification may be one device or a plurality of devices depending on the embodiment. Furthermore, when there is one destination for the bottleneck notification, the destination device may be the same as the GD of the data packet such as the gateway GW1, and a device different from the GD of the data packet.

For example, in the ninth embodiment, the destination of the bottleneck notification is one specified particular management server. However, the management server is different from the gateway GW1.

For example, assume that the network 400 in FIG. 4 further includes a management server. The management server may be connected to other nodes A through I only through the gateway GW1. In this case, the bottleneck notification is transmitted to the gateway GW1 along the same path as the data packet, and may be relayed to the management server by the gateway GW1.

Otherwise, the management server may be provided at the position where it is adjacent to, for example, the nodes D and E, but not adjacent to the gateway GW1. Obviously, the management server may be located in other places.

Furthermore, two or more management servers may be located in the network 400. For example, the nodes A through E may specify the first management server as a destination when a bottleneck notification is transmitted, and other nodes F through I may specify the second management server as a destination when a bottleneck notification is transmitted.

Described next is the tenth embodiment. In the tenth embodiment, a bottleneck notification is defined as a subtype of a data packet.

As described above, a bottleneck notification may be transmitted in various methods depending on the embodiments. For example, a frequency channel other than one used in transmitting a data packet and a hello packet may be used in transmitting a bottleneck notification. In addition, a data packet and a hello packet may be transmitted in accordance with the IEEE 802.15.4 standard, and a bottleneck notification may be transmitted in accordance with the IEEE 802.11b standard. That is, only the bottleneck notification may be transmitted in accordance with a different communication protocol.

However, it is obvious that a bottleneck notification may be transmitted at the same frequency channel and according to the same communication protocol as the data packet and the hello packet. In the tenth embodiment, the first subtype indicating the normal data packet and the second subtype indicating the bottleneck notification are defined as the subtypes of the data packet.

The bottleneck notification is multi-hop transmitted in the network as a data packet of the second subtype with a specified destination in the network (for example, the gateway GW1) as the GD. According to the tenth embodiment, each node is not to be implemented with both the 802.15.4 PHY/MAC chip 205 and the 802.11b PHY/MAC chip 206, for example, it may be produced inexpensively.

Described next is the eleventh embodiment. In the eleventh embodiment, there are a plurality of gateways which may be specified as the GD of a data packet in the network. Also when there are a plurality of gateways, the transmission traffic field may be embedded in a data packet or a hello packet as with the embodiments above.

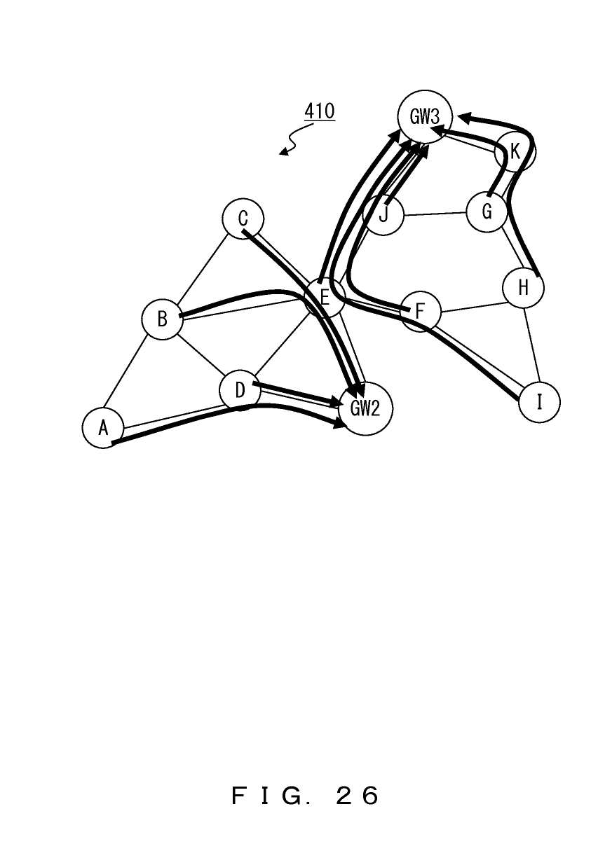

However, when there are a plurality of gateways, and if a transmission traffic field is included in a hello packet, not the hello packet 750 in FIG. 19, but the hello packet 760 in FIG. 19 are used. Then, the eleventh embodiment is described below with reference to FIGS. 26 and 19.

FIG. 26 is the second example of a network. A network 410 in FIG. 26 includes the nodes A through K, a gateway GW2, and a gateway GW3.

In FIG. 26, the thin solid line connecting the two nodes indicates that the two nodes are adjacent to each other. The bold arrow in FIG. 26 indicates the transmission path of a data packet.

The gateway GW2 or GW3 is set as the GD when a data packet is transmitted in each of the nodes A through K. Concretely, the nodes A through E transmit a data packet addressed to the gateway GW2, and the nodes F through K transmits a data packet addressed to the gateway GW3.

Furthermore, the node A is adjacent to the nodes B and D, and the node B is adjacent to the nodes A, C, D, and E, and the node C is adjacent to the nodes B and E. Then, the node D is adjacent to the nodes A, B, and E, and the gateway GW2. The node E is adjacent to the nodes B, C, D, F, and J, and the gateway GW2.

Then, the node F is adjacent to the nodes E, H, and I, and the node G is adjacent to the nodes H, J, and K. In addition, the node H is adjacent to the nodes F, G, and I, and the node I is adjacent to the nodes F and H. Then, the node J is adjacent to the nodes E and G, and the gateway GW3, and the node K is adjacent to the node G and the gateway GW3.

As indicated by the arrow in FIG. 26, the node A selects the node D as the LD when it transmits a data packet whose GD is the gateway GW2. The nodes B and C selects the node E as the LD when it transmits a data packet whose GD is the gateway GW2. The nodes D and E selects the gateway GW2 itself as the LD when transmitting a data packet whose GD is the gateway GW2.

In addition, the node E transmits not only the data packet whose GD is the gateway GW2, but also the data packet whose GD is the gateway GW3. Then, the node E selects the node J as the LD when transmitting the data packet whose GD is the gateway GW3.

Then, the node F selects the node E as the LD when transmitting the data packet whose GD is the gateway GW3, the node G selects the node K as the LD when transmitting the data packet whose GD is the gateway GW3. The node H selects the node G as the LD when transmitting the data packet whose GD is the gateway GW3, and the node I selects the node F as the LD when transmitting the data packet whose GD is the gateway GW3. Then, the nodes J and K select the gateway GW3 itself as the LD when transmitting the data packet whose GD is the gateway GW3.

Each of the nodes A through K in the network 410 above may be configured, for example, as the communication device 600 according to the third embodiment. In this case, the format of the data packet 710 according to the third embodiment is not to be changed.

Otherwise, each of the nodes A through K may have a configuration similar to that of the communication device 800 according to the fourth embodiment. In this case, the hello packet 750 according to the fourth embodiment is replaced with the hello packet 760 in FIG. 19 according to the eleventh embodiment, and the operation of each node is appropriately changed with the change of the format of the hello packet.

Concretely, the hello packet 760 in FIG. 19 includes an ad hoc header 701 and M pieces of transmission traffic information 761-1 through 761-M where M indicates the number of gateways which may be the GD of the data packet in the network, and M is 2 (M=2) in the example in FIG. 26. Each transmission traffic information 761-j (1≦j≦M) includes three fields, that is, a GD field, a selected LD field, and a transmission traffic field.

For example, as a concrete example of the hello packet 760, FIG. 19 illustrates a hello packet 762 transmitted by the node E in FIG. 26. In FIG. 26, it is assumed that the volume of the data packets generated by each of the nodes A through K per unit time is “1”. Then, the volume of the data packets transmitted by each of the nodes A through K per unit time corresponds to the number of arrows.

In the transmission traffic information 761-1 of the hello packet 762, the gateway GW3 is specified as the GD, the node J is specified as the selected LD, and the value of the transmission traffic is “3”. That is, the transmission traffic information 761-1 of the hello packet 762 expresses the following (I1) and (I2).

(I1) The volume of the data packets which is transmitted by the node E per unit time and for which the gateway GW3 is specified as the GD is “3”.

(I2) When the data packet for which the gateway GW3 is specified as the GD is transmitted, the node E selects the node J as the LD.

(I1) corresponds to the three arrows using the node E as the starting point or the relay point, and the gateway GW3 as the end point in FIG. 26. (I2) corresponds to these three arrows passing through the node J in FIG. 26.

In the transmission traffic information 761-2 of the hello packet 762, the gateway GW2 is specified as the GD, the gateway GW2 is specified as the selected LD, and the value of the transmission traffic is “2”. That is, the transmission traffic information 761-2 of the hello packet 762 expresses the following (J1) and (J2).

(J1) The volume of the data packets which are transmitted by the node E in a unit time and for which the gateway GW2 is specified as the GD is “2”.

(J2) When the data packet for which the gateway GW2 is specified as the GD is transmitted, the node E selects the gateway GW2 as the LD.

(J1) corresponds to that there are two arrows indicating the node E as a relay point and the gateway GW2 as an end point (and that there is no arrow indicating the node E as a starting point and the gateway GW2 as an end point) in FIG. 26. (J2) corresponds to that these two arrows directly points to the gateway GW2 from the node E without passing through any other nodes in FIG. 26.

According to the format of the above-mentioned hello packet 760, the format of the link table 811, the stored contents of the transmission volume storage unit 813, the processes in and after step S608 in FIG. 20, and the processes in FIG. 21 are changed in the eleventh embodiment as concretely described below.

In FIG. 18, each entry in the link table 811 stores only one value of the reception traffic corresponding to one link name. On the other hand, in the eleventh embodiment, each entry of the link table 811 includes M pairs of reception traffic and GD.

Also in the eleventh embodiment, the transmission volume storage unit 813 memorizes, for each of M gateways, the volume of the data packets for which the gateway concerned is specified as the GD and which are generated by the communication device 800 per unit time. For example, the transmission volume storage unit 813 in the node E in FIG. 26 stores the value of “0” in association with the gateway GW2 and also stores the value of “1” in association with the gateway GW3.

In addition, in the eleventh embodiment, each step in and after step S608 in FIG. 20 is performed on each of the transmission traffic information 761-1 through 761-M of the received hello packet 760 (that is, on each of the M gateways).

For example, upon receipt of the hello packet 762 from the node E, the node D operates as follows.

The selected LD of the transmission traffic information 761-1 and the selected LD of the transmission traffic information 761-2 are different from the node D. Therefore, the node D sets to “0” the values of the reception traffic associated with the gateways GW2 and GW3 in the entry in which the node E is specified as the link name in the link table 811.

Furthermore, upon receipt of the hello packet 762 from the node E, the node J operates as follows.

The selected LD of the transmission traffic information 761-1 refers to the node J. Therefore, the node J overwrites the reception traffic associated with the gateway GW3 with the value of “3” of the transmission traffic in the transmission traffic information 761-1 in the entry in which the node E is specified as the link name in the link table 811.

On the other hand, the selected LD of the transmission traffic information 761-2 is different from the node J. Therefore, the node J sets to “0” the reception traffic associated with the gateway GW2 in the entry in which the node E is specified as the link name in the link table 811.

The bottleneck detecting process in step S611 in FIG. 20 is concretely similar to the process in FIG. 14. However, in the eleventh embodiment, the process in FIG. 14 is performed on each of M gateways.

In addition, in the eleventh embodiment, steps S702 and S703 in FIG. 21 are performed on each of the M gateways, and the hello packet 760, not the hello packet 750, is generated in step S704.

The present invention is not limited to the above-mentioned embodiments. For example, the first through eleventh embodiments above are examples of the embodiments different in various viewpoints, but a plurality of embodiments may be appropriately combined. For example, the details of the bottleneck detecting process may be changed as in the fifth or sixth embodiment in the embodiment of embedding the transmission traffic in the hello packet 750 as in the fourth embodiment.

Some variations are described above, and further variations are available from the viewpoints described below. Various embodiments above and their variations and the following variations are arbitrarily combined so far as they are compatible with one another.

The transmission traffic may be embedded only in a data packet as illustrated in FIG. 10, and may be embedded only in a hello packet as illustrated in FIG. 19. However, the transmission traffic may be embedded in both a data packet and a hello packet.

The routing algorithm of an ad hoc network may be, for example, of proactive type, reactive type, hybrid type, etc. The routing algorithm may be any of these types depending on the embodiment.

To be more correct, any routing algorithm may be adopted for packets (such as data packets) to be transmitted in a multi-hop manner, so far as it is appropriate to regard the path as nearly static in a short time span as short as a period of time taken for prediction or detection of all bottlenecks. That is, unless a routing algorithm causes a path to be switched frequently (for example, each time the data packet is transmitted), any routing algorithm may be adopted.

That is, even if the path fluctuates, it may still be appropriate to regard the path as nearly static and stable during a relatively short time span that begins after the path is once established. Specifically, regarding the path as such is appropriate when a routing algorithm according to which fluctuation occurs moderately is used. The “relatively short time span” refers to, concretely, a time length nearly equal to a time length taken to predict or detect all bottlenecks as described above with reference to FIGS. 6 and 16. Therefore, an arbitrary routing algorithm that allows a moderate fluctuation is available.

For example, a routing algorithm which is designed to actually transmit a data packet in a data transmitting phase after constructing a path in a path constructing phase using a control packet may be also available. On the other hand, a routing algorithm which is designed to allow a node in a network to autonomously find an appropriate path while actually transmitting a data packet without discriminating the path constructing phase from the data transmitting phase may also be available.

In addition, some processes in the embodiments above include the comparison with a threshold. The comparison with a threshold may be the process of judging according to an embodiment “whether or not the numeral to be compared exceeds a threshold”, or the process of judging “whether or not the numeral to be compared is equal to or larger than a threshold”. In the explanation above, a threshold for various uses is exemplified, but a concrete value of each threshold may be appropriately determined depending on the embodiments.

Furthermore, relating to an evaluation value in a routing table, the quality in a link table, etc., the higher the evaluation or the quality is, the smaller the value becomes in the example above. However, it is obvious that depending on the embodiment, the evaluation value or the quality value may be defined so that the higher the evaluation or the quality is, the larger the value becomes, and the operation of each node may be appropriately changed depending on the definition.

In the examples in FIGS. 6 and 16, the value stored in the transmission volume storage unit 613 or 813 in each of the nodes A through I is “1”. However, it is obvious that a different value may be stored in the transmission volume storage unit 613 or 813 for each node depending on the embodiment.

Furthermore, the format of a packet is arbitrary depending on the embodiment, and the order and size of a field may be variable. Then, the field other than those exemplified above may be further included in a packet.

For example, each node may include the evaluation value of link quality in a hello packet. Then, adjacent nodes may recognize the bidirectional quality of a link by exchanging hello packets.

For example, the node H may include the evaluation value calculated based on the fluctuation of the reception interval of a hello packet from the node F in a hello packet with the evaluation value associated with the node ID of the node F. Then, upon receipt of the hello packet from the node H, the node F may recognize the evaluation value about the direction from the node F to the node H in the link between the nodes F and H. The node F may further use the evaluation value recognized as described above in the calculation of the weighted number of transmission paths.

For example, a bottleneck notification may be of subtype of a data packet depending on the embodiment. In this case, the 802.11b PHY/MAC chip 206 may be omitted from the communication device 200 in FIG. 2.

The data format of the link table and the routing table is also changed appropriately depending on the embodiment. For example, any data structure of a finite FIFO (first in first out), a linear list, etc. other than the tables may be available.

Furthermore, in FIGS. 8 and 18, the link table has a reception traffic field. However, it is sufficient for the reception traffic to be memorized in association with an adjacent node. For example, each communication device may associate the reception traffic with the adjacent node and memorize them in a storage area different from the link table.

Furthermore, in the example in FIG. 25, all LD candidates in the routing table 612 are used in calculating the weighted number of transmission paths. However, only a part of the LD candidates may be used in calculating the weighted number of transmission paths depending on the embodiment.

For example, the routing table may memorize an adjacent nodes having the best five evaluation values as LD candidates. In the calculation of the weighted number of transmission paths, only the LD candidates having the best three evaluation values may be used among the five LD candidates. Otherwise, only the LD candidates having the evaluation values within a specified range of the difference from the best evaluation value may be used in calculating the weighted number of transmission paths.

Even if a path is switched, the LD candidate having the second best evaluation value is selected as the first substitute path. The case in which substitute paths are sequentially checked to the lower LD candidate (for example, to the fifth candidate) does not frequently occur.

Therefore, in calculating the weighted number of transmission paths as an index of potential transmission capacity (or the robustness against the fluctuation of network topology), it is acceptable that an LD candidate(s) having relatively better evaluation (s) for which there is a high probability of actually being selected as a substitute path is/are considered. Therefore, it is not requested that all LD candidates in the routing table are used in calculating the weighted number of transmission paths depending on the embodiment.

Furthermore, concrete values and variables such as the numerals etc. referred to in the explanation above are only exemplified for convenience of explanation.

Then, it is obvious that a communication device may be realized by hardware other than those exemplified in FIGS. 2 and 3. Each function of a communication device may be realized by a dedicated hardware circuit such as an ASIC (application specific integrated circuit) etc., a reconfigurable circuit such as an FPGA etc., a general purpose MPU, or any combination of them.

Various embodiments including variation examples are described above, but every embodiment id very useful in taking countermeasures against new problems (that is, occurrences of a bottleneck) which have been revealed with an increasing number of ad hoc networks.

For example, to construct a new ad hoc network, a plurality of nodes are physically arranged first. The arrangement of the nodes may be made, for example, manually. Then, at the test stage before starting an operation of an ad hoc network, the operation of the entire ad hoc network is verified, and adjusted as appropriate.

Concretely, for example, at the test stage, it is monitored whether or not the gateway may receive data packets from all nodes. It is judged from the result of the monitor whether or not the data packet transmitted from each node is relayed without problem.

For example, when a gateway does not receive a data packet from a particular part of node, the adjustment of the position of a node, the addition of a relay node, the adjustment of the direction of an antenna of node, etc. may be performed. However, if an ad hoc network is large, and a data packet from a particular part of node is not received by a gateway, it is difficult to detect the reason.

For example, one of the reasons may be that “two nodes are physically not communicable (for example, because they are physically distant from each other, etc.), and there is no bypass route”. Another reason may be that “any node is a bottleneck”. Depending on the reasons, concrete countermeasures may be different.

According to each of the above-mentioned embodiments, since a bottleneck node may be quickly detected, countermeasures to remove the bottleneck may be taken at an early stage. Furthermore, by detecting the bottleneck, the occurrence of a bottleneck may be naturally discriminated from other reasons.

Furthermore, after starting the operation of an ad hoc network, for example, a change of an operation condition such as “increasing the volume of data packets generated and transmitted by each node per unit time” may be planned. For example, an addition of a sensor to each node and shortening the transmission interval of a data packet may be planned. Such plans imply an increase in the volume of packets to be generated per unit time.

When the above-mentioned plans are made, a simulation as to “whether or not the current network may stand the load if the plans are executed” may be easily performed according to each of the above-mentioned embodiments. That is, according to each of the embodiments above, for example, a bottleneck may be predicted without interfering with the transmission of a data packet on the ad hoc network being operated only by changing the value stored in the transmission volume storage unit 613 or 813.

Therefore, according to each of the above-mentioned embodiments, a predicted problem may be known before executing a plan, and countermeasures (for example, adding a node, adjusting a plan, etc.) to prevent the problem may be appropriately taken.

Furthermore, regardless of the test stage or a new plan being prepared, it is unnecessary to pass a dummy packet etc. for observation to an actual ad hoc network according to each of the above-mentioned embodiments. Therefore, according to each of the above-mentioned embodiments, the transmission of a normal data packet is not suppressed by the prediction or detection of a bottleneck, or the transmission of a normal data packet is not temporarily stopped.

Therefore, according to each of the above-mentioned embodiments, a bottleneck may be predicted or detected in a smaller number of steps. Furthermore, when a bottleneck is predicted, an excellent effect that “the prediction may be performed without stopping the operation of the ad hoc network system being operated” may be obtained.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A first communication device in a network including a plurality of communication devices, the first communication device comprising:
a memory configured to memorize a third communication device which is adjacent to the first communication device, and selectable when data is transmitted toward a second communication device;
a receiver configured to receive a notification of a first transmission data volume from a fourth communication device adjacent to the first communication device, the first transmission data volume being a volume of data that is addressed to the second communication device and transmitted by the fourth communication device through the first communication device in a certain period;
a processor configured to judge whether a second transmission data volume exceeds a certain criterion, the second transmission volume including the first transmission data volume and being a volume of data that is addressed to the second communication device and transmitted by the first communication device in the certain period; and
a transmitter configured to
notify the third communication device of the second transmission data volume, and
notify a fifth communication device that the first communication device is a bottleneck in the network, when the processor judges that the second transmission data volume exceeds the certain criterion.

2. The first communication device according to claim 1, wherein
the memory further stores a first evaluation value of communication quality between the third communication device and the first communication device, and
when a first value calculated based on the second transmission data volume and the first evaluation value is larger than a first threshold, the processor judges that the second transmission data volume exceeds the certain criterion.

3. The first communication device according to claim 2, wherein
the memory further memorizes
a sixth communication device which is adjacent to the first communication device and selectable when data is transmitted toward the second communication device, and
a second evaluation value of communication quality between the sixth communication device and the first communication device, and
when a second value calculated based on the second transmission data volume, the first evaluation value, and the second evaluation value is larger than a second threshold, the processor judges that the second transmission data volume exceeds the certain criterion.

4. The first communication device according to claim 1, wherein
the notification of the first transmission data volume is included in first data,
the first data is addressed to the second communication device and transmitted by the fourth communication device through the first communication device,
the first data is to be measured in measuring the first transmission data volume, and
the transmitter notifies the third communication device of the second transmission data volume by including the notification of the second transmission data volume in the first data when the first data is forwarded to the third communication device.

5. The first communication device according to claim 1, wherein
second data that is broadcast by the fourth communication device includes the notification of the first transmission data volume together with information for identification of the first communication device, and
the transmitter notifies the third communication device of the second transmission data volume by including the notification of the second transmission data volume in third data together with information for identification of the third communication device when the third data is broadcast by the first communication device.

6. A first communication device in a network including a plurality of communication devices, the first communication device comprising:
a receiver configured to receive from each of one or more second communication devices adjacent to the first communication device a notification of a first transmission data volume being a volume of data that is addressed to a third communication device and is transmitted by each second communication device in a certain period;
a processor configured to judge whether a second transmission data volume obtained by aggregating the first transmission data volume notified by each of the one or more second communication devices exceeds a certain criterion; and
a transmitter configured to notify a fourth communication device that the first communication device is a bottleneck in the network, when the processor judges that the second transmission data volume exceeds the certain criterion.

7. The first communication device according to claim 6, wherein
the notification of the first transmission data volume is included in first data,
the first data is addressed to the third communication device and transmitted by each of the one or more second communication devices through the first communication device, and
the first data is to be measured in measuring the first transmission data volume.

8. The first communication device according to claim 6, wherein second data that is broadcast by each of the one or more second communication devices includes the notification of the first transmission data volume together with information for identification of the first communication device.

9. A method executed by a first communication device in a network including a plurality of communication devices, the method comprising:
recognizing a third communication device which is adjacent to the first communication device, and selectable when data is transmitted toward a second communication device, with reference to a memory which memorizes the third communication device;
receiving from a fourth communication device adjacent to the first communication device a notification of a first transmission data volume being a volume of data that is addressed to the second communication device and is transmitted by the fourth communication device through the first communication device in a certain period;
notifying the third communication device of a second transmission data volume including the first transmission data volume and being a volume of data that is addressed to the second communication device and is transmitted by the first communication device in the certain period;
judging whether the second transmission data volume exceeds a certain criterion; and
notifying a fifth communication device that the first communication device is a bottleneck in the network, when the judging judges that the second transmission data volume exceeds the certain criterion.

10. A method executed by a first communication device in a network including a plurality of communication devices, the method comprising:
receiving from each of one or more second communication devices adjacent to the first communication device a notification of a first transmission data volume being a volume of data that is addressed to a third communication device and is transmitted by each second communication device in a certain period;
judging whether a second transmission data volume obtained by aggregating the first transmission data volume notified from each of the one or more second communication devices exceeds a certain criterion; and
notifying a fourth communication device that the first communication device is a bottleneck in the network, when the judging judges that the second transmission data volume exceeds the certain criterion.
